(19) United States
(12) Patent Application Publication
(10) Pub. No.: US 2023/0278141 A1
(43) Pub. Date: Sep. 7, 2023

(54) PATTERN FORMING APPARATUS

(71) Applicants: Keiichi SERIZAWA, Kanagawa (JP); Hirotoshi NAKAYAMA, Kanagawa (JP); Yoichi ICHIKAWA, Kanagawa (JP)

(72) Inventors: Keiichi SERIZAWA, Kanagawa (JP); Hirotoshi NAKAYAMA, Kanagawa (JP); Yoichi ICHIKAWA, Kanagawa (JP)

(21) Appl. No.: 18/020,676

(22) PCT Filed: Aug. 19, 2021
(86) PCT No.: PCT/JP2021/030469

§ 371 Date: Feb. 10, 2023

(30) Foreign Application Priority Data
Aug. 20, 2020 (JP) 2020-139568
Aug. 20, 2020 (JP) 2020-139569
Nov. 30, 2020 (JP) 2020-199086
May 20, 2021 (JP) 2021-085399
May 20, 2021 (JP) 2021-085407

(51) Int. Cl. B23K 26/359; B23K 26/082; B23K 26/08; B23K 26/0622; B41J 2/44; B41J 2/47; B41M 5/26

(52) U.S. Cl. CPC B23K 26/359; B23K 26/0624; B23K 26/0821; B23K 26/0838; B41J 2/442; B41J 2/473; B41M 5/262; B41M 5/267

(57) ABSTRACT

A pattern forming apparatus for forming a pattern by emitting a scanning light onto a plurality of base materials conveyed in a predetermined conveying direction, includes a plurality of emitting units including a first emitting unit and a second emitting unit. The first emitting unit includes a first light source unit to emit a first laser light; a first conveying direction light scanning unit to scan the first laser light in the predetermined conveying direction; a first intersecting direction light scanning unit to scan a scanning light, scanned by the first conveying direction light scanning unit, in an intersecting direction that intersects the predetermined conveying direction. Further, there is a first light emitting unit to emit a first scanning light, scanned by the first intersecting direction light scanning unit, onto a base material among the plurality of base materials.

### TECHNICAL FIELD

The present invention relates to a pattern forming apparatus and a laser processing apparatus.

### BACKGROUND ART

Conventionally, a pattern forming apparatus in which a laser beam is emitted to form a pattern on a base material such as a resin material, has been known. There is also disclosed a method of forming a pattern on a base material by one-dimensional scanning of a pulse laser beam (see, for example, Patent Literature 1).

Furthermore, conventionally, labeled have been attached to containers, such as Poly Ethylene Terephthalate (PET) bottles. The information indicated on such labels includes names, ingredients, best before dates, bar codes, QR codes (registered trademark), recycling marks, logos, or the like. Further, attempts have been made to demonstrate the individuality of products and to improve competitiveness, by displaying designs and pictures appealing to consumers through the labels.

On the other hand, in recent years, the problem of marine plastic waste and the like has been reported, and movements to eliminate environmental pollution caused by plastic waste are becoming increasingly active worldwide, and there is a growing demand for circulation type recycling of containers. Circulation type recycling of containers refers to separately collecting used containers (according to their different materials), turning the collected containers into flakes that can be used as raw materials of containers, and then producing containers again by using the flakes, by recycling companies.

In order to smoothly promote the circulation type recycling, it is preferable to ensure that containers, labels or the like, are separately collected according to their different materials. However, the task of manually removing labels from containers for the purpose of separate collection, can be troublesome. Therefore, the removal of labels from containers is one of the factors hampering the separate collection from being ensured.

On the other hand, there is disclosed a technique of directly forming a pattern for displaying information such as the name and the ingredients, by applying carbon dioxide gas laser on the surface of a container (see, for example, Patent Literature 2).

### CITATION LIST

### Patent Literature

PTL 1: Japanese Patent No. 5632662
PTL 2: Japanese Unexamined Patent Application Publication No. 2011-011819

### SUMMARY OF INVENTION

### Technical Problem

However, in the method of Patent Literature 1, if the conveying speed of the base material is high, the time for forming the pattern is shortened and a pattern cannot be formed on the conveyed base material, and if the conveying speed of the base material is reduced to a level that a pattern can be formed, the productivity of forming the pattern may be reduced.

Further, the method of Patent Literature 2 of directly forming patterns on the surface of a container using a carbon dioxide gas laser, has a margin for improvement in terms of forming patterns with good visibility while ensuring the mechanical strength of the base material.

The disclosed technology is thus intended to provide a pattern forming apparatus capable of ensuring the productivity of forming a pattern on a conveyed base material.

Further, the disclosed technology is intended to provide a pattern forming apparatus capable of forming a pattern with good visibility while ensuring the mechanical strength of the base material.

### Solution to Problem

According to an aspect of the present invention, a pattern forming apparatus for forming a pattern by emitting a scanning light onto a plurality of base materials conveyed in a predetermined conveying direction, includes a plurality of emitting units including a first emitting unit and a second emitting unit, wherein the first emitting unit includes a first light source unit configured to emit a first laser light; a first conveying direction light scanning unit configured to scan the first laser light in the predetermined conveying direction; a first intersecting direction light scanning unit configured to scan a scanning light, scanned by the first conveying direction light scanning unit, in an intersecting direction that intersects the predetermined conveying direction; and a first light emitting unit configured to emit a first scanning light, scanned by the first intersecting direction light scanning unit, onto a base material among the plurality of base materials, wherein the second emitting unit includes a second light source unit configured to emit a second laser light; a second conveying direction light scanning unit configured to scan the second laser light in the predetermined conveying direction; a second intersecting direction light scanning unit configured to scan a scanning light, scanned by the second conveying direction light scanning unit, in the intersecting direction; and a second light emitting unit configured to emit a second scanning light, scanned by the second intersecting direction light scanning unit, onto another base material among the plurality of base materials, wherein the first light emitting unit emits the first scanning light onto the base material that is different from the another base material onto which the second light emitting unit emits the second scanning light, at a position different from a position where the second light emitting unit emits the second scanning light in the predetermined conveying direction.

### Advantageous Effects of Invention

According to an embodiment of the present invention, a pattern forming apparatus capable of ensuring the productivity of forming a pattern on a conveyed base material, is provided.

According to an embodiment of the present invention, a pattern forming apparatus capable of forming a pattern with good visibility while ensuring the mechanical strength of the base material, is provided.

### BRIEF DESCRIPTION OF DRAWINGS

FIG. 1 is a top view illustrating an example of a configuration of a pattern forming apparatus according to an embodiment of the present invention.

FIG. 2 is a side view illustrating an example of a configuration of the pattern forming apparatus according to an embodiment of the present invention.

FIG. 3 illustrates a container viewed from the direction of the arrow D in FIG. 2.

FIG. 4A is a diagram illustrating an example of an operation of a galvanomirror of scanning in an X-axis positive direction according to an embodiment of the present invention.

FIG. 4B is a diagram illustrating an example of an operation of a galvanomirror of scanning in an X-axis negative direction according to an embodiment of the present invention.

FIG. 5 is a diagram illustrating a first example of an operation of a pattern forming apparatus according to a comparative example.

FIG. 6 is a diagram illustrating a second example of an operation of a pattern forming apparatus according to a comparative example.

FIG. 7 is a diagram illustrating a third example of an operation of a pattern forming apparatus according to a comparative example.

FIG. 8 is a diagram illustrating a first example of an operation of a pattern forming apparatus according to an embodiment of the present invention.

FIG. 9 is a diagram illustrating a second example of an operation of the pattern forming apparatus according to an embodiment of the present invention.

FIG. 10 is a diagram illustrating a third example of an operation of the pattern forming apparatus according to an embodiment of the present invention.

FIG. 11 is a diagram illustrating a fourth example of an operation of the pattern forming apparatus according to an embodiment of the present invention.

FIG. 12 is a top view illustrating a configuration example of a pattern forming apparatus according to a first embodiment of the present invention.

FIG. 13 is a diagram illustrating an example of an arrangement of the pattern forming apparatus according to the first embodiment of the present invention.

FIG. 14 is a diagram illustrating a first example of an operation of the pattern forming apparatus according to the first embodiment of the present invention.

FIG. 15 is a diagram illustrating a second example of an operation of the pattern forming apparatus according to the first embodiment of the present invention.

FIG. 16 is a diagram illustrating a third example of an operation of the pattern forming apparatus according to the first embodiment of the present invention.

FIG. 17 is a diagram illustrating a first example of an operation of a pattern forming apparatus according to a comparative example.

FIG. 18 is a diagram illustrating a second example of the operation of the pattern forming apparatus according to a comparative example.

FIG. 19 is a diagram illustrating an example of an operation of a pattern forming apparatus according to a modified example of the first embodiment of the present invention.

FIG. 20 is a diagram illustrating an example of a configuration of a container manufacturing apparatus according to a second embodiment of the present invention.

FIG. 21 is a diagram illustrating an example of a configuration of a laser emitting unit according to the second embodiment of the present invention.

FIG. 22 is a diagram illustrating the emission of a pulse laser light by a processing laser beam array according to the second embodiment of the present invention.

FIG. 23 is a block diagram illustrating an example of a hardware configuration of a control unit according to the second embodiment of the present invention.

FIG. 24 is a block diagram illustrating an example of a functional configuration of the control unit according to the second embodiment of the present invention.

FIG. 25 is a flowchart illustrating an example of a manufacturing method according to the second embodiment of the present invention.

FIG. 26 is a diagram illustrating an example of pattern data according to the second embodiment of the present invention.

FIG. 27 is a diagram illustrating an example of an association table of the types of first patterns and processing parameters according to the second embodiment of the present invention.

FIG. 28 is a diagram illustrating an example of a processing parameter according to the second embodiment of the present invention.

FIG. 29 is a diagram illustrating an example of processing data according to the second embodiment of the present invention.

FIG. 30A is a diagram illustrating an example of emission of processing laser beams, in a state where there is an interval between the beams in a direction orthogonal to the Y direction according to the second embodiment of the present invention.

FIG. 30B is a diagram illustrating the state of high-speed scanning of FIG. 30A.

FIG. 30C is a diagram illustrating an example of emission of processing laser beams, in a state where the beams are overlapping each other in a direction orthogonal to the Y direction according to the second embodiment of the present invention.

FIG. 30D is a diagram illustrating the state of high-speed scanning of FIG. 30C.

FIG. 30E is a diagram illustrating an example of emission of processing laser beams, in a state where the beams are contacting each other in a direction orthogonal to the Y direction according to the second embodiment of the present invention.

FIG. 30F is a diagram illustrating the state of high-speed scanning of FIG. 30E.

FIG. 31A is a diagram illustrating the change in the property of the base material of the container by a change in shape due to evaporation according to the second embodiment of the present invention.

FIG. 31B is a diagram illustrating the change in the property of the base material of the container by a change in shape due to melting according to the second embodiment of the present invention.

FIG. 31C is a diagram illustrating the change in the property the base material of the container due to a change in the crystallization state according to the second embodiment of the present invention.

FIG. 31D is a diagram illustrating the change in the property of the base material of the container due to a change in the foam state according to the second embodiment of the present invention.

FIG. 32 is a diagram illustrating an example of a container according to the second embodiment of the present invention.

FIG. 33 is a diagram illustrating an example of the relationship between the first pattern and the second pattern according to the second embodiment of the present invention.

FIG. 34 is a cross-sectional view of cut along A-A in FIG. 33.

FIG. 35A is a diagram illustrating an example in which the processing depth is shallower than the unprocessed depth according to the second embodiment of the present invention.

FIG. 35B is a diagram illustrating an example in which the processing depth and the unprocessed depth are approximately the same according to the second embodiment of the present invention.

FIG. 35C is a diagram illustrating an example in which the processing depth is deeper than the unprocessed depth according to the second embodiment of the present invention.

FIG. 35D is a diagram illustrating an example in which the processing depth and the unprocessed depth are varied according to the second embodiment of the present invention.

FIG. 36 is a diagram illustrating an example of a container according to the second embodiment of the present invention.

FIG. 37 is a diagram illustrating an example of a gradation representation according to a second pattern according to a third embodiment of the present invention.

FIG. 38A is a diagram illustrating an example of a gradation representation by the second pattern, in which the processing data of the second pattern does not have periodicity according to the third embodiment of the present invention.

FIG. 38B is a diagram illustrating an example of a gradation representation by the second pattern, which is a cross-sectional view of the second pattern according to crystallization according to the third embodiment of the present invention.

FIG. 38C is a diagram illustrating an example of a gradation representation by the second pattern, which is a plan view of the second pattern according to crystallization according to the third embodiment of the present invention.

FIG. 39 is a diagram illustrating an example of a container according to the third embodiment of the present invention.

FIG. 40 is a diagram illustrating an example of a relationship between the scanning time in the conveying direction and the time for returning to the initial position according to a fourth embodiment of the present invention.

FIG. 41A is a diagram illustrating an example of a surface tilt of a polygon mirror, and is a top view of the polygon mirror according to the fourth embodiment of the present invention.

FIG. 41B is a diagram illustrating an example of a surface tilt of a polygon mirror, and is a side view of the polygon mirror according to the fourth embodiment of the present invention.

FIG. 42A is a diagram for describing an example where the pattern quality is degraded due to a surface tilt of the polygon mirror, and illustrates a case where there is no surface tilt according to the fourth embodiment of the present invention.

FIG. 42B is a diagram for describing an example where the pattern quality is degraded due to a surface tilt of the polygon mirror, and illustrates a case where there is surface tilt according to the fourth embodiment of the present invention.

FIG. 43A is a diagram illustrating an example of a configuration of the pattern forming apparatus, that is a top view, according to the fourth embodiment of the present invention.

FIG. 43B is a diagram illustrating an example of a configuration of the pattern forming apparatus, that is a side view, according to the fourth embodiment of the present invention.

FIG. 44 is a block diagram illustrating a functional configuration of the patterning apparatus according to the fourth embodiment of the present invention.

FIG. 45A is a diagram illustrating an operation example of the pattern forming apparatus, that is a correction example by scanning in the X-axis positive direction, according to the fourth embodiment of the present invention.

FIG. 45B is a diagram illustrating an operation example of the pattern forming apparatus, that is a correction example by scanning in the X-axis negative direction, according to the fourth embodiment of the present invention.

FIG. 46 is a diagram illustrating a first example of an operation of the pattern forming apparatus according to the fourth embodiment of the present invention.

FIG. 47 is a diagram illustrating a second example of an operation of the pattern forming apparatus according to the fourth embodiment of the present invention.

FIG. 48 is a diagram illustrating an example of an interval between scanning lines in a pattern according to a fifth embodiment of the present invention.

FIG. 49A illustrates an example of the pixel density of the pattern that is 600 dpi according to the fifth embodiment of the present invention.

FIG. 49B illustrates an example of the pixel density of the pattern that is 1200 dpi according to the fifth embodiment of the present invention.

FIG. 49C illustrates an example of the pixel density of the pattern that is 1200 dpi according to the fifth embodiment of the present invention.

FIG. 50 is a diagram illustrating an example of a pattern according to the fifth embodiment of the present invention.

FIG. 51A is a diagram illustrating the experimental results of the relationship between the thickness of the substrate and the fluence of the pulse laser light, where (a) indicates a first condition, (b) indicates a fourth condition, and (c) indicates a third condition according to a sixth embodiment of the present invention.

FIG. 51B is a diagram illustrating the experimental results of the relationship between the pulse width of the pulse laser light and the fluence, where (a) indicates a second condition, (b) indicates a fifth condition and a sixth condition, and (c) indicates a seventh condition and an eighth condition according to the sixth embodiment of the present invention.

FIG. 52 is a top view illustrating an example of a configuration of a pattern forming apparatus according to a seventh embodiment of the present invention.

FIG. 53 is a side view illustrating an example of a configuration of the pattern forming apparatus according to the seventh embodiment of the present invention.

FIG. 54A illustrates a first example of pattern formation by the pattern forming apparatus, and illustrates scanning lines by one scan according to the seventh embodiment of the present invention.

FIG. 54B illustrates the first example of pattern formation by the pattern forming apparatus, and illustrates scanning lines by three scans according to the seventh embodiment of the present invention.

FIG. 55 is a partial enlarged view of a portion around a region E in FIG. 54B.

FIG. 56A illustrates a second example of pattern formation by the pattern forming apparatus according to the seventh embodiment of the present invention.

FIG. 56B illustrates the second example of pattern formation by the pattern forming apparatus according to the seventh embodiment of the present invention.

FIG. 57 is a partial enlarged view of a portion around a region F of FIG. 56B.

FIG. 58A is a diagram illustrating a third example of pattern formation by the pattern forming apparatus, and illustrates scanning lines at time t0 according to the seventh embodiment of the present invention.

FIG. 58B is a diagram illustrating the third example of pattern formation by the pattern forming apparatus, and illustrates scanning lines at time t1 according to the seventh embodiment of the present invention.

FIG. 58C is a diagram illustrating the third example of pattern formation by the pattern forming apparatus, and illustrates scanning lines at time t2 according to the seventh embodiment of the present invention.

FIG. 58D is a diagram illustrating the third example of pattern formation by the pattern forming apparatus, and illustrates scanning lines at time t3 according to the seventh embodiment of the present invention.

### DESCRIPTION OF EMBODIMENTS

Hereinafter, embodiments for carrying out the present invention will be described with reference to the drawings. In each drawing, the same elements are denoted by the same reference numerals, and overlapping descriptions may be omitted.

The following embodiments are exemplary of a pattern forming apparatus for embodying the technical idea of the present invention, and the present invention is not limited to the following embodiments. The dimensions, materials, shapes, relative layouts, etc., of the elements described below are not intended to limit the scope of the present invention to those alone, unless otherwise specified, but are intended to be exemplary. Furthermore, the size and positional relationship of the elements illustrated in the drawings may be exaggerated for the purpose of clarification.

In the drawings of the embodiment, the conveying direction of the base material is in the X-axis direction, which is a predetermined direction in a plane horizontal with respect to the ground. The intersecting (orthogonal) direction intersecting (orthogonal to) the X-axis direction (in the plane) is the Y-axis direction. The gravitational direction (height direction) intersecting (orthogonal to) the X-axis direction and the Y-axis direction, is the Z-axis direction.

The pattern forming apparatus according to an embodiment is a pattern forming apparatus in which a plurality of base materials conveyed in a predetermined conveying direction are irradiated with scanning light to form a pattern. The pattern forming apparatus according to an embodiment also includes a plurality of emitting units including a first emitting unit and a second emitting unit.

The first emitting unit includes a first conveying direction light scanning unit that scans a first laser light, emitted by a first light source unit, in a conveying direction, a first intersecting direction light scanning unit that scans the scanning light, scanned by the first conveying direction light scanning unit, in an intersecting direction that intersects the conveying direction, and a first light emitting unit that irradiates a base material with the first scanning light scanned by the first intersecting direction light scanning unit.

The second emitting unit includes a second conveying direction light scanning unit that scans a second laser light, emitted by a second light source unit, in the conveying direction, a second intersecting direction light scanning unit that scans the scanning light, scanned by the second conveying direction light scanning unit, in the intersecting direction, and a second light emitting unit that irradiates the base material with the second scanning light scanned by the second intersecting direction light scanning unit.

The first light emitting unit emits the first scanning light onto a base material that is different from the base material onto which the second light emitting unit emits the second scanning light, among a plurality of base materials, at a position different from that of the second light emitting unit in the conveying direction.

By scanning the first scanning light in the conveying direction, compared to the case where the first scanning light is scanned at one position in the conveying direction, the time during which the first scanning light can be emitted onto the base material is increased and the pattern formation time is increased. This allows the conveying speed of the base material to be maintained at the desired speed while ensuring the productivity of pattern formation.

Furthermore, the first scanning light is emitted onto a base material that is different from the base material irradiated with the second scanning light, at a position different from the second scanning light in the conveying direction, so that patterns can be formed in parallel with respect to different base materials. This further improves the productivity of pattern formation for multiple base materials.

The pattern forming apparatus according to an embodiment is a pattern forming apparatus that irradiates a base material conveyed in a predetermined direction with laser light, and includes a light source unit that emits laser light, a first light scanning unit that scans the laser light in a predetermined direction, a second light scanning unit that scans the laser light in an intersecting direction that intersects the predetermined direction, and a light emitting unit that irradiates the base material with scanning light scanned by the first or second light scanning unit. In an embodiment, the second light scanning unit scans the laser light in the intersecting direction at a plurality of positions along the predetermined direction. For example, the intersecting direction is a direction substantially orthogonal to the predetermined direction.

In this way, the pattern forming apparatus according to an embodiment increases the time for irradiating the base material with the laser light compared to the case where the second light scanning unit scans the laser light at one position along the predetermined direction, thereby increasing the pattern formation time. Thus, the pattern forming apparatus according to the embodiment ensures the conveying speed of the base material and ensures the productivity of pattern formation for the conveyed base material.

A pattern forming apparatus according to an embodiment is an apparatus for forming a pattern on a base material, such as plastic, and includes a light source unit for emitting pulse laser light, a light scanning unit for scanning the pulse laser light in a predetermined direction, and a light emitting unit for irradiating the base material with the light scanned by the light scanning unit.

In the present embodiment, when the oscillation wavelength of the light source unit is 300 nanometers or more and 400 nanometers or less, at least one of the following (A) to (C) is satisfied.

(A) When the pulse width of the pulse laser light is 10 picoseconds or more and 200 picoseconds or less, the fluence per pulse J/cm² of the pulse laser light at the base material satisfies the following formulas (10-1) and (10-2).

$$0.01 ≦ \text{t} < 1 \qquad \text{(10-1)}$$

$$0.61 \text{t} + 0.15 ≦ \text{F} ≦ 64.1 \text{t} + 32 \qquad \text{(10-2)}$$

(In the formulas (10-1) and (10-2), t represents the thickness of the base material in millimeters and F represents the fluence.)

(B) When the pulse width of the pulse laser light is 0.1 picoseconds or more and less than 10 picoseconds, the fluence per pulse J/cm² of the pulse laser light at the base material satisfies the following formulas (11-1), (11-2), and (11-3).

$$0.01 ≦ \text{t} < 1 \qquad \text{(11-1)}$$

$$0.1 ≦ \text{s} < 10 \qquad \text{(11-2)}$$

$$0.31 \text{s} + 0.023 ≦ \text{F} ≦ 64.1 \text{t} + 32 \qquad \text{(11-3)}$$

(In the formulas (11-1), (11-2), and (11-3), t represents the thickness of the base material in millimeters, s represents the pulse width of the pulse laser light in picoseconds, and F represents the fluence.)

(C) When the pulse width of the pulse laser light is 1 nanosecond or more and 100 nanoseconds or less, the fluence per pulse J/cm² of the pulse laser light at the base material satisfies the following formulas (12-1) and (12-2).

$$0.01 ≦ \text{t} < 1 \qquad \text{(12-1)}$$

$$\text{5t} + 1.7 ≦ \text{F} ≦ 67.7 \text{t} + 26.5 \qquad \text{(12-2)}$$

(In the formulas (12-1) and (12-2), t represents the thickness of the base material in millimeters and F represents the fluence.)

In the present embodiment, when the oscillation wavelength of the light source unit is 500 nanometers or more and 600 nanometers or less, at least one of the following (D) to (F) is satisfied.

(D) When the pulse width of the pulse laser light is 10 picoseconds or more and 200 picoseconds or less, the fluence per pulse J/cm² of the pulse laser light at the base material satisfies the following formulas (13-1) and (13-2).

$$0.01 ≦ \text{t} < 1 \qquad \text{(13-1)}$$

$$\text{10} \text{.4t} + 3.2 ≦ \text{F} ≦ 196.2 \text{t} \qquad \text{(13-2)}$$

(In formulas (13-1) and (13-2), t represents the thickness of the base material in millimeters and F represents the fluence.)

(E) When the pulse width of the pulse laser light is 0.1 picoseconds or more and less than 1 picosecond, the fluence per pulse J/cm² of the pulse laser light at the base material satisfies the following formulas (14-1) and (14-2).

$$0.01 ≦ \text{t} < 1 \qquad \text{(14-1)}$$

$$0.17 ≦ \text{F} ≦ 196.2 \text{t} \qquad \text{(14-2)}$$

(In formulas (14-1) and (14-2), t represents the thickness of the base material in millimeters and F represents the fluence.)

(F) When the pulse width of the pulse laser light is 1 picosecond or more and less than 10 picoseconds, the fluence per pulse J/cm² of the pulse laser light at the base material satisfies the following formulas (15-1), (15-2), and (15-3).

$$0.01 ≦ \text{t} < 1 \qquad \text{(15-1)}$$

$$1 ≦ \text{s} < 10 \qquad \text{(15-2)}$$

$$\text{0} \text{.76s-} 0.59 ≦ \text{F} ≦ 196.2 \text{t} \qquad \text{(15-3)}$$

(In the formulas (15-1), (15-2), and (15-3), t represents the thickness of the base material in millimeters, s represents the pulse width of the pulse laser light in picoseconds, and F represents the fluence.)

In the present embodiment, when the oscillation wavelength of the light source unit is 1,000 nanometers or more and 1,100 nanometers or less, the thickness of the base material is 0.01 millimeters or more and less than 1 millimeter, at least one of (G) and (H) below is satisfied.

(G) When the pulse width of the pulse laser light is 0.1 picoseconds or more and less than 1 picosecond, the fluence per pulse J/cm² of the pulse laser light at the base material satisfies the following formula (16-1).

$$1 ≦ \text{F} ≦ 8 \qquad \text{(16-1)}$$

(In the formula (16-1), F represents the fluence.)

(H) When the pulse width of the pulse laser light is 1 picosecond or more and 3 picoseconds or less, the fluence per pulse J/cm² of the pulse laser light at the base material satisfies the following formulas (17-1) and (17-2).

$$1 ≦ \text{s} ≦ 3 \qquad \text{(17-1)}$$

$$0.89 \text{s} + \text{0} \text{.11} ≦ \text{F} ≦ 8 \qquad \text{(17-2)}$$

(In formulas (17-1) and (17-2), s represents the pulse width of the pulse laser light in picoseconds and F represents the fluence.)

The conventional technique of directly forming patterns on the surface of a container, using a carbon dioxide gas laser (see, for example, Japanese Unexamined Patent Application Publication No. 2011-011819 (Patent Literature 2)), has a margin for improvement in terms of forming patterns with good visibility while ensuring the mechanical strength of the base material.

On the other hand, an embodiment of the present invention provides the above-described configuration in which, when a pattern is formed on a base material by emitting the pulse laser light, the mechanical strength of the base material is prevented from being degraded, and a pattern with good visibility can be formed while ensuring the mechanical strength of the base material.

Here, a “base material” refers to the material part of an object. The object may be, for example, a container for containing a beverage or the like. A container includes a polyethylene terephthalate (PET) bottle that is formed of a resin such as PET, for containing a beverage. However, there is no specific limitation on objects, and any object may be used. The container is not limited to any shape or material, and may be of any shape and may be of any material.

The surface of the base material means the surface in contact with external air, etc., of the base material. In the embodiments, the term “surface of base material” is used to be in contrast to the interior of the base material, and, therefore, for example, in the case of a plate-like base material, both the front surface and the back surface of the base material correspond to the surface of the base material. In the case of a cylindrical base material, both the outer surface and the inner surface of the base material correspond to the surface of the base material.

A pattern includes characters, codes such as barcodes, graphics, images, and the like, and indicates information, for example, regarding the container or the contents contained in the container such as a beverage or the like, such as the name, the identification number, the manufacturer, the date and time of manufacture, or the like.

There may be cases where a container such as a PET bottle indicates this information by pasting a recording medium (label), on which this information is recorded, on the surface of the container. In an embodiment, a pattern representing the above information is formed on the surface of the base material configuring the container so that the above information can be indicated on the base material, in a so-called LABELLESS manner, without using a recording medium.

### Embodiments

### Example of Configuration of a Pattern Forming Apparatus 200

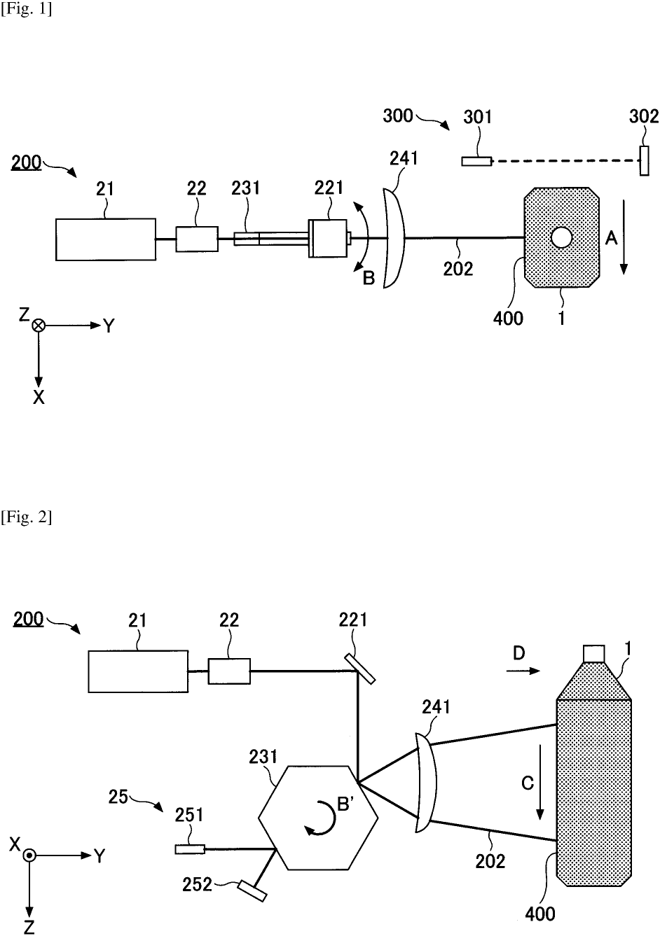

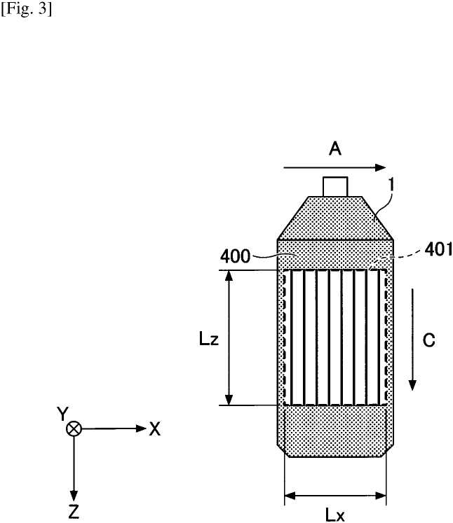

First, the pattern forming apparatus 200 according to embodiments of the present invention will be described with reference to FIGS. 1 to 3. FIG. 1 is a top view illustrating an example of a configuration of the pattern forming apparatus 200, FIG. 2 is a side view thereof, and FIG. 3 is a view illustrating a container from the direction of an arrow D of FIG. 2.

The pattern forming apparatus 200 emits scanning light 202 of pulse laser light onto a container 1, such as a PET bottle, conveyed in the direction of an arrow A, to form a pattern on at least one of the surface or the interior of a base material configuring the container 1.

The pattern forming apparatus 200 is capable of changing the property of at least one of the surface or the interior of the base material to form a pattern, by so-called laser processing using the scanning light 202 in an arrow C direction of the pulse laser light. Here, the arrow A direction corresponds to the conveying direction, which is an example of a predetermined direction, and the arrow C direction, which is an example of a scanning direction, corresponds to an intersecting direction intersecting the conveying direction. The pulse laser light is an example of a laser light.

As illustrated in FIGS. 1 to 3, the pattern forming apparatus 200 includes a pulse laser 21, a beam expander 22, a galvanomirror 221, a polygon mirror 231, and an fθ lens 241.

The pulse laser 21 is an example of a light source unit that emits pulse laser light. The pulse laser 21 emits generally parallel pulse laser beams in the Y-axis positive direction of FIG. 1. The pulse laser 21 can emit the light by switching among pulse laser light beams of three oscillation wavelengths, that is, a fundamental wave having an oscillation wavelength of 1064 nanometers, a secondary harmonic wave having an oscillation wavelength of 532 nanometers, and a tertiary harmonic wave having an oscillation wavelength of 355 nanometers.

The pulse width of the pulse laser light is 15 picoseconds or less at any of the oscillation wavelengths. The repetition frequency of the pulse laser light can be appropriately selected within a range from a single shot to 200 kHz. The beam diameter of the pulse laser beam is approximately 2.0 mm for the fundamental wave, approximately 1.4 mm for the secondary harmonic wave, and approximately 1.3 mm for the tertiary harmonic wave.

As the pulse laser 21 described above, for example, Talisker Ultra 355-4 manufactured by Coherent Inc. based on fiber laser, may be applied. However, the pulse laser 21 is not limited thereto, and other pulse lasers may be used.

Further, the pulse laser 21 is capable of switching between emission (ON) and non-emission (OFF) based on the pattern data of the pattern to be formed on the container 1.

In the pattern forming apparatus 200, the beam expander 22 is disposed on the Y-axis positive direction side of the pulse laser 21. The beam expander 22 is an optical system that emits, in the Y-axis positive direction, substantially parallel laser beams having a beam diameter obtained by enlarging, by a predetermined magnification factor, the beam diameter of the pulse laser light emitted by the pulse laser 21.

In the pattern forming apparatus 200, the galvanomirror 221 is disposed in the Y-axis positive direction of the beam expander 22. The galvanomirror 221 (an example of a Z-axis direction deflection mirror) deflects, in the Z-axis positive direction, the pulse laser light whose beam diameter has been enlarged by beam expander 22. However, a diffraction element may be used instead of the galvanomirror, as long as the element has a function of deflecting the light in the Z-axis direction. The galvanomirror 221 can be oscillated in the direction of an arrow B by a motor as the driving source, and this oscillation allows the pulse laser light from the beam expander 22 to be scanned in the conveying direction. The galvanomirror 221 is an example of a first light scanning unit.

The polygon mirror 231 scans the pulse laser light in the arrow C direction (example of scanning direction). The polygon mirror 231 is an example of a second light scanning unit. The polygon mirror 231 is a rotatable polygon mirror which is rotatable by a motor or the like as a driving source and includes a plurality (here, six) reflection surfaces. In the pattern forming apparatus 200, the polygon mirror 231 is disposed in the Z-axis positive direction of the galvanomirror 221. The polygon mirror 231 can scan the pulse laser light incident from the galvanomirror 221 in the arrow C direction (scanning direction) by rotating about an axis parallel to the X-axis (in the arrow B′ direction) to change the angle of the reflection surface.

The polygon mirror 231 is capable of scanning the pulse laser light in the arrow C direction at a plurality of positions along the conveying direction, by scanning, in the arrow C direction, the scanning light deflected by the galvanomirror 221 in the conveying direction.

The fθ lens 241 irradiates the base material configuring the container 1 with the scanning light 202 that is the pulse laser light scanned by the polygon mirror 231 in the scanning direction. The fθ lens 241 is an example of a light emitting unit, and is a lens designed and fabricated so that the scanning speed of the scanning light 202 passing through the periphery and center of the fθ lens 241 is substantially constant. The fθ lens 241 is also designed and fabricated to focus the pulse laser light on the base material that configures the container 1 and that is disposed at a predetermined position. FIG. 1 illustrates the fθ lens 241 configured by a single lens. However, the functions of the fθ lens 241 may be implemented by combining a plurality of lenses, or the functions of the fθ lens 241 may be implemented by a configuration that includes optical elements other than lenses, such as mirrors.

In the pattern forming apparatus 200, the container 1 is disposed on the Y-axis positive side of the fθ lens 241, and the pattern forming apparatus 200 emits the scanning light 202 onto an irradiation target surface 400 of the container 1 facing the fθ lens 241. In the pattern forming apparatus 200, the container 1 is mounted on a conveying unit, such as a belt conveyor, and the pattern forming apparatus 200 conveys the container 1 in the arrow A direction (the conveying direction) orthogonal to the Y-axis.

As illustrated in FIG. 1, in the pattern forming apparatus 200, a conveyance detecting unit 300 for detecting the container 1 being conveyed, is disposed at the upstream side in the arrow A direction (an example of the conveying direction of the container 1). The conveyance detecting unit 300 includes a conveyance detection light emitting element 301 (Laser Diode (LD)) and a conveyance detection light receiving element 302 (Photo Diode (PD)). The conveyance detecting unit 300 detects the timing when the container 1 blocks light emitted by the conveyance detection light emitting element 301 toward the conveyance detection light receiving element 302. The pattern forming apparatus 200 detects the timing at which the container 1 being conveyed enters the irradiation position of the scanning light 202, based on the timing at which the above described light is blocked and the distance information regarding the distance between the irradiation position of the scanning light 202 and the conveyance detecting unit 300, and determines the timing to start pattern formation in the conveying direction.

As illustrated in FIG. 2, a synchronization detecting unit 25 is provided near the polygon mirror 231. The synchronization detecting unit 25 includes a synchronization detection Laser Diode (LD) 251 and a synchronization detection Photo Diode (PD) 252. The synchronization detection LD 251 emits laser light toward the polygon mirror 231, and the synchronization detection PD 252 receives reflection light from the polygon mirror 231. The pattern forming apparatus 200 determines the timing of the start of the pattern formation in the intersecting direction based on a light signal received from the synchronization detection PD 252.

The pattern forming apparatus 200 is triggered by the start timing of the pattern formation in the conveying direction and the intersecting direction, respectively, and then while controlling the on and off of the pulse laser 21 based on the pattern data, the pattern forming apparatus 200 emits the line-shaped scanning light 202 extending in the arrow C direction, onto the container 1 being conveyed in the arrow A direction. Accordingly, a two-dimensional desired pattern 401 (a two-dimensional pattern) can be formed on the irradiation target surface 400 of the container 1, as illustrated in FIG. 3.

Further, the pattern forming apparatus 200 can sequentially form patterns on the respective base materials of a plurality of the containers 1 that are sequentially conveyed by a conveying unit such as a belt conveyor.

### Productivity of Pattern Formation by the Pattern Forming Apparatus 200

Here, the productivity of the pattern formation by the pattern forming apparatus 200 will be described. Assuming that the container size is W mm, the distance between adjacent containers among the plurality of the containers 1 in the conveying direction is d mm, and the productivity of the pattern formation is X units/min (for example, units correspond to the number of containers), the conveying speed V mm/s of the container 1 is calculated by the following formula (1). The distance between the plurality of the containers 1 in the conveying direction is equal to the distance between the plurality of base materials in the conveying direction.

### Formula 1

$$\text{V} = \frac{X ⋅ \left(W + d\right)}{60} \qquad \text{[Math.1]}$$

Assuming that the pixel density a dpi, in order to ensure a productivity X, the time T allowed for one scan by the polygon mirror 231 is calculated by the following formula.

### Formula 2

$$\text{T} = \frac{25.4}{\text{a} ⋅ X ⋅ \left(W + d\right)} \qquad \text{[Math.2]}$$

Further, assuming that the pattern formation region in the intersecting direction (scanning direction) is Lz mm, in order to ensure a productivity X, the time Δt (s) allowed for one dot in the intersecting direction (sub-scanning direction) is calculated by the following formula.

### Formula 3

$$\text{Δ} t = \frac{T}{\frac{L z}{\frac{25.4}{a}}} = \frac{25.4}{\text{a} ⋅ X ⋅ \left(W + d\right)} ⋅ \frac{25.4}{a ⋅ L z} \qquad \text{[Math.3]}$$

Next, the fluence of the pulse laser light will be described.

The fluence F of the pulse laser light can be expressed by the following formulas (4) and (5).

$$\text{P=E} ⋅ v \qquad \text{(4)}$$

$$\text{F=} \text{E} / \text{S} \qquad \text{(5)}$$

Here, P (W) represents the average output (light intensity) of the pulse laser, E (J) represents the pulse energy per pulse of the pulse laser light, and v (Hz) represents the repetition frequency of the emission of the pulse laser light by the pulse laser. F J/cm² represents the fluence and S (cm2) represents the area of the laser beam spot.

The fluence F corresponds to a value obtained by dividing the pulse energy by the area of the laser beam spot. The fluence at the base material configuring the container 1 corresponds to a value obtained by dividing the pulse energy of the pulse laser light emitted by the pulse laser 21 by the area of the laser beam spot on the base material configuring the container 1.

The pattern forming apparatus 200 performs pattern formation (laser processing) by thermal denaturation according to the light absorption spectrum of the base material, with respect to a pulse laser light having a pulse width of a nanosecond scale. On the other hand, the pattern forming apparatus 200 performs pattern formation (laser processing) by thermal denaturation according to the light absorption spectrum and multiphoton absorption, respectively, with respect to a pulse laser light having a pulse width of a picosecond scale.

Multiphoton absorption refers to a nonlinear phenomenon in which the pulse laser light is emitted such that the pulse laser light is excited by light having a wavelength corresponding to ½ or ⅓ of the pulse laser light’s oscillation wavelength, and multiple photons are absorbed such that the states of electrons and atoms transition to a high energy level. The use of pulse laser beams having a pulse width of a picosecond scale allows the base material to sublimate from a solid state without passing through a molten state, to form processing marks on the base material.

In this case, if the fluence required to form a pattern on the base material of the container 1 results in the selection of the pulse laser 21 capable of forming a pattern of one dot by one pulse, the pattern formation frequency will be a repetition frequency of v (Hz).

On the other hand, if the fluence of the pulse laser 21 is low and an N number of pulses is required for the pattern formation of one dot, the pattern formation frequency will be v/N (Hz), and, therefore, the time required for pattern formation of one dot becomes N/v s.

In this case, Δt is only allowed to be a value that is greater than N/v s, and the container 1 cannot be conveyed at a speed that is faster than the speed allowed for pattern formation by a single scan. That is, the time allowed for the pattern formation of one dot, becomes the rate limitation of productivity.

On the other hand, in the present embodiment, the polygon mirror 231 scans the laser light in the intersecting direction (scanning direction) at a plurality of positions along the conveying direction of the container 1. The larger the number of positions along the conveying direction, the slower the apparent conveying speed of the container 1, and, therefore, the pattern formation time can be increased.

### Example of Operation of the Pattern Forming Apparatus

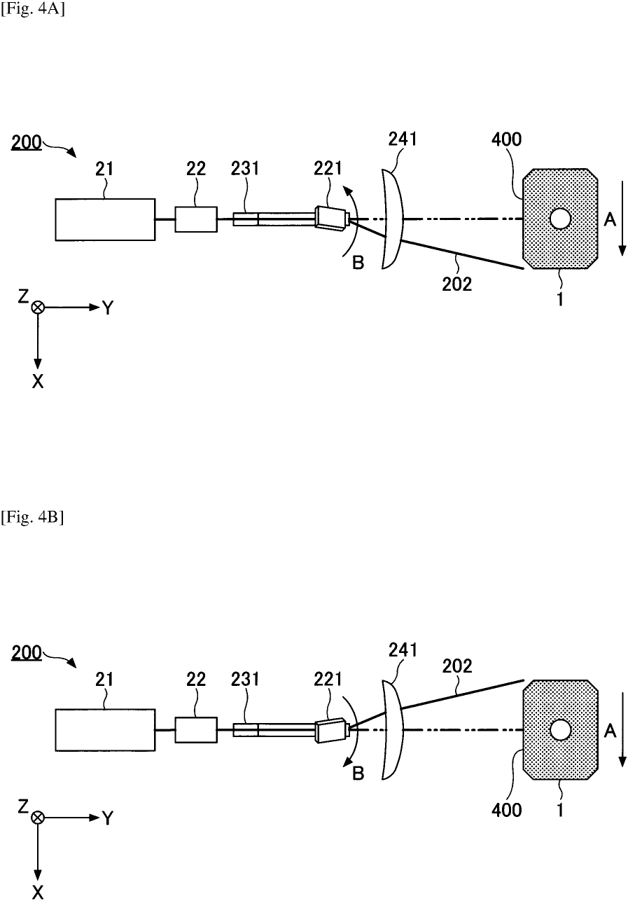

FIGS. 4A and 4B are diagrams illustrating an example of an operation of the galvanomirror 221. FIG. 4A illustrates an example of scanning in the X-axis positive direction, and FIG. 4B illustrates an example of scanning in the X-axis negative direction. By oscillating the galvanomirror 221 along the direction of the arrow B, the scanning light 202 scanned by the polygon mirror 231 can be scanned in the arrow A direction. In FIG. 4A, the scanning light 202 is scanned in the X-axis positive direction, and in FIG. 4B, the scanning light 202 is scanned in the X-axis negative direction. That is, the polygon mirror 231 scans the scanning light 202 in the intersecting direction, at two positions along the conveying direction.

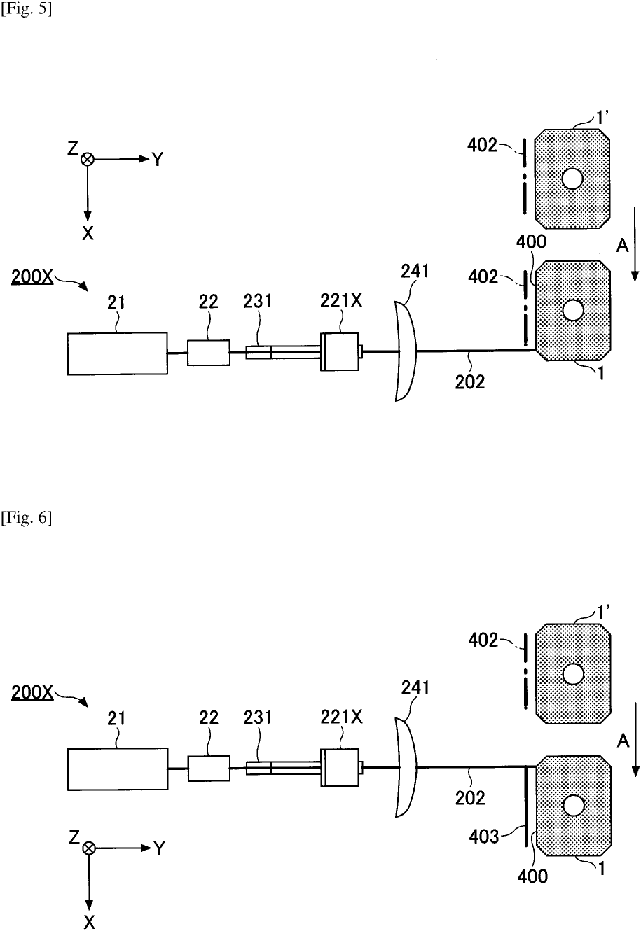

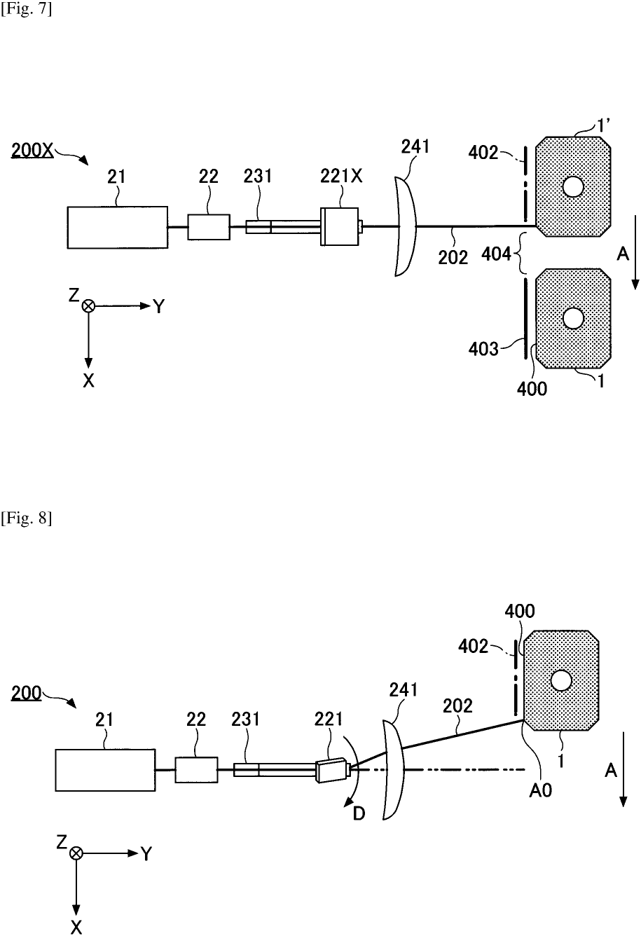

Next, an operation of a pattern forming apparatus 200X according to a comparative example will be described with reference to FIGS. 5 to 7. FIG. 5 is a top view illustrating a first example of the operation of the pattern forming apparatus 200X, FIG. 6 is a top view illustrating a second example of the operation of the pattern forming apparatus 200X, and FIG. 7 is a top view illustrating a third example of the operation of the pattern forming apparatus 200X. In the pattern forming apparatus 200X, the elements having the same functions as those of the pattern forming apparatus 200 are denoted by the same reference numerals as those of the pattern forming apparatus 200, as a matter of convenience.

As illustrated in FIGS. 5 to 7, the pattern forming apparatus 200X includes a Z-axis direction deflection mirror 221X. The Z-axis deflection mirror 221X deflects, toward the Z-axis positive direction, the pulse laser light whose beam diameter has been enlarged by the beam expander 22 at the Y-axis positive direction side of the beam expander 22. The Z-axis direction deflection mirror 221X has no oscillating function like the galvanomirror 221 described above, and along the conveying direction, the position where the polygon mirror 231 scans the pulse laser light, is only at one fixed position.

FIGS. 5 to 7 illustrate how the pattern forming apparatus 200X emits the scanning light 202 while the plurality of containers, that is, the container 1 and the container 1′, are conveyed in the arrow A direction. In FIG. 5, the pattern forming apparatus 200X emits the scanning light 202 to the most X-axis positive direction side of the container 1. In FIG. 6, the pattern forming apparatus 200X emits the scanning light 202 to the most X-axis negative direction side of the container 1, and in FIG. 7, the pattern forming apparatus 200X emits the scanning light 202 to the most X-axis positive direction side of the container 1′.

Pattern formation uncompleted regions 402 in FIGS. 5 to 7 represent regions where patterns have not yet been formed on the container 1 or the container 1′. Pattern formation completed regions 403 represent regions where patterns have been formed on the container 1 or the container 1′.

As illustrated in FIG. 7, there is a non-pattern formation section 404 between the container 1 and the container 1′ in the conveying direction corresponding to the distance between the container 1 and the container 1′ adjacent to each other in the conveying direction. The length of the non-pattern formation section 404 in the conveying direction is an example of a predetermined interval. In the pattern forming apparatus 200X, the base material of the container 1 and the base material of the container 1′ cannot be patterned while the scanning light 202 is emitted to the non-pattern formation section 404, resulting in a waste of productivity.

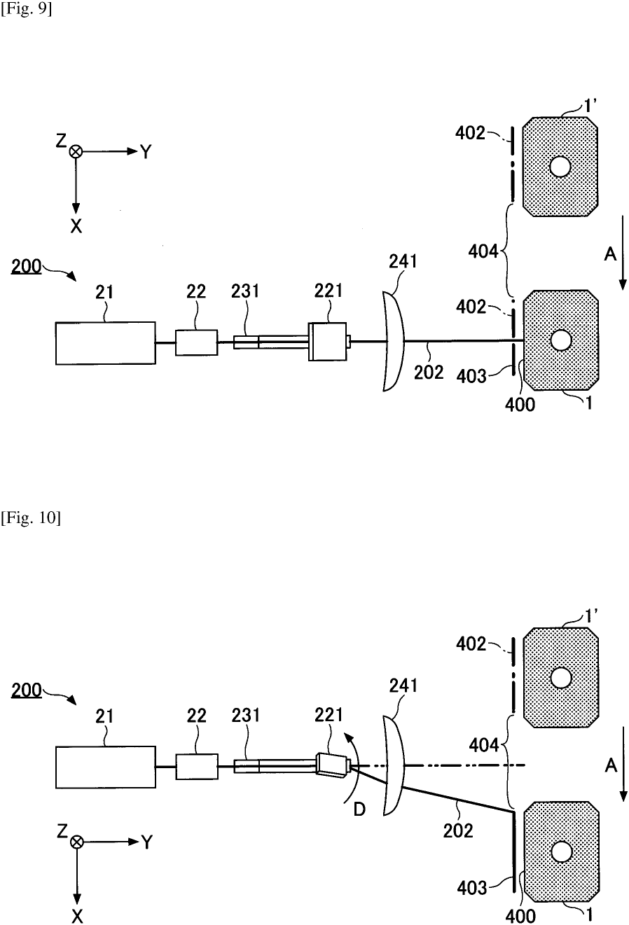

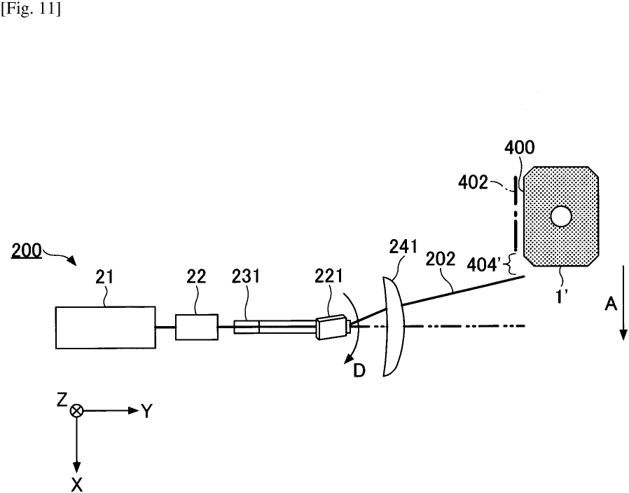

Next, an operation of the pattern forming apparatus 200 according to the present embodiment will be described with reference to FIGS. 8 to 11. FIG. 8 is a top view illustrating a first example of the operation of the pattern forming apparatus 200, FIG. 9 is a top view illustrating a second example of the operation of the pattern forming apparatus 200, FIG. 10 is a top view illustrating a third example of the operation of the pattern forming apparatus 200, and FIG. 11 is a top view illustrating a fourth example of the operation of the pattern forming apparatus 200.

FIGS. 8 to 11 illustrate how the pattern forming apparatus 200 emits the scanning light 202 while the plurality of containers, that is, the container 1 and the container 1′, are conveyed in the conveying direction, similar to FIGS. 5 to 7.

In FIG. 8, the galvanomirror 221 scans (deflects), in the X-axis negative direction, the scanning light 202 scanned by the polygon mirror 231, so that the pattern forming apparatus 200 emits the scanning light 202 to the position (an initial position A0) at the most X-axis positive direction of the container 1, before the container 1 reaches the position facing the fθ lens 241.

In FIG. 9, the pattern forming apparatus 200 emits the scanning light 202 to the center of the container 1 at a position where the container 1 faces the fθ lens 241. In FIG. 10, the pattern forming apparatus 200 scans (deflects) the scanning light 202 in the X-axis positive direction by the galvanomirror 221, so that after the container 1 passes the position facing the fθ lens 241, the pattern forming apparatus 200 emits the scanning light 202 to the position at the most X-axis negative direction of the container 1.

The containers 1 and 1′ are conveyed at a conveying speed V′ and the pattern forming apparatus 200 forms a pattern on the base material configuring the container 1 while the angle of the galvanomirror 221 changes in accordance with the conveying of the container 1. In the state of FIG. 8, pattern formation on the pattern formation uncompleted region 402 of the base material is started, and in the state of FIG. 9, a pattern is formed in half of the pattern formation uncompleted region 402 so that this half becomes the pattern formation completed region 403. In the state of FIG. 10, pattern formation of the base material is completed and the entire base material is the pattern formation completed region 403.

Subsequently, in FIG. 11, the galvanomirror 221 changes the angle so that the pattern forming apparatus 200 emits the scanning light 202 to a position that is shifted in the X-axis positive direction by an amount corresponding to a non-pattern formation section 404′ from the position at the most X-axis positive direction side of the next container 1′. Subsequently, the pattern forming apparatus 200 conveys the container 1′ in the X-axis positive direction and starts pattern formation on the container 1′ when the state becomes that of FIG. 8.

Assuming that the conveying speed of the container 1 is V and the non-pattern formation section is b in the pattern forming apparatus 200X, and the conveying speed of the container 1 is V′ and the non-pattern formation section is b′ in the pattern forming apparatus 200, the following formula (6) is established.

$$\text{V′} / \text{V} \text{=} \text{b} / \text{b′} \qquad \text{(6)}$$

The smaller the non-pattern formation section 404′, the higher the productivity. However, if the following condition formula (7) is satisfied, the productivity effect according to the present embodiment can be improved.

$$0.4 < \text{Lx} / \left(\text{Lx+S}\right) < 1 \qquad \text{(7)}$$

Here, Lx represents the size of the pattern in the conveying direction, and S represents the interval between the container 1 and the container 1′ in the conveying direction. In the present embodiment, S corresponds to the length of the non-pattern formation section 404 in the conveying direction. By a condition of 0.4 or less, the productivity does not differ from the comparative example. By fulfilling a condition greater than 0.4, the pattern forming apparatus 200 can implement following control (in a manner as to follow the conveyance of the container) and can perform pattern formation with high accuracy.

In an embodiment, after scanning the scanning light 202 in the conveying direction by the polygon mirror 231, the galvanomirror 221 returns the irradiation position of the scanning light 202 according to the polygon mirror 231, to the initial position A0 (see FIG. 8) of scanning in the conveying direction, within a shorter time than that required for scanning in the conveying direction. This initial position A0 corresponds to the irradiation position of the scanning light 202 in the conveying direction illustrated in FIG. 8. The scanning in the conveying direction corresponds to changing the irradiation position of the scanning light 202 in the conveying direction from the irradiation position illustrated in FIG. 8 to the irradiation position illustrated in FIG. 10. Accordingly, it can be said that the time for returning from the state of FIG. 10 to the state of FIG. 8 can be shorter than the time for changing from the state of FIG. 8 to the state of FIG. 10.

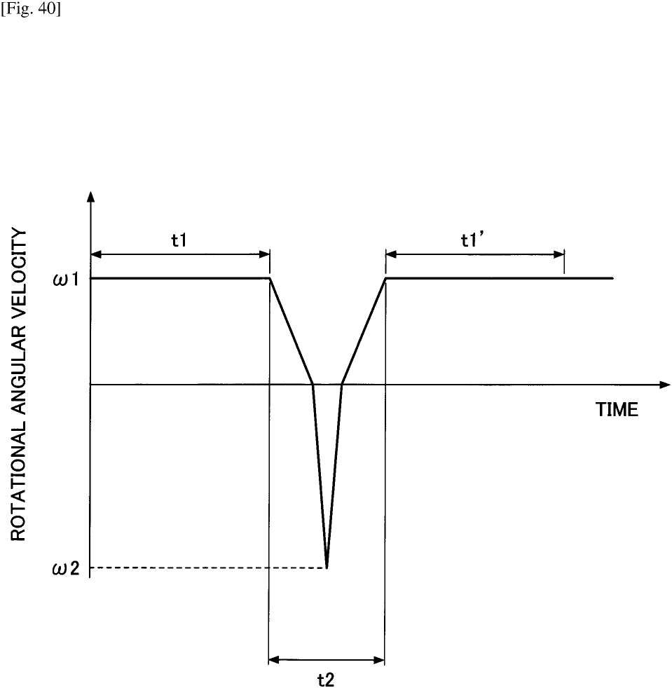

FIG. 40 is a diagram illustrating an example of the relationship between the time required for the scanning in the conveying direction and the time required for returning to the initial position A0 of scanning in the conveying direction. In FIG. 40, the horizontal axis represents time and the vertical axis represents the rotational angular velocity of the galvanomirror 221.

In FIG. 40, a time period t1 represents the time period during which the galvanomirror 221 scans, in the conveying direction, the scanning light 202 scanned by the polygon mirror 231 for performing pattern formation onto the predetermined container 1. A time period t2 represents the time period during which the irradiation position of the scanning light 202 scanned by the polygon mirror 231 is returned to the initial position A0 of scanning in the conveying direction after the scanning in the conveying direction for pattern formation onto the predetermined container 1 is completed. A time period t1′ represents the time period during which the galvanomirror 221 scans, in the conveying direction, the scanning light 202 scanned by the polygon mirror 231 for performing pattern formation onto another container adjacent to the predetermined container 1 that is the target to be patterned next after the predetermined container 1.

As illustrated in FIG. 40, with respect to the rotational angular velocity ω1 of the galvanomirror 221 in the periods t1 and t1′, the rotational angular velocity ω2 of the galvanomirror 221 in the period t2 has a reversed sign in terms of positive and negative and has and an absolute value that is increased. That is, in the periods t1 and t1′, the galvanomirror 221 rotates in the positive direction by the rotational angular velocity ω1, and in the period t2, the galvanomirror 221 rotates in the negative direction by the rotational angular velocity ω2 that is faster than the rotational angular velocity ω1. Thus, the galvanomirror 221 can return the irradiation position of the scanning light 202 scanned by the polygon mirror 231 to the initial position A0 of scanning in the conveying direction within the period t2 that is shorter than each of the periods t1 and t1′.

### Effect of the Pattern Forming Apparatus 200

Next, an effect of the pattern forming apparatus 200 will be described.

Conventionally, a pattern forming apparatus in which a laser beam is emitted to form a pattern on a base material such as a resin material, has been known. There is also disclosed a method of forming a pattern on a base material by one-dimensional scanning of a pulse laser beam. However, in order to form a pattern on the base material, it is necessary to emit the pulse laser light for a period of time required for the base material to denature sufficiently.

In a method in which a pulse laser beam is scanned one dimensionally to form a pattern on a base material, the higher the conveying speed of the base material, the shorter the time available for pattern formation, and a pattern cannot be properly formed on the conveyed base material. However, if the conveying speed of the base material is reduced to a speed such that a pattern can be properly formed, the productivity of pattern formation may be reduced.

In the present embodiment, the galvanomirror 221 scans the laser light in the conveying direction so that the polygon mirror 231 scans the laser light in the intersecting direction at a plurality of positions along the conveying direction.

This allows for a longer time for the base material to be irradiated with the laser light and a longer pattern formation time, compared to the case of scanning the laser light at one position along the conveying direction. As a result, the conveying speed of the base material can be maintained at the desired speed, to ensure the productivity of pattern formation.

The polygon mirror 231 may be replaced by a galvanomirror, an acousto-optic element, a Micro Electro Mechanical System (MEMS) mirror, or the like. However, it is preferable that such an element has durability with respect to the pulse energy of the pulse laser beam.

In the present embodiment, the polygon mirror 231 is configured to scan, in the intersecting direction, the laser light after being deflected by the galvanomirror 221 in the conveying direction. However, the galvanomirror 221 may be configured to scan, in the conveying direction, the laser light after being scanned by the polygon mirror 231 in the intersecting direction. Further, a biaxially-driven galvanomirror, a MEMS mirror, or an acousto-optic element capable of scanning laser light in both the conveying direction and the intersecting direction, may be used.

However, it is more preferable that the galvanomirror 221 scans the laser light in the conveying direction and the polygon mirror 231 scans the laser light in the intersecting direction, because with this configuration, high-speed scanning is enabled while ensuring durability against the pulse laser light.

In the present embodiment, in the pattern forming apparatus 200, when the galvanomirror 221 (the first light scanning unit) scans the laser light in the conveying direction, the polygon mirror 231 (the second light scanning unit) scans the laser light in the scanning direction at a plurality of positions along the conveying direction. The pattern forming apparatus 200 changes, in the conveying direction by the galvanomirror 221, the irradiation position of the scanning light scanned by the polygon mirror 231, in accordance with the position of the container 1 (the base material) being conveyed, and forms a two-dimensional pattern on the container 1.

In this way, the pattern forming apparatus 200 can increase the time in which the laser light is emitted onto the base material compared to the case in which the second light scanning unit scans the laser light at only one position along the conveying direction, thereby increasing the pattern formation time. Accordingly, the pattern forming apparatus 200 can ensure the conveying speed of the base material to ensure the productivity of pattern formation with respect to the base material being conveyed.

As the second light scanning unit, the polygon mirror may be replaced by a galvanomirror, an acousto-optic element, a Micro Electro Mechanical System (MEMS) mirror, or the like. However, it is preferable that such an element has durability with respect to the pulse energy of the pulse laser beam.

In the present embodiment, a configuration in which the pulse laser light after being scanned in the conveying direction by the first light scanning unit, is scanned in the scanning direction by the second light scanning unit is described. However, the pattern forming apparatus 200 may have a configuration in which the pulse laser light after being scanned in the scanning direction by the second light scanning unit, is scanned in the conveying direction by the first light scanning unit. Further, the pattern forming apparatus 200 can combine the functions of the first light scanning unit and the second light scanning unit by using a biaxially-driven galvanomirror, a MEMS mirror, and an acousto-optic element capable of scanning the pulse laser light in both the conveying direction and the scanning direction.

However, it is preferable that the first light scanning unit is configured by a galvanomirror, and the second light scanning unit is configured by a polygon mirror, because the pattern forming apparatus 200 will be capable of high-speed scanning while ensuring durability against pulse laser light.

In the present embodiment, the pattern forming apparatus 200 satisfies the following formula (8).

$$\text{Δ} \text{V} ≧ \text{V-} \text{Lx} / \left({\text{t}}_{\text{L}} ⋅ \text{N}\right) \qquad \text{(8)}$$

In in the above formula (8), ΔV represents the scanning speed of the laser light scanned by the galvanomirror 221 in the conveying direction, V represents the conveying speed of the container 1, and Lx represents the size of the pattern in the conveying direction. Further, t_{L} represents the scanning time of one scanning line of the intersecting scanning line corresponding to the scanning line in the direction (the intersecting direction) orthogonal to the conveying direction, and N represents the number of scanning lines of the intersecting scanning lines necessary for forming the two-dimensional pattern.

For example, if the scanning time t_{L} needs to be increased in order to form a pattern having the size Lx in the conveying direction, the conveying speed of the container 1 needs to be reduced, and the productivity of forming a pattern onto the container 1 decreases as the conveying speed is reduced. Particularly, in pattern formation on the container 1, it may take time for the container 1 to denature in the region irradiated by the laser light, and the scanning time t_{L} is likely to be long.

By determining the scan speed ΔV to satisfy the condition of the above formula (8), the apparent conveying speed of the container 1 in the conveying direction can be slowed. Accordingly, the scanning time tL can be increased without slowing the actual conveying speed V, and the time of performing pattern formation on the container 1 can be increased. As a result, high productivity can be ensured in forming a pattern onto the container 1.

In the present embodiment, after scanning in the conveying direction, the galvanomirror 221 returns the irradiation position of the scanning light scanned by the polygon mirror 231, to the initial position A0 of scanning in the conveying direction, within a shorter time than that required for scanning in the conveying direction. Accordingly, the pattern forming apparatus 200 can ensure higher productivity in pattern formation on the container 1 being conveyed.

### First Embodiment

Next, a pattern forming apparatus 200a according to the first embodiment will be described. Note that the same reference numerals are assigned to the same elements as those described with respect to the pattern forming apparatus 200 of the above-described embodiment, and the overlapping descriptions are omitted accordingly. The same applies to the following embodiments.

In the embodiment described above, an example is given of the pattern forming apparatus 200 including one set of an emitting unit including the pulse laser 21, the beam expander 22, the galvanomirror 221, the polygon mirror 231, and the fθ lens 241.

On the other hand, in the present embodiment, the pattern forming apparatus 200a includes two or more emitting units, each emitting unit including the pulse laser 21, the beam expander 22, the galvanomirror 221, the polygon mirror 231, and the fθ lens 241. The emitting units form patterns onto different base materials in parallel, at different positions along the conveying direction, thereby further improving the productivity of pattern formation on multiple base materials

### Example of Configuration of the Pattern Forming Apparatus 200a

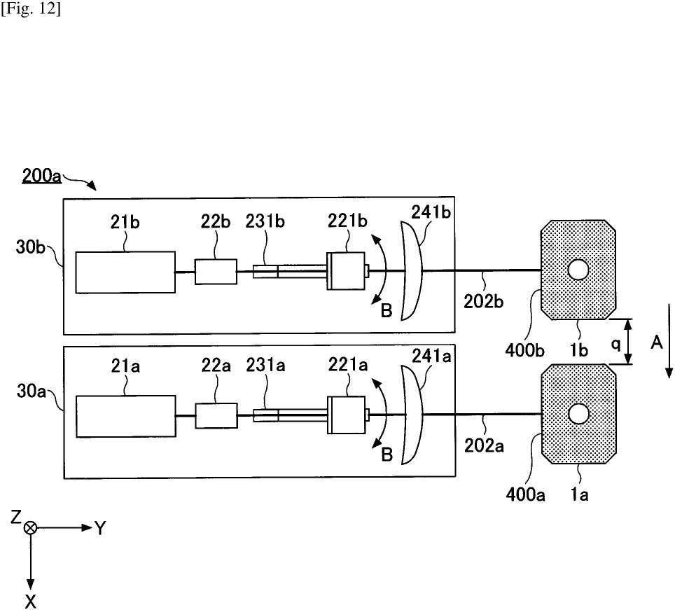

FIG. 12 is a diagram illustrating an example of a configuration of the pattern forming apparatus 200a. As illustrated in FIG. 12, the pattern forming apparatus 200a includes an emitting unit 30a and an emitting unit 30b. The emitting units 30a and 30b are arranged at different positions along the arrow A direction (conveying direction). Here, the emitting unit 30a is an example of a first emitting unit and the emitting unit 30b is an example of a second emitting unit.

The emitting unit 30a includes a pulse laser 21a, a beam expander 22a, a galvanomirror 221a, a polygon mirror 231a, and a fθ lens 241a.

The pulse laser 21a is an example of a first light source unit that emits pulse laser light (first laser light). The galvanomirror 221a is an example of a first conveying direction light scanning unit that scans the pulse laser light in the arrow A direction (the conveying direction). The polygon mirror 231a is an example of a first intersecting direction light scanning unit that scans, in the Z-axis direction (the intersecting direction), the scanning light deflected by the galvanomirror 221a. The fθ lens 241a is an example of a first light emitting unit that irradiates the base material configuring a container 1a with first scanning light 202a scanned by the polygon mirror 231a.

The configuration and function of the pulse laser 21a are similar to those of the pulse laser 21, the configuration and function of the beam expander 22a are similar to those of the beam expander 22, and the configuration and function of the galvanomirror 221a are similar to those of the galvanomirror 221. The configuration and function of the polygon mirror 231a are similar to those of the polygon mirror 231, and the configuration and function of the fθ lens 241a are similar to those of the fθ lens 241.

The emitting unit 30b includes a pulse laser 21b, a beam expander 22b, a galvanomirror 221b, a polygon mirror 231b, and a fθ lens 241b.

The pulse laser 21b is an example of a second light source unit that emits pulse laser light (second laser light). The galvanomirror 221b is an example of a second conveying direction light scanning unit that scans the pulse laser light in the arrow A direction. The polygon mirror 231b is an example of a second intersecting direction light scanning unit that scans, in the Z-axis direction (the intersecting direction), the scanning light deflected by the galvanomirror 221b. The fθ lens 241b is an example of a second light emitting unit that irradiates the base material configuring the container 1b with second scanning light 202b scanned by the polygon mirror 231b.

The configuration and function of the pulse laser 21b are similar to those of the pulse laser 21, the configuration and function of the beam expander 22b are similar to those of the beam expander 22, and the configuration and function of the galvanomirror 221b are similar to those of the galvanomirror 221. The configuration and function of the polygon mirror 231b are similar to those of the polygon mirror 231, and the configuration and function of the fθ lens 241b are similar to those of the fθ lens 241.

A container 1b is conveyed with an interval q with respect to the container 1a in the arrow A direction. The interval q is an example of a predetermined interval between a plurality of base materials in the conveying direction.

The fθ lens 241a emits the first scanning light scanned by the polygon mirror 231a onto an irradiation target surface 400a of the base material of the container 1a, which is one of a plurality of base materials that are conveyed with the intervals q between adjacent base materials in the arrow A direction.

The fθ lens 241b emits the second scanning light scanned by the polygon mirror 231b onto an irradiation target surface 400b of the base material of the container 1b, which is one of a plurality of base materials that are conveyed with the intervals q between adjacent base materials in the arrow A direction.

The other configurations and functions of the emitting unit 30a and the emitting unit 30b are the same with each other, except that the position along the arrow A direction and the container that is the target to be irradiated with the scanning light, are different.

FIG. 12 illustrates a configuration in which the pattern forming apparatus 200a includes the two emitting units 30a and 30b, but the pattern forming apparatus 200a may include two or more emitting units. Again, the other configurations and functions of the two or more emitting units are similar to each other, except that the position of each emitting unit along the arrow A direction and the container to be irradiated with the scanning light are different.

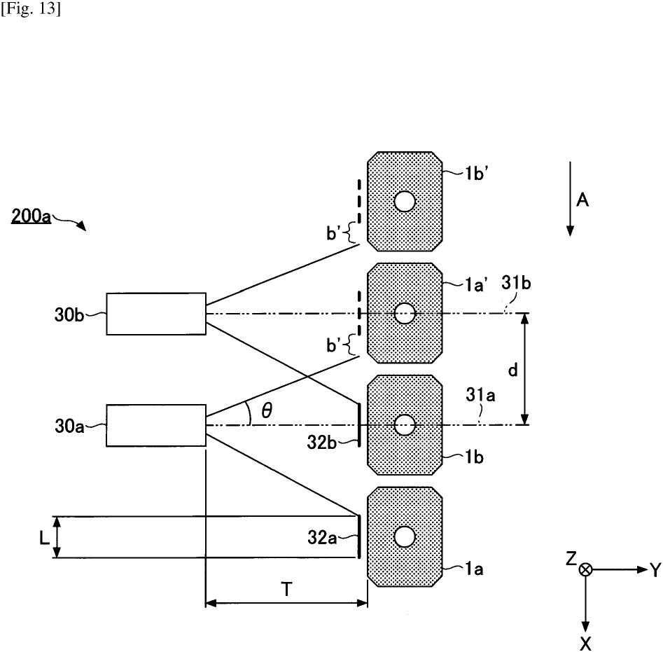

Next, FIG. 13 is a diagram illustrating an example of an arrangement of the pattern forming apparatus 200a. As illustrated in FIG. 13, the pattern forming apparatus 200a is arranged so as to satisfy the following formula (9).

$$\text{d=} \left(\text{L+2} ⋅ \text{T} ⋅ \text{tan} \text{θ} \text{+b′}\right) / \text{N} \qquad \text{(9)}$$

By satisfying formula (9), it is possible to shorten the time period in which the pattern forming apparatus 200a does not perform pattern formation with respect to the base material configuring the container, thereby improving the productivity of pattern formation.

In FIG. 13 and in the above formula (9), d represents the distance in the arrow A direction between a central axis 31a of a fθ lens 241a and a central axis 31b of a fθ lens 241b. The central axis 31a of the fθ lens 241a corresponds to the optical axis of the fθ lens 241a, and the central axis 31b of the fθ lens 241b corresponds to the optical axis of the fθ lens 241b.

Further, L represents the length of a pattern formation target region in the arrow A direction on the base material configuring the container. A pattern formation target region 32a in FIG. 13 represents the pattern formation target region on the base material of the container 1a, and a pattern formation target region 32b represents the pattern formation target region on the base material of the container 1b. L is the length in the arrow A direction of each of the pattern formation target regions 32a and 32b.

Further, T represents the distance between the emitting unit 30a or 30b and the base material configuring the container 1a. The base material configuring the container 1a corresponds to the base material positioned at the shortest distance from the emitting units 30a and 30b in the Y-axis direction among the base materials configuring the container 1a. In the Y-axis direction, the emitting unit 30a and the emitting unit 30b are disposed at substantially the same position, so that the distance between the emitting unit 30a and the base material and the distance between the emitting unit 30b and the base material are substantially the same. Thus, either the distance between the emitting unit 30a and the base material or the distance between the emitting unit 30b and the base material may be T. Alternatively, the average value of the distance between the emitting unit 30a and the base material and the distance between the emitting unit 30b and the base material, may be T.

Further, θ represents a half angle of the maximum light scanning angle of the galvanomirror 221a and the galvanomirror 221b, respectively.

Further, b′ represents a predetermined waiting section where each of the polygon mirror 231a and the polygon mirror 231b waits before performing scanning. Here, the waiting section means the section in which the emitting unit 30a waits until the pattern formation starts on the base material of a container 1a′ that is the next pattern formation target, after the pattern formation is completed on the base material of the container 1a. That is, the waiting section corresponds to the distance in which the containers 1a and 1a′ are conveyed, during a period of waiting until the pattern formation is started on the base material of the container 1a′ that is the next pattern formation target, after the emitting unit 30a completes the pattern formation on the base material of the container 1a.

Further, N represents the number of a plurality of emitting units including the emitting unit 30a and the emitting unit 30b. In the present embodiment, the number of emitting units is two, N = 2. However, the number of emitting units is not limited to two, and the pattern forming apparatus 200a may include three or more emitting units.

### Example of Operation of the Pattern Forming Apparatus 200a

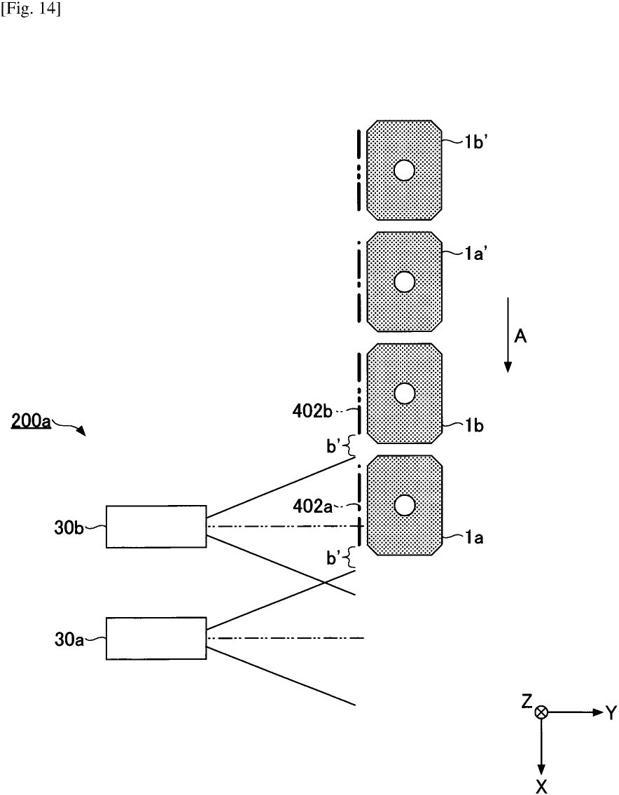

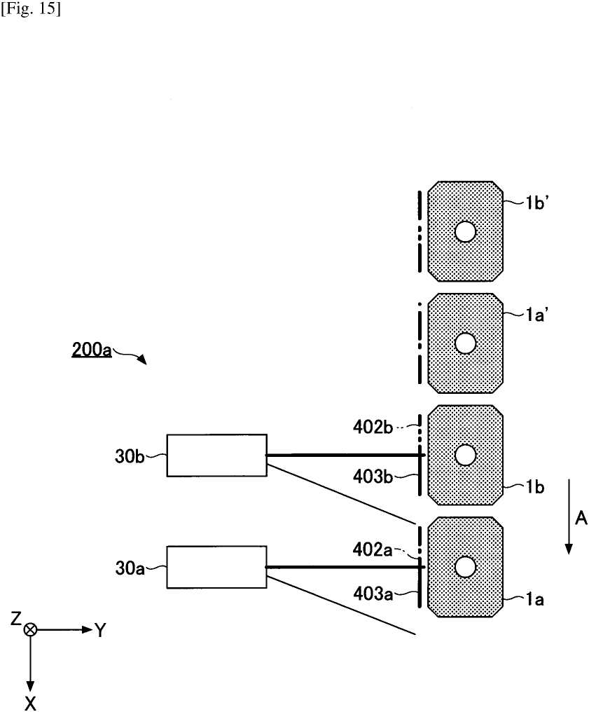

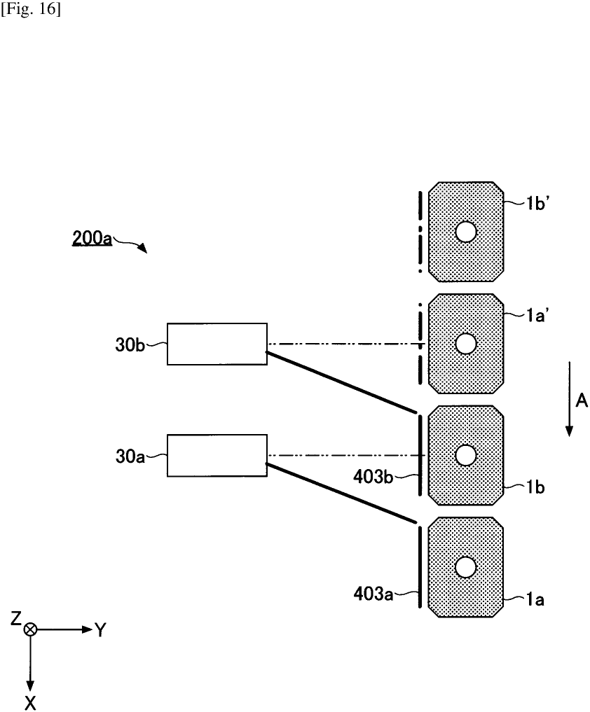

Next, an operation of the pattern forming apparatus 200a will be described with reference to FIGS. 14 to 16. FIG. 14 is a diagram illustrating a first example, FIG. 15 is a diagram illustrating a second example, and FIG. 16 is a diagram illustrating a third example of the operation of the pattern forming apparatus 200a.

FIG. 14 illustrates a state where the containers 1a, 1b, 1a′, and 1b′ are being conveyed in the arrow A direction. The emitting unit 30a irradiates the base material of the container 1a and the base material of the container 1a′ with the first scanning light to form a pattern. The emitting unit 30b irradiates the base material of the container 1b and the base material of the container 1b′ with the second scanning light to form a pattern.

A pattern formation uncompleted region 402a, indicated by a dash-dot-dash line, represents a region in which a pattern has not yet been formed on the base material of the container 1a. A pattern formation uncompleted region 402b, indicated by a dash-dot-dot-dash line, represents a region in which a pattern has not yet been formed on the base material of the container 1b.

Next, FIG. 15 illustrates a state where the containers 1a, 1b, 1a′ and 1b′ are further conveyed from the state of FIG. 14, in the arrow A direction. On the container 1a, the pattern formation has progressed up to half of the pattern formation target region in the arrow A direction, and on the container 1b, the pattern formation has progressed up to half of the pattern formation target region in the arrow A direction.

Thus, a pattern formation completed region 403a represents the region where the pattern has been formed on the container 1a, and the pattern formation uncompleted region 402a represents the region where the pattern has not yet been formed on the container 1a.

A pattern formation completed region 403b represents the region where the pattern has been formed on the container 1b, and the pattern formation uncompleted region 402b represents the region where the pattern has not yet been formed on the container 1b.

The galvanomirror 221a changes the position of the first scanning light in the arrow A direction so as to follow the conveyance of the container 1a, and the galvanomirror 221b changes the position of the second scanning light in the arrow A direction so as to follow the conveyance of the container 1b.

Next, FIG. 16 illustrates a state where the containers 1a, 1b, 1a′ and 1b′ are further conveyed from the state of FIG. 15 in the arrow A direction. On the container 1a, the pattern formation on the entire pattern formation target region in the arrow A direction is completed, and on the container 1b, the pattern formation of the entire pattern formation target region in the arrow A direction is completed.

After pattern formation is completed, the galvanomirror 221a changes the position of the first scanning light in the arrow A direction so as to return to the state of FIG. 14, and the galvanomirror 221b changes the position of the second scanning light in the arrow A direction so as to return to the state of FIG. 14.

In this way, the two emitting units 30a and 30b perform pattern formation in parallel, thereby allowing the productivity of pattern formation to be improved compared to the case where there is only one emitting unit. The larger the number of emitting units performing pattern formation in parallel, the higher the productivity.

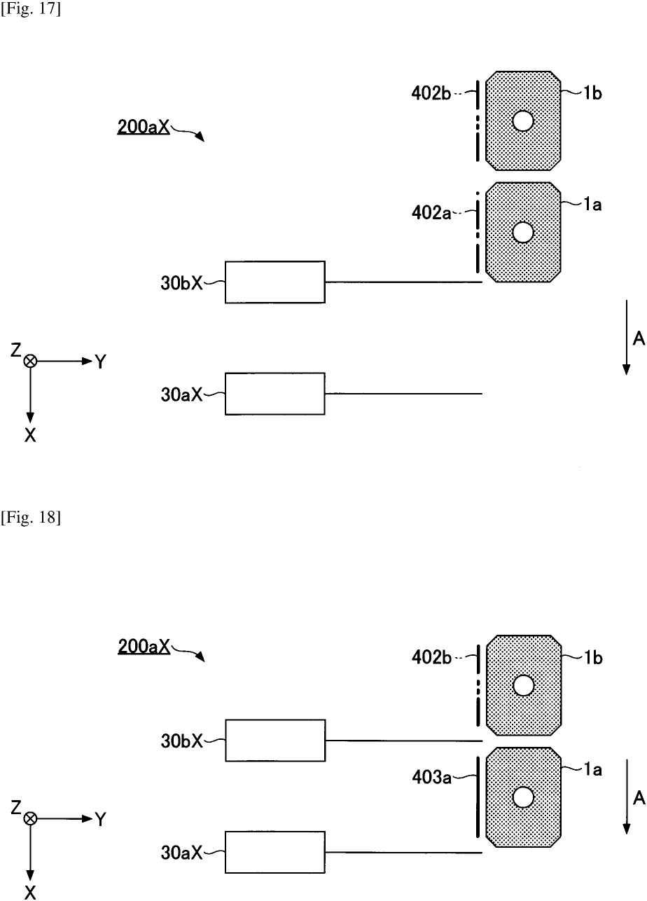

Here, FIG. 17 is a diagram illustrating a first example of an operation of a pattern forming apparatus 200aX according to a comparative example, and FIG. 18 is a diagram illustrating a second example of an operation of the pattern forming apparatus 200aX.

As illustrated in FIGS. 17 and 18, the pattern forming apparatus 200aX includes two emitting units 30aX and 30bX. Neither one of the emitting units 30aX or 30bX has a first conveying direction light scanning unit or a second conveying direction light scanning unit, such as a galvanomirror, for scanning pulse laser light in the arrow A direction.

The conveyed container 1a enters the irradiation position where the scanning light is emitted by the emitting unit 30bX, and as the container 1a is conveyed, the pattern formation progresses and eventually the pattern formation ends. Subsequently, the container 1a enters the irradiation position where the scanning light is emitted by the emitting unit 30aX. The pattern has already been formed on the container 1a, and, therefore, pattern formation cannot be performed during the time period in which the container 1a is passing by the irradiation position of the scanning light emitted by the emitting unit 30aX. Thus, the productivity of pattern formation is reduced.

In order to increase the productivity of pattern formation by the pattern forming apparatus 200aX, it is necessary to increase the number of the pattern forming apparatuses 200aX. This results in a larger area occupied by the apparatuses and an increase in cost.

### Example of Operation of a Pattern Forming Apparatus 200b According to Modified example

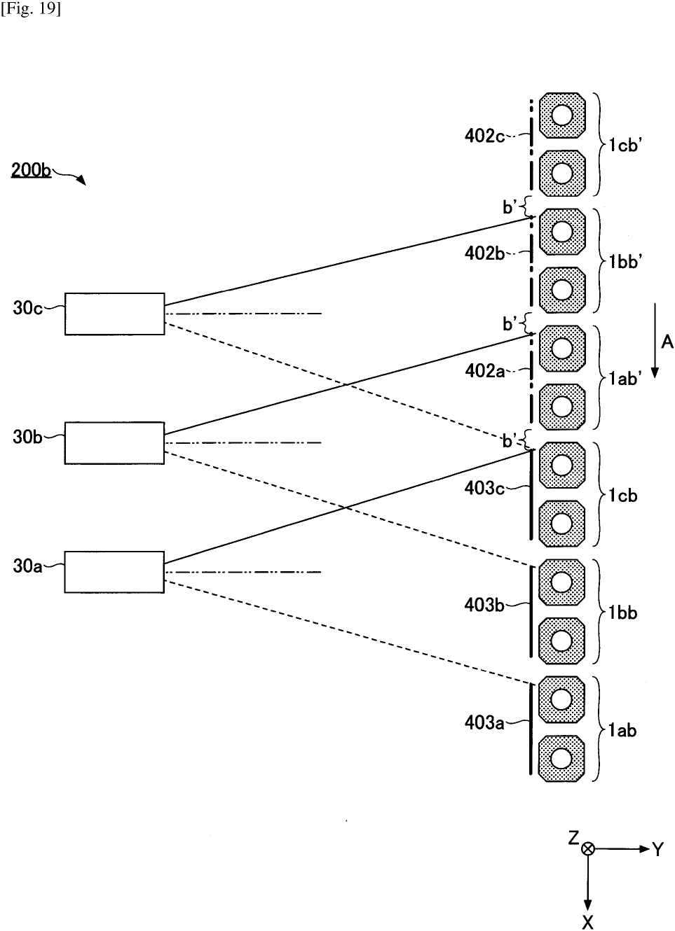

Next, an operation of the pattern forming apparatus 200b according to a modified example of the first embodiment will be described with reference to FIG. 19. FIG. 19 is a diagram illustrating an example of an operation of the pattern forming apparatus 200b.

The pattern forming apparatus 200b forms a pattern on a small container compared to a container subject to pattern formation by the pattern forming apparatus 200a according to the first embodiment. The pattern forming apparatus 200b includes emitting units 30a, 30b, and 30c and forms patterns with respect to a group of containers including two containers, within a time period of scanning once in the arrow A direction.

For example, in the example of FIG. 19, the emitting unit 30a has already completed the pattern formation on the pattern formation completed region 403a, and will subsequently perform pattern formation on the pattern formation uncompleted region 402a. At this time, at the time point when the emitting unit 30a has completed pattern formation on the pattern formation completed region 403a, pattern formation completed regions 403b and 403c enter the irradiation range of laser light emitted by the emitting unit 30a. However, the emitting unit 30a skips these pattern formation completed regions 403b and 403c, and starts pattern formation with respect to a pattern formation uncompleted region 402a.

The emitting unit 30b has already completed the pattern formation on the pattern formation completed region 403b, and will subsequently perform pattern formation on the pattern formation uncompleted region 402b. At this time, at the time point when the emitting unit 30b has completed pattern formation on the pattern formation completed region 403b, the pattern formation completed region 403c and the pattern formation uncompleted region 402a enter the irradiation region of laser light emitted by the emitting unit 30b. However, the emitting unit 30b skips these regions, i.e., the pattern formation completed region 403c and the pattern formation uncompleted region 402a, and starts pattern formation with respect to the pattern formation uncompleted region 402b.

The emitting unit 30c has already completed the pattern formation on the pattern formation completed region 403c, and will subsequently perform pattern formation on a pattern formation uncompleted region 402c. At this time, at the time point when the emitting unit 30c has completed pattern formation on the pattern formation completed region 403c, the pattern formation uncompleted regions 402a and 402b enter the irradiation region of laser light emitted by the emitting unit 30c. However, the emitting unit 30c skips these pattern formation uncompleted regions 402a and 402b, and starts pattern formation with respect to the pattern formation uncompleted region 402c.

That is, with respect to the irradiation range of laser light emitted by one emitting unit, the irradiation range of laser light emitted by each emitting unit, including the arrangement or the waiting time of each light emitting unit, is defined by an interval (distance) at which the container to be patterned is conveyed.

Assuming that the number of emitting units is N and the number of containers included in each container group is M, the interval between adjacent containers in the container group subjected to pattern formation by one emitting unit, is (N-1)×M.

### Effect of the Pattern Forming Apparatus 200a

As described above, the pattern forming apparatus 200a according to the present embodiment includes the emitting unit 30a and the emitting unit 30b. In the emitting unit 30a, the galvanomirror 221a (the first conveying direction light scanning unit) scans, in the conveying direction, the pulse laser light (the first laser light) emitted by the pulse laser 21a (the first light source unit). The polygon mirror 231a (the first intersecting direction light scanning unit) scans, in the intersecting direction intersecting the conveying direction, the scanning light scanned by the galvanomirror 221a, and the fθ lens 241a (the first light emitting unit) irradiates the base material with the first scanning light scanned by the first intersecting direction light scanning unit.

In the emitting unit 30b, the galvanomirror 221b (the second conveying direction light scanning unit) scans the pulse laser light (the second laser light) emitted by the pulse laser 21b (the second light source unit), the polygon mirror 231b (the second intersecting direction light scanning unit) scans, in the intersecting direction, the scanning light scanned by the galvanomirror 221b (the second conveying direction light scanning unit), and the fθ lens 241b (the second light emitting unit) irradiates the base material with the second scanning light scanned by the polygon mirror 231b (the second intersecting direction light scanning unit).

The fθ lens 241a emits the first scanning light on a base material different from the base material onto which the fθ lens 241b emits the second scanning light, among a plurality of base materials, at a position different from that of the fθ lens 241b along the conveying direction.

By scanning the first scanning light in the conveying direction, compared to the case where the first scanning light is scanned only at one position along the conveying direction, the time during which the first scanning light can be emitted onto the base material is increased and the pattern formation time is increased. This allows the conveying speed of the base material to be maintained at a desired speed to ensure the productivity of pattern formation.

Furthermore, by emitting the first scanning light onto a base material that is different from the base material irradiated with the second scanning light, at a position different from that of the second scanning light along the conveying direction, patterns can be formed in parallel with respect to different base materials. This can further improve the productivity of pattern formation for multiple base materials.

Further, according to the present embodiment, each element of the pattern forming apparatus 200a is disposed so as to satisfy the above-described formula (9). Accordingly, the time period in which the pattern forming apparatus 200a does not perform the pattern formation on a base material configuring a container can be shortened, thus improving the productivity of the pattern formation.

In the present embodiment, the fθ lens 241a emits the first scanning light on a plurality of base materials conveyed with the interval q between adjacent base materials in the conveying direction, and the fθ lens 241b emits the second scanning light on a plurality of base materials conveyed with the interval q between adjacent base materials in the conveying direction.

When adjacent base materials are conveyed at intervals q in the conveying direction, a configuration that does not include the galvanomirror 221a or the galvanomirror 221b, is not capable of performing pattern formation at the section of the interval q, and thus the productivity of pattern formation is reduced.

In the present embodiment, the galvanomirror 221a and the galvanomirror 221b can change the irradiation position of the first scanning light and the second scanning light in the conveying direction, and, therefore, pattern formation on the base material is possible even at the section of the interval q. Accordingly, the productivity of pattern formation can be improved.

In the present embodiment, the pulse laser light is scanned in the conveying direction by the galvanomirrors 221a and 221b, and the first scanning light and the second scanning light are scanned in the intersecting direction intersecting the conveying direction by the polygon mirrors 231a and 231b. Accordingly, high-speed scanning is enabled while ensuring durability against pulse laser light.

### Second Embodiment

Next, a second embodiment will be described. In the present embodiment, a manufacturing apparatus and a method for manufacturing a container will be described. Here, the apparatus for manufacturing a container (container manufacturing apparatus) corresponds to an example of a pattern forming apparatus. The container manufacturing apparatus also corresponds to an example of a laser processing apparatus in which a pattern is formed by processing, with a pulse laser, a base material configuring the container. The manufacturing apparatus according to each of the following embodiments includes the configuration and function of any one of the above-described pattern forming apparatuses 200, 200a, and 200b, and can achieve the same effect as the pattern forming apparatuses 200, 200a, and 200b.

### Example of Configuration of a Manufacturing Apparatus 100

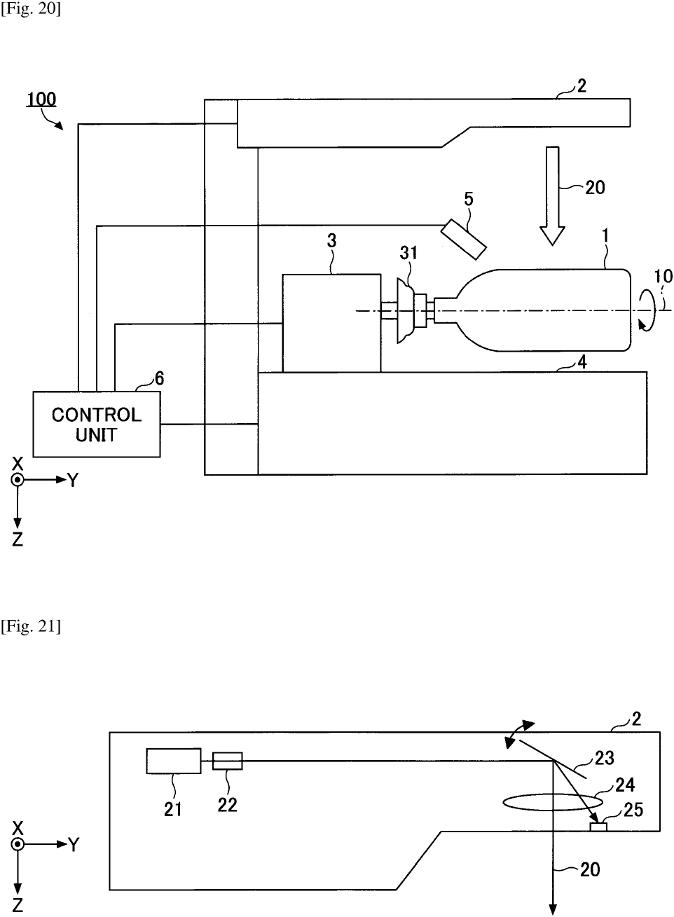

First, the configuration of the manufacturing apparatus 100 will be described. FIG. 20 is a diagram illustrating an example of a configuration of the manufacturing apparatus 100. The manufacturing apparatus 100 changes the property of a base material configuring a container to form a first pattern configured by an assembly of second patterns, on at least one of the surface or the interior of the base material. Here, the property of the base material means the quality or the state of the base material.

As illustrated in FIG. 20, the manufacturing apparatus 100 includes a laser emitting unit 2, a rotation mechanism 3 for rotating a processing target object, a holding unit 31, a moving mechanism 4, a dust collecting unit 5, and a control unit 6. The manufacturing apparatus 100 rotatably holds the container 1, which is a cylindrical container, about a cylindrical axis 10 of the container 1 via the holding unit 31. Then, by irradiating the container 1 with the pulse laser light from the laser emitting unit 2 and changing the property of the base material configuring the container 1, a first pattern, which is an assembly of the second patterns, is formed on the surface of the container 1. Hereinafter, for the purpose of simplifying the description, the first pattern, which is configured by an assembly of the second patterns, may be referred to as the first pattern as appropriate.

The laser emitting unit 2 scans, in the Y direction of FIG. 20, the pulse laser light emitted from the pulse laser, and emits a processing laser beam 20 toward the container 1 disposed in the Z-axis positive direction. The laser emitting unit 2 will be described in detail with reference to FIG. 21.

The rotating mechanism 3 holds the container 1 via the holding unit 31. The holding unit 31 is a coupling member connected to the motor shaft of a motor as a driving unit provided in the rotating mechanism 3, and one end of holding unit 31 is inserted into the opening of the container 1 to hold the container 1. By the rotation of the motor shaft, the holding unit 31 rotates to rotate the container 1 held by the holding unit 31 about the cylindrical axis 10.

The moving mechanism 4 is a linear motion stage including a table, and the rotating mechanism 3 is mounted on the table of the moving mechanism 4. The moving mechanism 4 moves the table back and forth in the Y direction to move the rotating mechanism 3, the holding unit 31, and the container 1 back and forth together in the Y direction.

The dust collecting unit 5 is an air suction device positioned in the vicinity of the portion of the container 1 to which the processing laser beam 20 is emitted. The plume and dust, which are generated when forming the first pattern by emitting the processing laser beam 20, are collected by suction of air to prevent the plume and dust from soiling the manufacturing apparatus 100, the container 1, and the surrounding.

The control unit 6 is electrically connected to each of the pulse laser 21, a scanning unit 23 (see FIG. 21), the rotating mechanism 3, the moving mechanism 4, and the dust collecting unit 5 via a cable or the like, and the control unit 6 outputs a control signal to control the operation of each of these elements.

The manufacturing apparatus 100 emits the processing laser beam 20 scanned in the Y direction onto the container 1 by the laser emitting unit 2, under the control of the control unit 6 while rotating the container 1 by the rotating mechanism 3. Then, the first pattern is two-dimensionally formed on at least one of the front side, the back side, and the interior of the base material of the container 1.

Here, the range of the scanning region of the processing laser beam 20 in the Y direction by the laser emitting unit 2 may be limited in some cases. Therefore, when the first pattern is to be formed in a wider range than the scanning region, the manufacturing apparatus 100 moves the container 1 in the Y direction by the moving mechanism 4 so that the irradiation position of the processing laser beam 20 on the container 1 is shifted in the Y direction. Subsequently, by scanning the processing laser beam 20 in the Y direction by the laser emitting unit 2 while rotating the container 1 again by the rotating mechanism 3, a first pattern is formed on at least one of the surface and the interior of the base material of the container 1. This allows a first pattern to be formed in a wider area of the container 1 (any region from the opening to the bottom of the bottle).

### Example of Configuration of the Laser Emitting Unit 2

Next, the configuration of the laser emitting unit 2 will be described. FIG. 21 is a diagram illustrating an example of a configuration of the laser emitting unit 2. As illustrated in FIG. 21, the laser emitting unit 2 includes the pulse laser 21, the beam expander 22, the scanning unit 23, a scanning lens 24, and the synchronization detecting unit 25.

The pulse laser 21 is a laser light source that emits, for example, a pulse laser light. The pulse laser 21 emits a pulse laser light of suitable output (light intensity) in order to change the property of at least one of the surface and the interior of the base material of the container 1 irradiated with the pulse laser light.

The pulse laser 21 is capable of controlling the ON or OFF of the emission of the pulse laser light, controlling the emission frequency of the pulse laser light, controlling the light intensity of the pulse laser light, and the like. As an example of the pulse laser 21, a pulse laser having a wavelength of 532 nm, a pulse width of 16 picoseconds of the pulse laser light, and an average output of 4.9 W, may be used. Preferably, the diameter of the pulse laser light, in the region where the property of the base material in the container 1 is to be changed, is 1 µm or more and 200 µm or less.

Further, the pulse laser 21 may be configured by one pulse laser or a plurality of pulse lasers. When a plurality of pulse lasers are used, the ON or OFF control, the emission frequency control, and the light intensity control may be performed independently for each pulse laser, or may be performed commonly for the respective pulse lasers.

The pulse laser light that is parallel light emitted from the pulse laser 21, is enlarged in diameter by the beam expander 22, and enters the scanning unit 23.

The scanning unit 23 includes a scanning mirror that changes the reflection angle by a driving unit such as a motor. By changing the reflection angle according to the scanning mirror, the incoming pulse laser light is scanned in the Y direction. The scanning mirror may be a galvanomirror, a polygon mirror, a Micro Electro Mechanical System (MEMS) mirror, or the like.

In the present embodiment, an example in which the scanning unit 23 one-dimensionally scans the pulse laser light in the Y direction is illustrated, but the present invention is not limited thereto. The scanning unit 23 may use a scanning mirror that changes the reflection angle in two directions that are orthogonal to each other to two-dimensionally scan the pulse laser light in the XY directions.

However, when the pulse laser light is emitted onto the surface of the container 1 having a cylindrical shape, the beam spot diameter on the surface of the container 1 changes according to the scanning in the X direction when the two-dimensional scanning is performed in the XY directions. Thus, in such a case, one-dimensional scanning is preferable.

The pulse laser light, which is scanned by the scanning unit 23, is emitted as the processing laser beam 20 onto at least one of the surface or the interior of the base material of the container 1.

The scanning lens 24 is a fθ lens that maintains the scanning speed of the processing laser beam 20 scanned by scanning unit 23 to be constant, and focuses the processing laser beam 20 at a predetermined position on at least one of the surface and the interior of the base material of the container 1. Preferably, the scanning lens 24 and the container 1 are arranged so as to minimize the beam spot diameter of the processing laser beam 20 in the region in which the property of the base material in the container 1 is to be changed. The scanning lens 24 may be configured by a combination of a plurality of lenses.

The synchronization detecting unit 25 outputs a synchronization detection signal used to synchronize the scanning of the processing laser beam 20 with the rotation of the container 1 by the rotation mechanism 3. The synchronization detecting unit 25 includes a photodiode for outputting an electrical signal according to the received light intensity, and outputs, to the control unit 6, the electrical signal output by the photodiode as a synchronization detection signal.

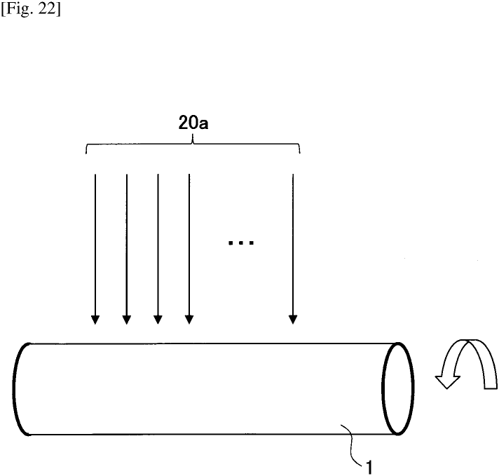

Although FIG. 21 illustrates an example of scanning a processing laser beam, it is possible to provide multiple processing laser beams in the range of the printing width, for example, to form a processing laser beam array, and rotate the container 1 to scan the container 1 in one direction with multiple laser beams. FIG. 22 illustrates an example thereof, illustrating a processing laser beam array 20a including a plurality of laser beams in parallel, being emitted to the container 1.

### Example of Hardware Configuration of the Control Unit 6

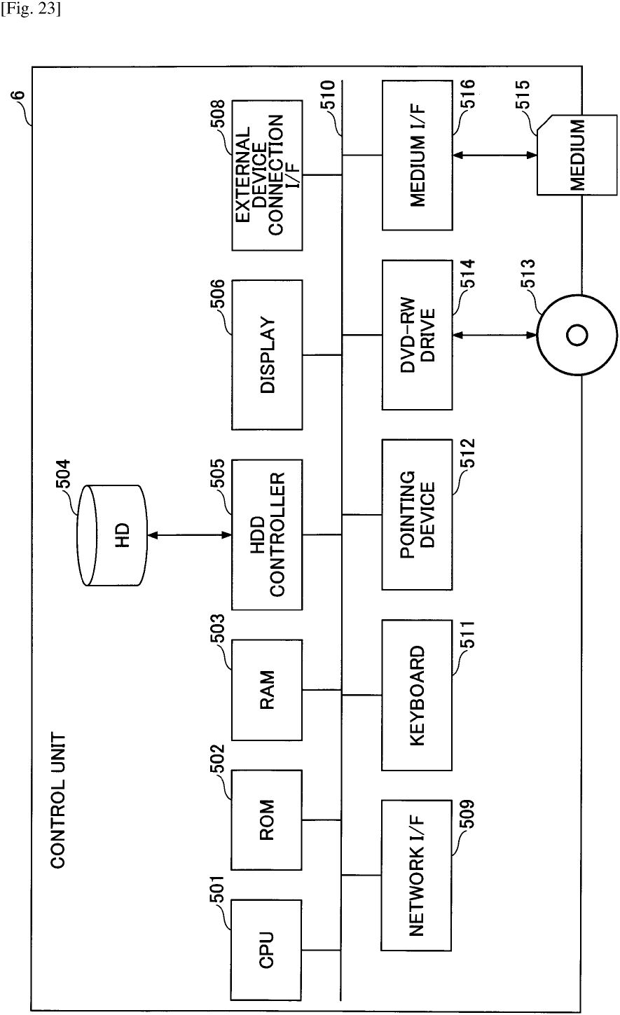

Next, the hardware configuration of the control unit 6 provided in the manufacturing apparatus 100 will be described. FIG. 23 is a block diagram illustrating an example of the hardware configuration of the control unit 6. The control unit 6 is constructed by a computer.

As illustrated in FIG. 23, the control unit 6 includes a Central Processing Unit (CPU) 501, a Read Only Memory (ROM) 502, a Random Access Memory (RAM) 503, a Hard Disk (HD) 504, a Hard Disk Drive (HDD) controller 505, and a display 506. The control unit 6 further includes an external device connection Interface (I/F) 508, a network I/F 509, a data bus 510, a keyboard 511, a pointing device 512, a Digital Versatile Disk Rewritable (DVD-RW) drive 514, and a medium I/F 516.

Among these, the CPU 501 is a processor and controls the operation of the entire control unit 6. The ROM 502 is a memory for storing a program used for driving the CPU 501, such as an Initial Program Loader (IPL).

The RAM 503 is a memory used as a work area of the CPU 501. The HD 504 is a memory for storing various kinds of data such as a program. The HDD controller 505 controls the reading or writing of various kinds of data to the HD 504 according to the control of the CPU 501.

The display 506 displays various kinds of information such as cursors, menus, windows, characters, or images. The external device connection I/F 508 is an interface for connecting various external devices. In this case, the external devices include the pulse laser 21, the scanning unit 23, the synchronization detecting unit 25, the rotating mechanism 3, the moving mechanism 4, and the dust collection unit 5. However, it is also possible to connect a Universal Serial Bus (USB) memory, a printer, etc.

The network I/F 509 is an interface for performing data communication using a communication network. The bus line 510 is an address bus, a data bus, or the like for electrically connecting elements such as the CPU 501 illustrated in FIG. 23.

The keyboard 511 is a type of input means including a plurality of keys for inputting characters, numbers, various instructions, and the like. The pointing device 512 is a type of input means for selecting and executing various instructions, selecting a processing target, moving a cursor, and the like.

The DVD-RW drive 514 controls the reading or writing of various kinds of data to a DVD-RW 513 that is an example of a removable recording medium. The recording medium is not limited to a DVD-RW, but may be a Digital Versatile Disc Recordable (DVD-R), etc. The medium I/F 516 controls the reading or writing (storage) of data to a recording medium 515, such as a flash memory.

### Example of Functional Configuration of the Control Unit 6

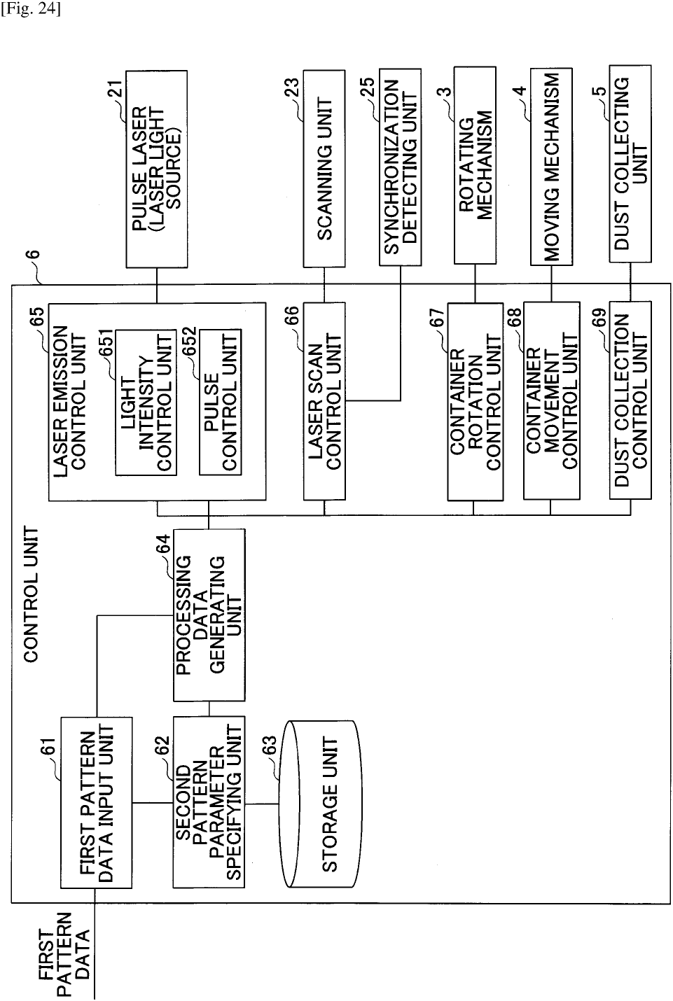

Next, the functional configuration of the control unit 6 will be described. FIG. 24 is a block diagram illustrating an example of a functional configuration of the control unit 6.

As illustrated in FIG. 24, the control unit 6 includes a first pattern data input unit 61, a second pattern parameter specifying unit 62, a storage unit 63, a processing data generating unit 64, a laser emission control unit 65, a laser scan control unit 66, a container rotation control unit 67, a container movement control unit 68, and a dust collection control unit 69. In the material data of the material to be processed, information on processing parameters depending on the material such as resin, is stored.

Among these, the functions of the first pattern data input unit 61, the second pattern parameter specifying unit 62, the processing data generating unit 64, the laser emission control unit 65, the laser scan control unit 66, the container rotation control unit 67, the container movement control unit 68, and the dust collection control unit 69 are implemented by executing a predetermined program by the CPU 501 of FIG. 23 and outputting a control signal via the external device connection I/F 508. However, electronic circuits or electrical circuits such as Application Specific Integrated Circuit (ASIC) or Field-Programmable Gate Array (FPGA) may be added to the hardware configuration of the control unit 6, and a part or all of the functions of each of the above elements may be implemented by electronic circuits or electrical circuits. The function of the storage unit 63 is implemented by the HD 504 or the like.

The first pattern data input unit 61 inputs the pattern data of a first pattern to be formed on at least one of the surface and the interior of the base material in the container 1, from an external device such as a personal computer (PC) or a scanner. The pattern data of the first pattern is electronic data including information representing codes such as bar codes and QR codes (registered trademark), characters, graphics, photographs, and the like, and information representing the type of the first pattern.

However, pattern data is not limited to that input from external devices. Pattern data of the first pattern, which is generated by a user of the manufacturing apparatus 100 by using the keyboard 511 or the pointing device 512 of the control unit 6, can also be input.

The first pattern data input unit 61 outputs the input pattern data of the first pattern to the processing data generating unit 64 and the second pattern parameter specifying unit 62, respectively.

The second pattern parameter specifying unit 62 specifies a processing parameter for forming the second pattern. As described above, the second pattern is a pattern having a shorter length or a shorter width than that of the first pattern, or a line, a dot or the like having a shorter length and a shorter width than that of the first pattern. The second pattern acts to increase the contrast of the first pattern and improve visibility of the first pattern.

The processing parameters of the second pattern are information specifying the type, the length, the thickness, and the processing depth of a line that is the second pattern, or the intervals or arrangements, the density or the like of adjacent lines in an assembly of lines that are the second pattern. Alternatively, the processing parameters of the second pattern are information specifying the type, the size, the processing depth of a dot that is the second pattern, or the intervals or arrangements, the density or the like of adjacent dots in an assembly of dots that are the second pattern.

The type of lines is information indicating a straight line, a curve, etc. The type of dots is information indicating the shape of dots such as circles, ovals, rectangles, diamonds, etc. In the assembly of second patterns, the second patterns may be configured to be periodic or non-periodic. However, it is preferable that the second patterns are configured to have periodicity, because the parameter specification can be simplified.

The processing parameters of the second pattern suitable for improving visibility, according to the type of the first pattern, such as characters, codes, graphics, or photographs, are predetermined by experiments and simulations. The storage unit 63 stores a table representing the association relationship between the type of the first pattern and the processing parameters. The outer frame of the first pattern may or may not be processed. When the outer frame is processed, the contour will be clarified. When the outer frame is not processed, the rendering efficiency can be improved.

The second pattern parameter specifying unit 62 can acquire and specify processing parameters for the second pattern by referring to the storage unit 63 based on information indicating the type of the first pattern input from the first pattern data input unit 61.

However, the method of the specification by the second pattern parameter specifying unit 62 is not limited to those described above. The second pattern parameter specifying unit 62 may accept a user’s instruction via the keyboard 511 or the pointing device 512 of the control unit 6 and acquire the processing parameters for the second pattern by referring to the storage unit 63 based on the accepted instruction.

The second pattern parameter specifying unit 62 may acquire the processing parameters of the second pattern that are generated by a user of the manufacturing apparatus 100 by using the keyboard 511 or the pointing device 512 of the control unit 6.

The processing data generating unit 64 generates processing data for forming a first pattern configured by an assembly of the second patterns based on the pattern data of the first pattern and the processing parameters of the second pattern.

The processing data includes rotation condition data for rotating the container 1 by the rotation mechanism 3, scan condition data for scanning the laser beam 20 by the laser emitting unit 2, and emission condition data for emitting the laser beam 20 by the laser emitting unit 2 in synchronization with the rotation of the container 1. Further, the processing data includes movement condition data for moving the container 1 in the Y direction by the moving mechanism 4 and dust collection condition data for performing the dust collection operation by the dust collecting unit 5.

The processing data generating unit 64 outputs the generated processing data to each of the laser emission control unit 65, the laser scan control unit 66, the container rotation control unit 67, the container movement control unit 68, and the dust collection control unit 69.

The laser emission control unit 65 includes a light intensity control unit 651 and a pulse control unit 652 to control the emission of the processing laser beam 20 to the container 1 by the pulse laser 21 based on the emission condition data. The laser emission control unit 65 controls the timing of emitting the processing laser beam 20 to the container 1 in synchronization with the rotation of the container 1 rotated by the rotation mechanism 3, based on a synchronization detection signal from the synchronization detecting unit 25.

When the pulse laser 21 is configured by a plurality of pulse lasers, the laser emission control unit 65 performs the above-described control independently for each of the plurality of pulse lasers.

The light intensity control 651 controls the light intensity of the processing laser beam 20, and the pulse control 652 controls the pulse width and emission timing of the processing laser beam 20.

The laser scan control unit 66 controls the scanning of the processing laser beam 20 by the scanning unit 23 based on the scan condition data. Specifically, the laser scan control unit 66 controls the ON or OFF of the driving of the scanning mirror, controls the driving frequency, and the like.

The container rotation control unit 67 controls the ON or OFF of the rotation driving, the rotation angle, the rotation direction, and the rotation speed of the container 1 by the rotation mechanism 3, based on the rotation condition data. The container rotation control unit 67 may rotate the container 1 continuously in a predetermined rotation direction or reciprocally rotate (swing) the container 1 within a predetermined angle range such as ±90 degrees while switching the rotation direction.

The container movement control unit 68 controls the ON or OFF of the movement driving, the movement direction, the movement amount, and the movement speed and the like of the container 1 by the movement mechanism 4 based on the movement condition data.

The dust collection control unit 69 controls the ON or OFF control, the air flow rate to be suctioned or the flow rate, etc., of dust collection by the dust collection section 5, based on the dust collection condition data. A mechanism for moving the dust collecting unit 5 may be provided, and movement of the dust collecting unit 5 by the mechanism may be controlled so that the dust collecting unit 5 is disposed near a position where the processing laser beam 20 is emitted.

### Example of Manufacturing Method by the Manufacturing Apparatus 100

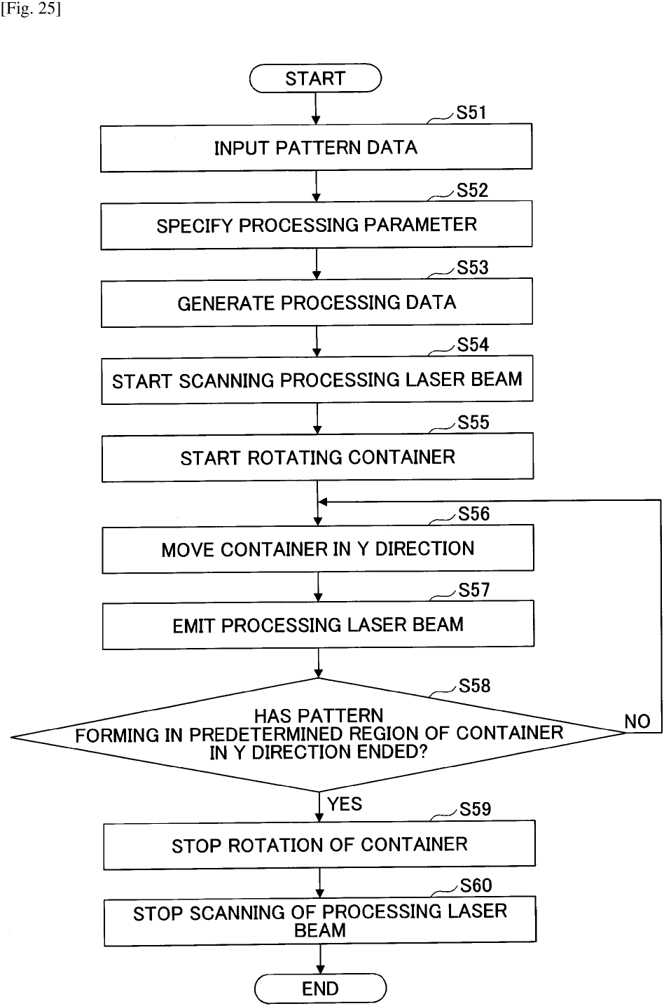

Next, a manufacturing method performed by the manufacturing apparatus 100 will be described. FIG. 25 is a flowchart illustrating an example of a manufacturing method by the manufacturing apparatus 100.

First, in step S51, the first pattern data input unit 61 inputs the pattern data of the first pattern, from an external device such as a PC or a scanner. The first pattern data input unit 61 outputs the input pattern data of the first pattern to the processing data generating unit 64 and the second pattern parameter specifying unit 62, respectively.

Subsequently, in step S52, the second pattern parameter specifying unit 62 specifies processing parameters for forming the second pattern. The second pattern parameter specifying unit 62 acquires and specifies the processing parameters for forming the second pattern, by referring to the storage unit 63, based on information indicating the type of the first pattern input from the first pattern data input unit 61.

The order of performing the operations of step S51 and step S52 may be appropriately changed, or these steps may be performed in parallel.

Subsequently, in step S53, the processing data generating unit 64 generates the processing data for forming the first pattern configured by an assembly of the second patterns based on the pattern data of the first pattern and the processing parameters of the second pattern. The generated processing data is output to the laser emission control unit 65, the laser scan control unit 66, the container rotation control unit 67, the container movement control unit 68, and the dust collection control unit 69, respectively.

Subsequently, in step S54, the laser scan control unit 66 causes the scanning unit 23 to start the scanning of the processing laser beam 20 in the Y direction based on the scan condition data. In the present embodiment, in response to this control to start the scanning, the scanning unit 23 continuously performs the scanning of the processing laser beam 20 in the Y direction until an instruction to stop is given.

Subsequently, in step S55, the container rotation control unit 67 causes the rotation mechanism 3 to start the rotation driving of the container 1 based on the rotation condition data. In the present embodiment, in response to this control to start the rotation driving, the rotation mechanism 3 continues to rotate the container 1 until an instruction to stop is given.

Subsequently, in step S56, the container movement control unit 68 causes the movement mechanism 4 to move the container 1 to an initial position in the Y direction, so that the processing laser beam 20 is emitted to a predetermined position of the container 1, based on the movement condition data. After completion of the movement of the container 1 to the initial position, the container movement control unit 68 stops the moving mechanism 4.

Note that the order of performing the operations of steps S54 to S56 may be appropriately changed, or these steps may be performed in parallel.

Subsequently, in step S57, the laser emission control unit 65 starts the emission control of the processing laser beam 20 relative to the container 1.

Specifically, the laser emitting unit 2 scans one line along the Y direction to emit the processing laser beam 20 onto the container 1. Subsequently, the rotation mechanism 3 rotates the container 1 by a predetermined angle about the cylindrical axis 10 of the container 1. After the rotation by the predetermined angle, the laser emitting unit 2 scans the next one line to emit the processing laser beam 20 onto the container 1. Subsequently, the rotation mechanism 3 rotates the container 1 by a predetermined angle about the cylindrical axis 10 of the container 1. By repeating such operations, a first pattern is sequentially formed on at least one of the surface and the interior of the base material of the container 1.

Subsequently, in step S58, the laser emission control unit 65 determines whether the formation of the first pattern has been completed for a predetermined region of the container 1 in the Y direction.

When it is determined that the formation has not been completed in step S58 (NO in step S58), the processes from steps S56 and onward are repeated again.

On the other hand, when it is determined that the formation has been completed in step S58 (YES in step S58), in step S59, the rotation mechanism 3 stops rotating the container 1 in response to an instruction to stop by the container rotation control unit 67.

Subsequently, in step S60, the scanning unit 23 stops scanning the processing laser beam 20 in response to an instruction to stop by the laser scan control unit 66. The pulse laser 21 stops emitting the processing laser beam 20 in response to an instruction to stop by the laser emission control 65.

Note that the order of performing the operations of step S59 and step S60 can be appropriately changed, or these steps may be performed in parallel.

In this manner, the manufacturing apparatus 100 can form a first pattern configured by an assembly of second patterns on at least one of the surface or the interior of the base material of the container 1.

### Examples of Various Kinds of Data

Next, an example of various kinds of data used in the manufacturing of the container 1 will be described.

### Example of Pattern Data

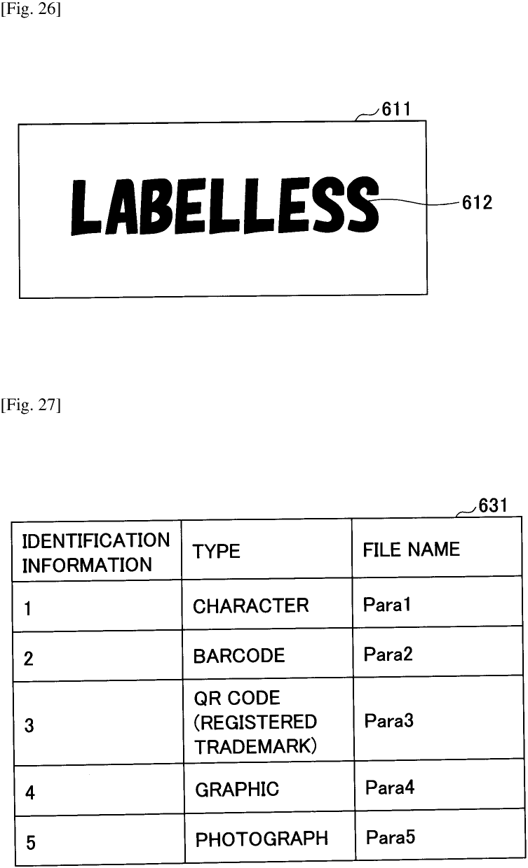

FIG. 26 is a diagram illustrating an example of the pattern data of the first pattern input by the first pattern data input unit 61.

As illustrated in FIG. 26, pattern data 611 includes character data 612 reading “LABELLESS”, and the character data 612 is an object to be formed on the container 1 as a first pattern. An assembly of lines including the nine characters (letters) of “LABELLESS” corresponds to the data for the first pattern. In the pattern data 611, data other than the character data 612 is not subject to formation on the container 1.

The pattern data 611 is provided as an image file, such as a bitmap, as an example. The header information of the image file that provides the pattern data 611 includes information representing the type of the first pattern. In this example, the type of the first pattern is “characters”.

The first pattern data input unit 61 outputs the pattern data 611 including information representing “characters” to each of the second pattern parameter specifying unit 62 and the processing data generating unit 64.

### Example of Association Table Indicating Association Between Types of First Patterns and Processing Parameters

FIG. 27 illustrates an example of an association table stored in the storage unit 63. An association table 631, illustrated in FIG. 27, indicates the association relationship between the type of first pattern, such as characters, codes, graphics, or photographs, and processing parameters for the second pattern suitable for improving the visibility of the first pattern. This association relationship is predetermined by experiments and simulations.

The numeric value indicated in the “IDENTIFICATION INFORMATION” column of the association table 631 represents identification information of the first pattern, and the information indicated in the “TYPE” column represents the type of the first pattern. The information indicated in the “FILE NAME” column represents the file name in which the processing parameter corresponding to the type of the first pattern is recorded.

The second pattern parameter specifying unit 62 reads in a file corresponding to information representing the type of the first pattern by referring to the association table 631 and acquires a processing parameter. In the example of FIG. 26, the type of the first pattern is “character”, and, therefore, the second pattern parameter specifying unit 62 reads the file “Para1” corresponding to the identification information “1” indicating “character” to acquire the processing parameter, and outputs the acquired processing parameter to the processing data generating unit 64.

### Example of Processing Parameters

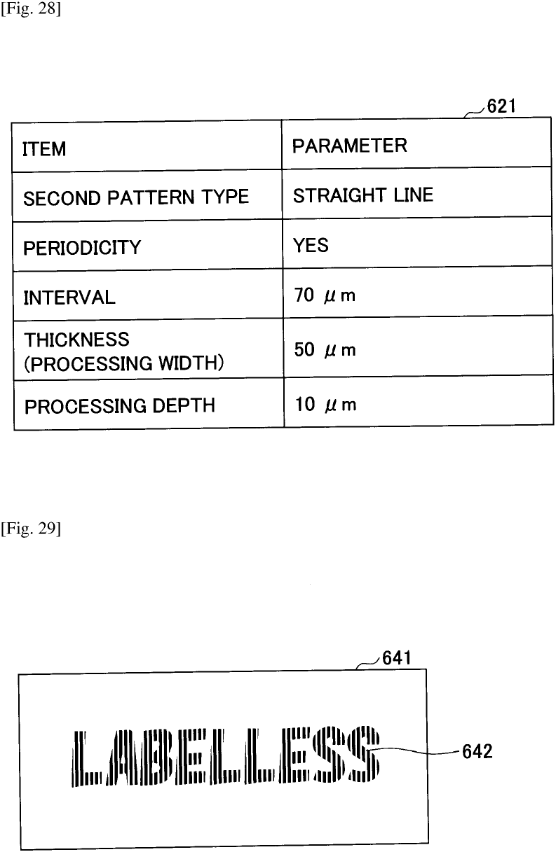

FIG. 28 is a diagram illustrating examples of processing parameters acquired by the second pattern parameter specifying unit 62. According to the item in the “item” column of processing parameters 621, a parameter is indicated in the “parameter” column.

### Example of Processing Data

FIG. 29 is a diagram illustrating an example of the processing data generated by the processing data generating unit 64. In processing data 641, character data 642 is configured by a plurality of pieces of linear data corresponding to second patterns. The black regions in the processing data 641 correspond to the regions where the property of the base material of the container 1 is changed by being irradiated by the processing laser beam 20.

### Example of the Processing Laser Beam 20

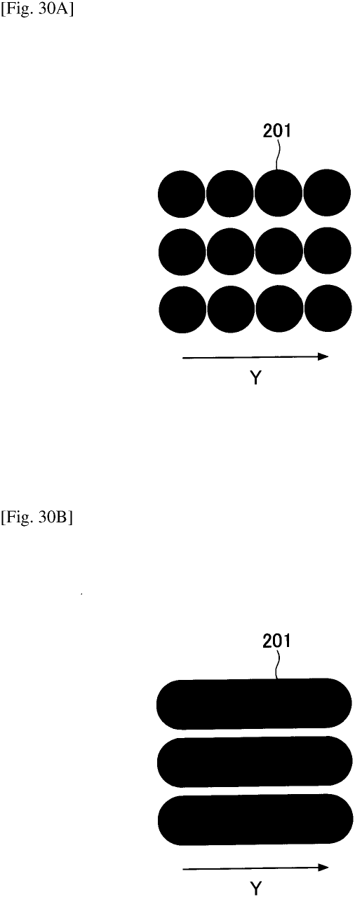

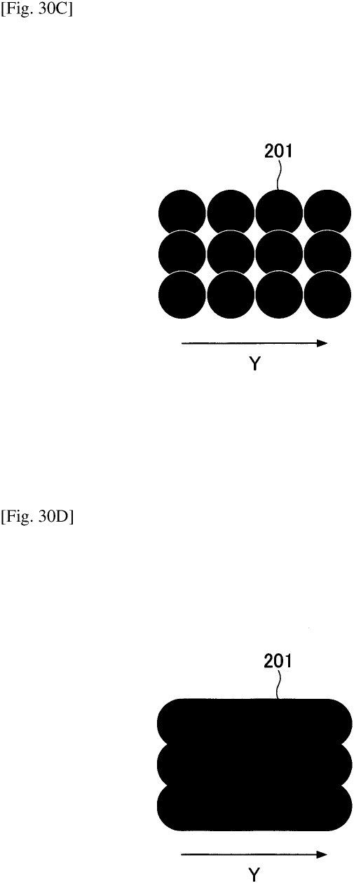

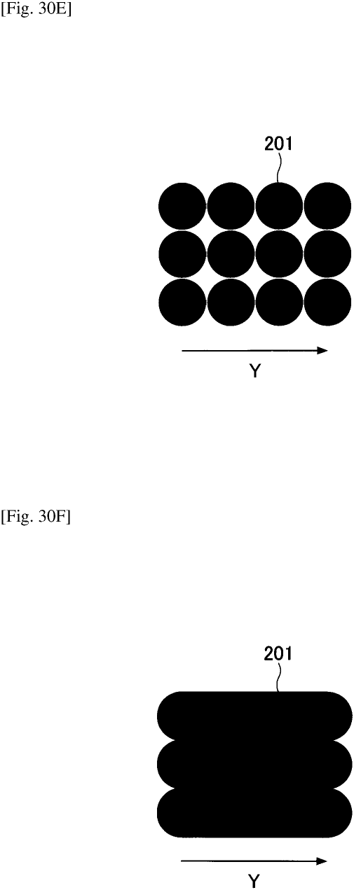

Next, FIGS. 30A to 30F illustrate examples of emission of the processing laser beam 20 to the container 1 and illustrate three emission examples.

Further, FIGS. 30A to 30F illustrate a beam spot 201 of the processing laser beam 20 on the surface of the container 1, and illustrate three beam spots 201, arranged in a direction orthogonal to the scanning direction (Y direction) of the processing laser beam 20, scanned in the Y direction.

The three beam spots 201 can be obtained by juxtaposing three of the pulse lasers 21 in a direction orthogonal to the Y direction and emitting the processing laser beam 20 by each of the three pulse lasers 21.

FIGS. 30A and 30B illustrate a first example in which there is a gap between the beam spots 201 in the direction orthogonal to the Y direction. FIG. 30A illustrates a state where there is a gap between the beam spots 201 in a direction orthogonal to the Y direction, and FIG. 30B illustrates a state where the beam spots 201 of FIG. 30A are scanned at a high speed in the Y direction. By high-speed scanning, three scanning lines are formed by the three beam spots 201, and there is a gap between the respective scanning lines extending in the Y direction. By emitting the beam spots 201 in the arrangement of FIGS. 30A and 30B, the efficiency of pattern formation can be increased.

FIGS. 30C and 30D illustrate a second example in which the beam spots 201 overlap each other in a direction orthogonal to the Y direction. FIG. 30C illustrates a state in which the beam spots 201 overlap each other in a direction orthogonal to the Y direction, and FIG. 30D illustrates a state in which the beam spots 201 of FIG. 30C are scanned at a high speed in the Y direction. By high-speed scanning, three scanning lines are formed by the beam spots 201, and the scanning lines extending in the Y direction overlap each other. By emitting the beam spots 201 in the arrangement of FIGS. 30C and 30D, the contrast of the pattern can be increased.

FIGS. 30E and 30F illustrate a third example in which the beam spots 201 contact each other in a direction orthogonal to the Y direction. FIG. 30E illustrates a state in which the beam spots 201 contact each other in a direction orthogonal to the Y direction, and FIG. 30F illustrates a state in which the beam spots 201 in FIG. 30E are scanned at a high speed in the Y direction. By high-speed scanning, three scanning lines are formed by the beam spots 201, and the scanning lines extending in the Y direction contact each other. By emitting the beam spots 201 in the arrangement of FIGS. 30E and 30F, the pattern formation efficiency and contrast can be balanced.

The above-described three emission examples of the processing laser beam 20 may be combined to form a first pattern configured by an assembly of second patterns, on the container 1. Note that the number of the processing laser beams 20 is not limited to three and may be one or even more than three. The greater the number of the processing laser beams 20, the shorter the time it takes to form a pattern.

The diameter of the beam spot 201 is 42.3 µm as an example, and the gap between the beam spots 201 in the direction orthogonal to the Y direction in FIGS. 30A and 30B is 21.2 µm as an example.

FIGS. 30A to 30F illustrate an embodiment in which the processing laser beams are periodically arranged, but the present embodiment is not limited thereto, and the processing laser beams may be arranged in non-periodic manner.

### Examples of Changes in Property of Base Material

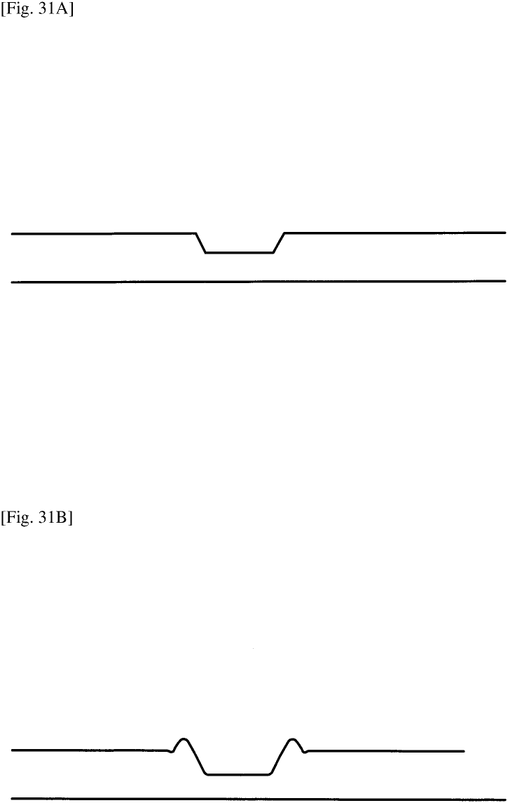

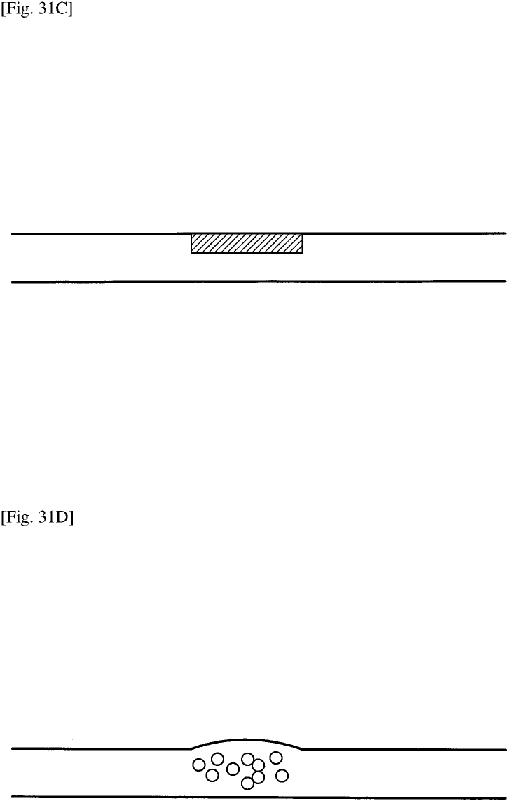

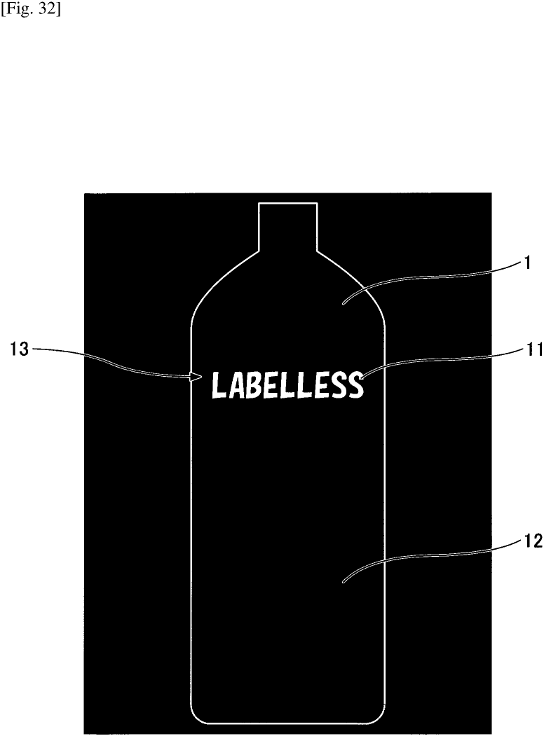

Next, changes in the property of the base material of the container 1 by being irradiated by the processing laser beam 20 will be described. FIGS. 31A to 31D are diagrams illustrating examples of changes in the property of a base material of the container 1 by being irradiated by the processing laser beam 20.

FIG. 31A illustrates a recessed shape formed by vaporizing the base material of the surface of the container 1, and FIG. 31B illustrates a recessed shape formed by melting the base material of the surface of the container 1. In the case of FIG. 31B, the periphery of the recessed portion is raised with respect to that of FIG. 31A.

Further, FIG. 31C illustrates the change in the crystallization state of the surface of the base material of the container 1, and FIG. 31D illustrates the change in the foaming state of the interior of the base material of the container 1.

Thus, by changing the shape of the surface of the container 1 or by changing the quality such as the crystallization state of the surface of the base material or the foaming state of the interior of the base material, a first pattern configured by an assembly of second patterns can be formed on the surface or in the interior of the container 1.

As a method of vaporizing the base material on the surface of the container 1 to form a recessed shape, for example, a pulse laser having a wavelength of 355 nm to 1064 nm and a pulse width of 10 fs to 500 nm or less is emitted. Accordingly, the base material is vaporized at the portion irradiated with the laser beam, so that a microscopic recess is formed on the surface.

It is also possible to melt the base material to form a recess by emitting a Continuous Wave (CW) laser having a wavelength of 355 nm to 1064 nm. If the laser continues to be emitted even after the base material has melted, the interior and surface of the base material can be foamed and can become whitish turbid.

In order to change the crystallization state, for example, when a PET base material is used, the PET base material can be crystallized and can become whitish turbid by emitting a CW laser having a wavelength of 355 nm to 1064 nm to rapidly increase the temperature of the base material, and then slowly cooling down the base material by weakening the power or the like. After increasing the temperature, when the laser beam is turned off, etc., to rapidly cool down the base material, the PET becomes amorphous and transparent.

The change in the property of the base material of the container 1 is not limited to those illustrated in FIGS. 31A to 31D. The property of the base material may be changed by methods such as yellowing, oxidation reaction, surface modification, or the like applied to the base material made of a resin material.

### Example of the Container 1 According to the Second Embodiment

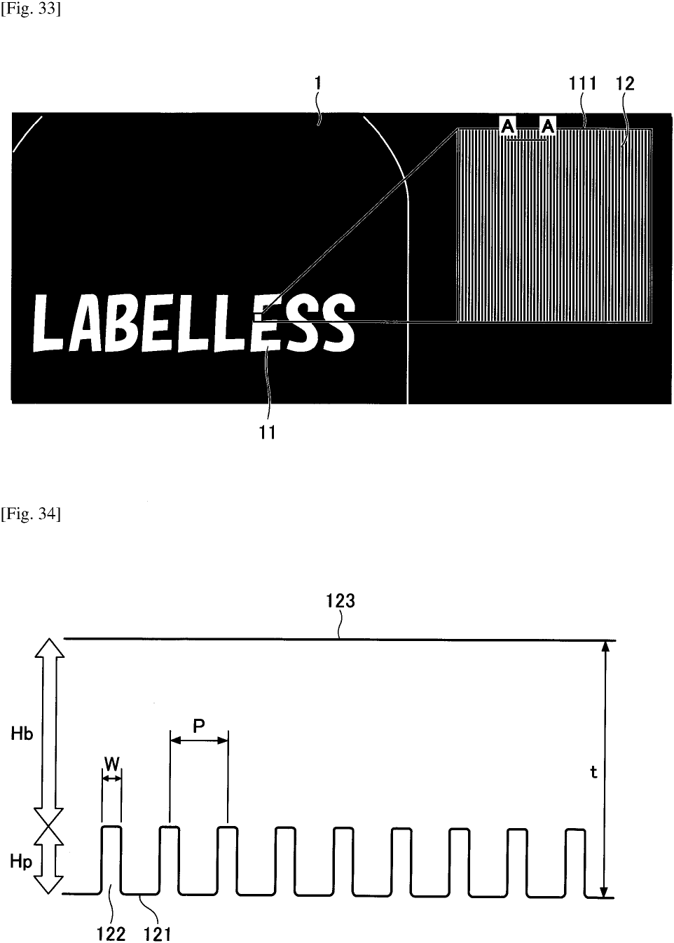

Next, the container 1 according to the second embodiment will be described. FIG. 32 is a diagram illustrating an example of the container 1. The container 1 is a cylindrical bottle configured by a base material made of resin (transparent resin) that is transparent to visible light. FIG. 32 illustrates the container 1 placed in front of a black screen as a background. The black screen at the background is seen through the transparent container 1. Alternatively, black liquid may be contained in the container 1 and the black liquid in the container 1 may be seen through the transparent container 1.

On the surface of the container 1, characters 11 reading “LABELLESS” are formed. With respect to the black background or the black color of the liquid in the container 1, by diffusion of ambient light at the characters 11, the characters 11 become whitish turbid so as to be visualized. An assembly of multiple lines configuring the nine characters (letters) of “LABELLESS”, corresponds to the characters 11, and the characters 11 are an example of a first pattern and an example of a first region. Further, the regions of the container 1 in which the characters 11 are not formed are examples of other regions.

As resins of the base material of the container 1, polyvinyl alcohol (PVA), polybutylene adipate/terephthalate (PBAT), polyethylene terephthalate succinate, polyethylene (PE), polypropylene (PP), polyethylene terephthalate (PET), vinyl chloride (PVC), polystyrene (PS), polyurethane, epoxy, biopolypolybutylene succinate (PBS), polylactic acid blend (PBAT), starch blend polyester resin, polybutylene terephthalate succinate, polylactic acid (PLA), polyhydroxy butyrate/hydrox-yhexanoate (PHBH), polyhydroxyalkanic acid (PHA), bioPET30, biopolyamide (PA) 610,410,510, and bioPA1012,10T, Bio-PA11T,MXD10, biopolycarbonate, biopolyurethane, Bio-PE, Bio-PET100, Bio-PA11, Bio-PA1010 or the like may be used.

Among these, by using biodegradable resins such as polyvinyl alcohol, polybutylene adipate/terephthalate, and polyethylene terephthalate succinate, the environmental load can be reduced, and are thus suitable. It is preferable that the resin is 100% biodegradable resin, but the resin may be partially biodegradable resin. For example, a combination of approximately 5%, 10%, and 30% of biodegradable resin and the remaining percentage including other typical resins can be expected to reduce the environmental load.

FIG. 33 is a diagram illustrating an example of the relationship between the first pattern and the second pattern formed on the container 1. An enlarged view 111 in FIG. 33 is an enlarged representation of a portion of the characters 11. As illustrated in FIG. 33, the characters 11 “LABELLESS” are formed on the surface of the container 1 and the characters 11 are configured by a plurality of straight lines 12, as illustrated in the enlarged view 111. That is, the characters 11 include of an assembly of the straight lines 12. In FIG. 33, the straight lines 12 are illustrated only in the region corresponding to the enlarged view 111, but all of the characters 11 are configured by an assembly of the straight lines 12.

The white region in the assembly of the straight lines 12 represents the region where the property of the base material has changed, and the straight line 12 corresponding to one straight line among the plurality of straight lines indicated by the white regions is an example of the second pattern and an example of a second region. The plurality of straight lines 12 are an example of an assembly of the straight lines 12. The straight line 12 is a pattern that is smaller than the characters 11. More specifically, the straight line 12 is a pattern in which the area of the straight line portion is smaller than the total area of the plurality of lines configuring the characters 11. Thus, the characters 11 are formed by including an assembly of the (fine) straight lines 12 that are smaller than the characters 11.

FIG. 34 is a cross-sectional view illustrating a cross-sectional shape cut along A-A of the enlarged view 111 in FIG. 33. An outer surface portion 121 represents the outer surface of the base material of the container 1. A recessed portion 122 represents a portion formed by evaporation of the surface of the base material of the container 1 upon being irradiated by the processing laser beam 20 and corresponds to the straight line 12. An inner surface portion 123 illustrates the surface of the base material on the inner side of the container 1 (inside the container 1).

A thickness t indicates the thickness of the base material of the container 1 and a processed depth Hp indicates the depth of the recessed portion 122. An unprocessed depth Hb indicates the depth of the unprocessed portion. The depth of the unprocessed portion is the depth obtained by subtracting the processed depth Hp from the thickness t of the base material of the container 1.

Here, the interval between adjacent second patterns means the distance between the centers of adjacent second patterns. An interval P in FIG. 34 indicates the interval between the adjacent straight lines 12. Further, a width W indicates the thickness of the straight line 12. The straight lines 12 in the present embodiment are formed with periodicity, and, therefore, the interval P also corresponds to the period at which the straight lines 12 are formed.

Here, it is preferable that the interval P is 0.4 µm or more and 130 µm or less. By setting the interval P to be 0.4 µm or more, ambient light can be diffused without being limited by the wavelength limit of visible light, thereby improving the contrast of the characters 11 that are configured by an assembly of the straight lines 12.

Furthermore, by setting the interval P to 130 µm or less, a resolution of 200 dpi (dot per inch) can be guaranteed, while preventing the individual straight line 12 from being apparently recognizable, and allowing the characters 11 to be visualized with high contrast as a white turbid pattern. n interval P of 50 µm or less is more preferable because the individual second pattern can be reliably prevented from being apparently recognizable.

Although the above example has been described with a suitable value for the interval P, if the second pattern has a periodicity, the above preferred value can also be applied to the period. Although the interval P is constant in the example of FIG. 34, a plurality of types of intervals P may be used without being constant. For example, intervals including P1=50 µm, P2=30 µm, P3=60 µm, and P4=100 µm may be set.

FIG. 33 illustrates an example of second patterns with narrow intervals, compared to the processing data of the second patterns illustrated in FIG. 29. That is, the character data 642 of FIG. 29 is not associated with the characters 11 of FIG. 33.

Further, in the enlarged view 111, the straight lines 12 in the assembly are formed with equal intervals and periodicity; however, an assembly of second patterns is not limited thereto. The assembly of second patterns may be configured by a plurality of the straight lines 12 formed at different intervals in a non-periodic manner, or an assembly of second patterns may be configured by a plurality of dots formed periodically or non-periodically, or the like. If the second pattern is a pattern of a dot, the pattern of the dot is smaller than the first pattern such as the characters 11.

In the present embodiment, the second patterns are formed with recessed and protruding shapes including the outer surface portion 121, which corresponds to a protruding portion, and the recessed portion 122. In the case where the second patterns are formed by the recessed and protruding shapes as described above, it is preferable that the depth difference between the outer surface portion 121 and the recessed portion 122 is 0.4 µm or more. By making the depth difference to be 0.4 µm or more, the ambient light can be diffused without being limited by the wavelength limit of visible light, thereby improving the contrast of the characters 11 that are configured by an assembly of the straight lines 12. Although the outer surface portion 121 is illustrated as an example of a protruding portion, the protruding portion may be a portion in which the outer surface of the container 1 is vaporized by being irradiating the processing laser beam 20, as long as the depth is shallower than the recessed portion 122.

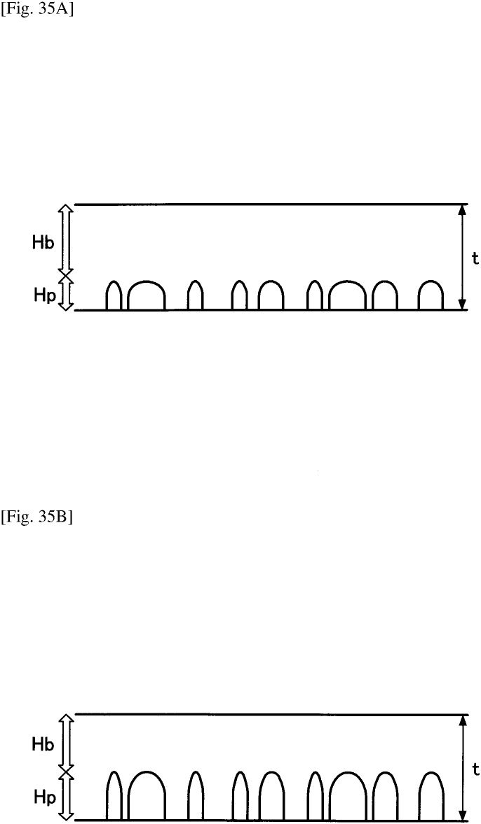

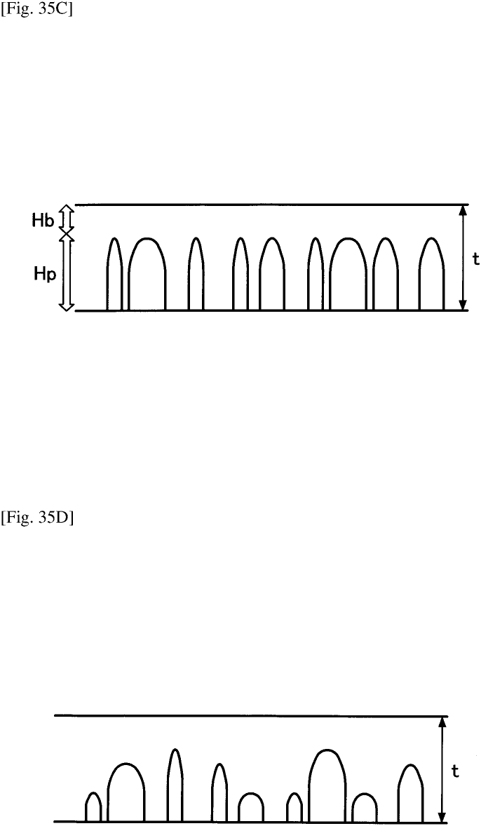

Next, FIGS. 35A to 35D illustrate various examples of the processed depth Hp.

FIG. 35A illustrates the case where the processed depth Hp is shallower than the unprocessed depth Hb of the base material. More specifically, the ratio of the processed depth Hp to the unprocessed depth Hb is 1 or less to 9 or more through 3 to 7. In this case, the rigidity (mechanical strength) of the second pattern is improved. As an example, the processed depth Hp is 10 µm when the thickness of the base material of the container 1 is 100 µm to 500 µm.

FIG. 35B illustrates the case where the processed depth Hp and the unprocessed depth Hb of the base material are approximately the same. More specifically, the ratio of the processed depth Hp to the unprocessed depth Hb is 4 to 6 through 6 to 4.

FIG. 35C illustrates the case where the processed depth Hp is deeper than the unprocessed depth Hb of the base material. More specifically, the ratio of the processed depth Hp to the unprocessed depth Hb is 7 to 3 through 9 or more to 1 or less.

FIG. 35D illustrates the case where the processed depth Hp and the unprocessed depth Hb of the base material are varied.

The depth of the processed depth Hp as illustrated in FIGS. 35A through 35D can be adjusted by controlling the light intensity of the pulse laser light emitted from the pulse laser 21 by the light intensity control unit 651 of the laser emission control unit 65.

In the case of a bottle (the container 1) for carbonated beverages, because the strength of the bottle needs to be greater than that of a bottle for non-carbonated beverages, the thickness of the base material may be thicker than that of a bottle for non-carbonated beverages. In such a case, it is preferable to ensure that the unprocessed depth Hb is sufficient, so that sufficient strength is obtained. For example, the unprocessed depth Hb of 200 µm to 450 µm is suitable. When the processed depth Hp is required to ensure renderability, it is preferable to further increase the thickness of the resin to ensure that both the unprocessed depth Hb and the processed depth Hp are sufficient.

### Example of Association Between Pulse Laser and Processing Parameter

The pulse laser 21 used in the manufacturing apparatus 100 is, for example, a pulse laser having a wavelength of 355 nm, a wavelength of 532 nm, and a wavelength of 1064 nm, with a pulse width of tens of fs to hundreds of ns. A CW laser can also be used, in which the CW laser is modulated.

The shorter the wavelength of the pulse laser used as the pulse laser 21, the smaller the beam spot diameter, which is suitable for forming a first pattern configured by an assembly of finer second patterns.

### Effects of the Container 1

Containers such as PET bottles are widely used because of a variety of advantages such as preservability in the distribution and sales of beverages or the like. To containers distributed in the market, labels are often attached to display product names, ingredient, best before dates, bar codes, QR codes, recycle marks, logos, etc., to manage and promote the sales. Labels can provide useful information to consumers. Furthermore, by displaying designs to appeal to consumers with labels, it is possible to demonstrate the individuality of the product and improve competitiveness.

On the other hand, in recent years, the problem of marine plastic waste and the like has been reported, and movements to eliminate environmental pollution caused by plastic waste are becoming increasingly active worldwide. This is not an exception for containers such as PET bottles, and measures are being taken to reduce plastic waste from the viewpoint of reducing waste in consideration of the environment.

Amid this situation, there is a growing demand for circulation type recycling of containers. Circulation type recycling of containers refers to separately collecting used containers (according to their different materials), turning the collected containers into flakes that can be used as raw materials of containers, and then producing containers again by using the flakes, by recycling companies.

In order to smoothly promote circulation type recycling, it is preferable to ensure that base materials that are made of different materials, such as container bodies, labels, and caps of PET bottles or the like, are separately collected, during the recycling process. Separate collection requires consumers to separate the cap and label from each container, and in particular, the removal of labels is a manual task, which can be troublesome for general consumers and municipal resource collection companies. Therefore, the removal of labels from containers is one of the factors hampering the separate collection from being ensured.

On the other hand, a technology to provide unlabeled containers is being studied. For example, a method of eliminating labels by printing a pattern for displaying information by an ink-jet method onto the container body has been studied.

However, printing ink may be undesirable because residual ink increases impurities in the recycling process after bottle collection. By removing ink from the container body during recycling to reduce impurities, management information may be lost, which may be undesirable in some cases.

As another method, the use of CO₂ lasers (carbon dioxide lasers) to form a pattern for displaying information on the body of the container has been studied.

However, the wavelength of a pulse laser, such as a CO₂ laser, is long, and, therefore, the beam spot diameter will be increased, and the resolution of the pattern formed on the body of the container will be reduced. As a result, when a pattern with a large amount of information, such as an image, is formed on the container, the contrast of the pattern may be reduced and visibility may be reduced.

In contrast, in the present embodiment, the container 1 having the first pattern configured by the second patterns, on at least one of the front side, the back side, and the interior of the base material, is provided.

At the first pattern configured by the second patterns, the ambient light has a higher diffusion property, compared to a case in which the first pattern is formed in a unicursal manner. In this context, a unicursal manner means that a line or a shape is drawn by continuously emitting the pulse laser light with no interruption. As a result, in the present embodiment, the contrast of the first pattern with respect to the region where the first pattern is not formed on the container 1, is improved. In the present embodiment, due to the light diffusion effect by the second pattern, the first pattern is visually recognized as being white turbid with respect to the region where the first pattern is not formed, and the white turbid region is visually identified as being whiter due to the improved contrast.

Accordingly, even if the first pattern is a pattern having a large amount of information including fine lines, characters or the like, the first pattern can be satisfactorily visually recognized with a high contrast, and the container 1 in which the pattern having a large amount of information is formed with good visibility, can be provided. Further, it is possible to provide a member that is the base material of the container 1, on which images, figures, or the like are formed to have good visibility.

Furthermore, the first pattern can be formed without applying impurities such as ink to the body of the container 1, and, therefore, the process of removing impurities in the circulation type recycling process is unnecessary, thereby preventing management information from being lost by removing ink as impurities.

Further, by coloring, whitening, and clouding the first pattern, even when a transparent plastic or transparent glass having permeability with respect to the visible light is used as the base material of the container 1, the first pattern can be visualized with good contrast.

In the present embodiment, an example in which a first pattern configured by an assembly of second patterns formed by the processing laser beam 20 is described. However, the present invention is not limited thereto, and other processing methods such as mechanically cutting processes are applicable.

Further, a laser processing technique of emitting a laser beam as a means of changing the property of the base material by changing at least one of the shape, the crystallization state, and the foam state of the base material can be applied. The laser processing method enables high-speed processing and prevents the generation of cutting debris or the like, and, therefore, the first pattern configured by an assembly of second patterns can be formed in a cleaner environment.

In the present embodiment, the depth of the processed depth Hp of the second pattern is adjusted by controlling the light intensity of the processing laser beam 20 based on the emission condition data. Thus, it is possible to optimize the contrast of the first pattern or the rigidity of the second pattern.

Further, it is preferable that the diameter of the processing laser beam 20, in the region where the property of the base material is changed on the surface of or in the interior of the container 1, is 1 µm or more and 200 µm or less. Accordingly, it is possible to attain a preferable diffusion property of the ambient light according to the first pattern configured by an assembly of second patterns, and the formation efficiency of the first pattern can be ensured.

When the beam spot diameter is smaller than 1 µm, the wavelength becomes close to the wavelength of visible light, and it is impossible to scatter the light with a structure processed with such a beam spot diameter, and thus the white turbidity cannot be achieved. Further, when the beam spot diameter is larger than 200 µm, the structure will be apparently recognized by the human eye. Thus, for these reasons, it is preferable that the diameter of the processing laser beam 20 is 1 µm or more and 200 µm or less. Further, in order to ensure that even a person with good vision will not apparently recognize the structure, it is further preferable that the processing laser beam has a diameter of 1 µm to 100 µm or less.

Furthermore, it is preferable that the interval between the adjacent second patterns is 0.4 µm or more and 130 µm or less. By making the interval 0.4 µm or more, the ambient light is diffused without being limited by the wavelength limit of visible light, thereby improving the contrast of the first pattern. Furthermore, when the interval is set to 130 µm or less, a resolution of 200 dpi (dot per inch) is guaranteed, and the individual second pattern is prevented from being apparently recognizable, so that the first pattern can be visualized with high contrast as a whitish turbid pattern.

Furthermore, it is preferable that the second pattern is formed at a predetermined period, so that periodic information can be used as a processing parameter, and the processing parameter for forming the second pattern can be simplified.

Furthermore, when the second patterns are configured with recessed and protruding shapes, it is preferable that the difference between the depth of the recessed portion and the depth of the protruding portion among the recessed and protruding shapes, is 0.4 µm or more. Accordingly, the diffusion property of the ambient light according to the second pattern can be ensured, and the contrast of the first pattern can be improved.

Furthermore, it is preferable that the assembly of second patterns includes two or more second patterns and five or less second patterns, so that the white turbidity caused by the second patterns can be better achieved.

Moreover, by using biodegradable resin as the base material of the container 1, resin waste is not generated, so that it is possible to reduce the environmental load and is thus more preferable. In this case, it is preferable that the ratio of the biodegradable resin in the resin configuring the container 1 is 100%, but even when the ratio is approximately 30%, the environmental load is significantly reduced.

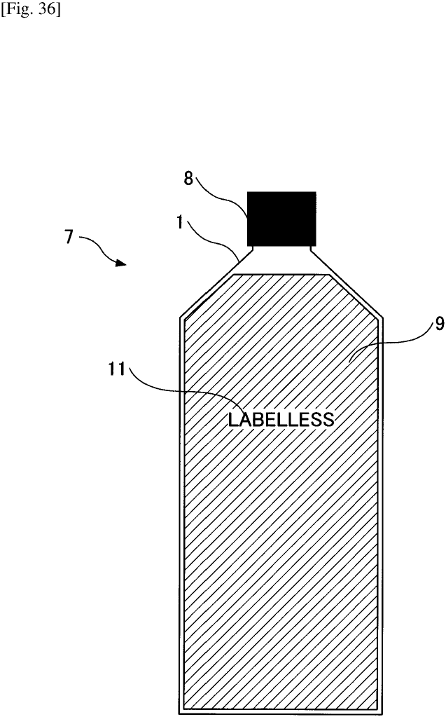

The embodiment also includes a container body including the container 1 and a contained object contained in the container 1. FIG. 36 is a diagram illustrating an example of such a container body 7. The container body 7 includes the container 1, a sealing member 8 such as a cap, and a content 9 such as a liquid beverage contained in the container 1. On the surface of the container 1, the characters 11 “LABELLESS” are formed.

The content 9 often has a color such as black, brown, or yellow. The opening portion of the container body 7 has a screw portion to which the sealing member 8 is screwed and fixed. Further, a screw portion is provided on the inside of the sealing member 8 for being screwed to the screw portion provided at the opening portion of the container body 7.

As methods for manufacturing the container body 7, there are the following three modes.

Mode 1: A method for manufacturing the container body 7 performed by forming a pattern on the container 1, and then containing the container 1 with the content 9, and then sealing the container 1 with the sealing member 8.

Mode 2: A method for manufacturing the container body 7 performed by containing the container 1 with the content 9, and then sealing the container 1 with the sealing member 8 and forming a pattern on the container 1.

Mode 3: A method for manufacturing a container body 7 performed by forming a pattern on the container 1 while containing the container 1 with the content 9, and then sealing the container 1 with the sealing member 8.

### Third Embodiment

Next, a third embodiment will be described.

In the third embodiment, the first pattern formed in the container 1 is an image, and each of the plurality of pixels forming the image is configured by an assembly of the second patterns. Furthermore, the intervals between the second patterns are set to be different among the respective pixels, so that the image that is the first pattern can be represented by a multi-value gradation.

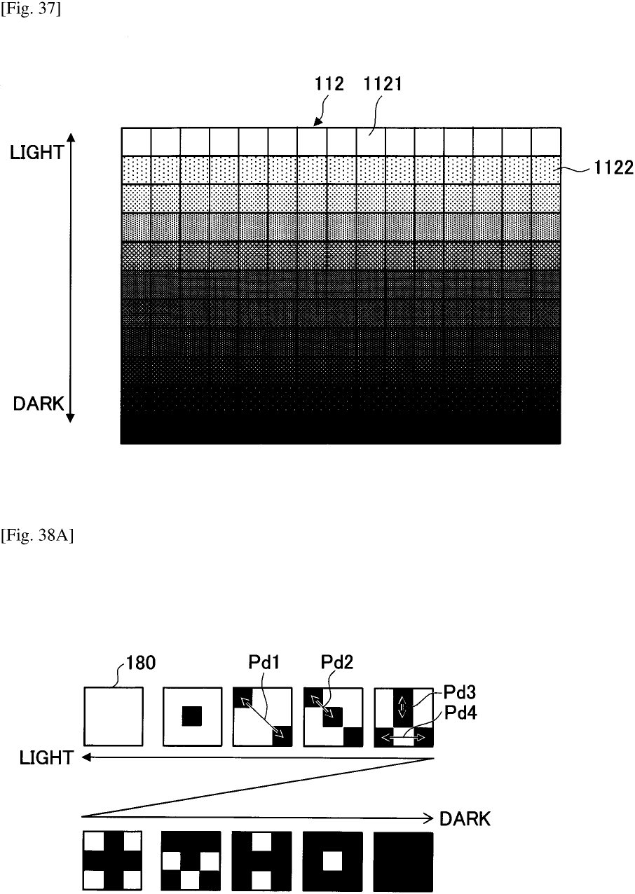

FIG. 37 is a diagram illustrating an example of a gradation representation in which the intervals between the second patterns are different among the respective pixels, and processing image data 112 of an image corresponding to the first pattern to be formed in the container 1 is illustrated. Pixels 1121 illustrated by squares in FIG. 37 represent the pixels configuring the processing image data 112. The processing image data 112 is configured by a plurality of the pixels 1121.

In the present embodiment, the second patterns are patterns of dots, and each of the plurality of the pixels 1121 is configured by an assembly of pieces of dot data 1122. The dot data 1122, which is represented by a black region in the processing image data 112, corresponds to the region where the property of the base material is changed by being irradiated by the processing laser beam 20.

In FIG. 37, the interval between adjacent pieces of the dot data 1122 increases in the upward direction of the arrow in the figure, and the interval between adjacent pieces of the dot data 1122 decreases in the downward direction of the arrow. The wider the interval between adjacent pieces of the dot data 1122, the lower the diffusion property of ambient light when dot patterns are formed on the container 1, and the density of the white turbid first pattern is decreased. On the other hand, the narrower the interval between adjacent pieces of the dot data 1122, the higher the diffusion property of ambient light when dot patterns are formed on the container 1, and the density of the white turbid first pattern is increased.

As described above, the gradation (shading) of the image is represented by setting the intervals between the second patterns to be different among the respective pixels.

Here, an example of expressing the gradation according to intervals between the dot patterns having periodicity is illustrated in FIG. 37, but the gradation expression method is not limited thereto. For example, the gradation may be expressed by having recessed and protruding shapes formed at an angle, rather than orthogonally, with respect to the surface of the container. The processing of such recessed and protruding shapes can be performed by emitting the processing laser beam 20 at an angle, rather than orthogonally, with respect to the surface of the container 1. Accordingly, the strength of the container 1 can be maintained and the pattern can be enhanced by the angle (direction of visualization).

In addition to performing tilted processing in one direction with respect to each container 1, tilted processing may be performed in a plurality of directions (e.g., processing of the shoulder portion and processing on the side surface). The tilted processing in in multiple directions may be performed in a single processing step.

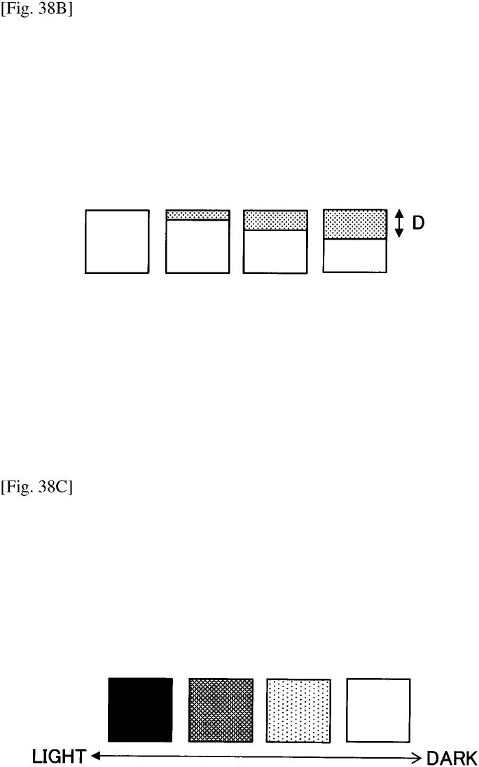

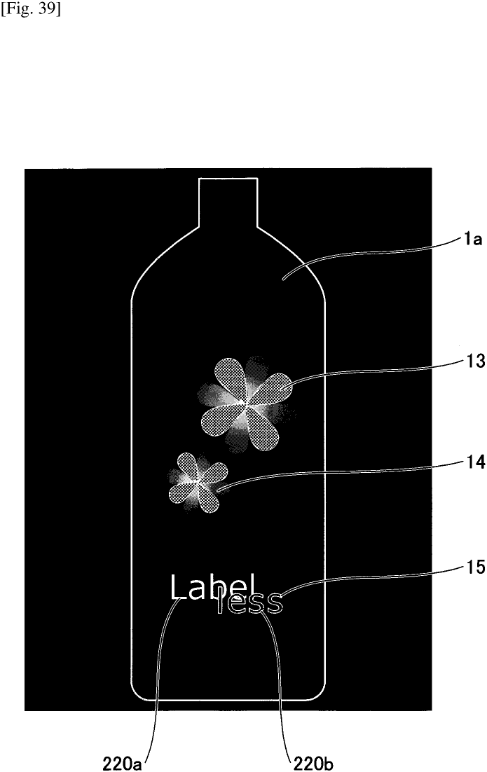

FIGS. 38A to 38C are diagrams illustrating other examples of the gradation expression according to second patterns. FIG. 38A illustrates the processing data of the second patterns without periodicity. In FIG. 38A, a pixel 180 represents one pixel and the pixel 180 includes pieces of rectangular dot data in non-periodic arrangements. The direction of the arrow illustrated indicates the shading of pixel density, and the more the pieces of dot data in the pixel 180, the higher the density.

Intervals Pd1 through Pd4 in FIG. 38A indicate intervals between adjacent pieces of dot data in the arrangement of the various pieces of dot data in the pixel 180, corresponding to intervals between dot patterns when the dot patterns are formed on the container 1.

On the other hand, FIG. 38B illustrates cross-sectional views of second patterns formed by changing the crystallization state. FIG. 38C is a plan view of the second patterns illustrated in FIG. 38B.

FIGS. 38B and 38C illustrate an example in which the diffusion propriety of ambient light according to the second pattern is changed and the density of the first pattern is changed, by changing a crystallization depth D in crystallizing the base material of the container 1. The deeper the crystallization depth D, the higher the diffusion property of ambient light and the higher the white density of white turbidity (further whitened).

Next, FIG. 39 illustrates an example of a container 1a according to the present embodiment. Images 13 and 14 represented by multi-valued gradations are formed on the container 1a. Further, an image 15, in which characters are superimposed, is formed.

Each of the images 13, 14, and 15 is formed of a plurality of pixels, each pixel being configured by an assembly of dot patterns as second patterns. The gradation is expressed by setting different intervals between adjacent dot patterns for the respective pixels. Each of such images 13, 14, and 15 is an example of a first pattern.

As described above, in the present embodiment, the first pattern formed on the container 1 is an image, each of the plurality of pixels forming the image is configured by an assembly of the second patterns, and the intervals between the second patterns are different among the respective pixels. Accordingly, by changing the diffusion property for each pixel, the density of the first pattern formed on the container 1 can be changed for each pixel, and the first pattern can be represented by a multi-value gradation.

The diffusion property of the ambient light is increased in a region of characters 220a, and the region of the characters 220a is visually recognized as a white turbidity. In the region of characters 220b, a black color of the background screen or a black color of the liquid in the container 1 is visible. In this manner, the first pattern, such as the characters 220b, can be visually recognized.

In the present embodiment, cylindrical containers are taken as examples, but the containers are not limited thereto and may be box-shaped or cone-shaped.

In the present embodiment, an example is illustrated in which a first pattern configured by an assembly of second patterns is formed on the surface of a container, but a first pattern configured by an assembly of second patterns may be formed in the interior of the base material configuring the container.

Furthermore, with regard to the content contained in the container 1, by increasing the contrast of the first pattern with respect to the color of the content contained in the container that is transparent to visible light, a pattern with good visibility and a large amount of information can be formed. For example, if the content is black, forming a white turbid first pattern on the container makes the first pattern more visible; if the content is white, forming a black first pattern on the container makes the first pattern more visible.

The container may have any shape, such as a cylindrical column or a square column, without a shoulder portion or an inclined portion. The content of the container may be of any color, and may be anything that may be contained in a container, such as a cold or warm content, carbonic content, colloidal content (e.g., yogurt), or the like. The content may be, for example, coffee, tea, beer, water, juice, carbonic acid, milk, or the like, but is not limited thereto, and may be anything that can be contained in a container.

Alternatively, the processing state can be changed depending on the content of the container. For example, depending on the content of the container, the intensity of the laser can be adjusted to change the processing state in terms of attaining whiteness or white turbidity so that the shading can be controlled.

A second pattern may be formed according to the embossing shape of the PET bottle. Further, the aforementioned tilted processing may also be performed to process the contours of the recessed and protruding shapes, the interior, and the outer periphery of the PET bottle.

### Fourth Embodiment

Next, a pattern forming apparatus 200c according to the fourth embodiment will be described. Note that the same reference numerals are assigned to the same elements as those described with respect to the pattern forming apparatus 200 of the above-described embodiment, and the overlapping descriptions are omitted accordingly.

In the present embodiment, the second light scanning unit changes the angle of the reflection surface to scan the laser light in the scanning direction, and the first light scanning unit scans the laser light in the conveying direction so as to correct the deviation of the irradiation position of the scanning light on the base material due to the tilting in the conveying direction of the reflection surface of the second light scanning unit. Thus, the present embodiment ensures the accuracy in pattern formation on the base material. Here, tilting in the conveying direction of the reflection surface refers to tilting of the reflection surface about an axis orthogonal to the conveying direction in the plane of the reflection surface.

### Examples of Surface Tilt of Polygon Mirror

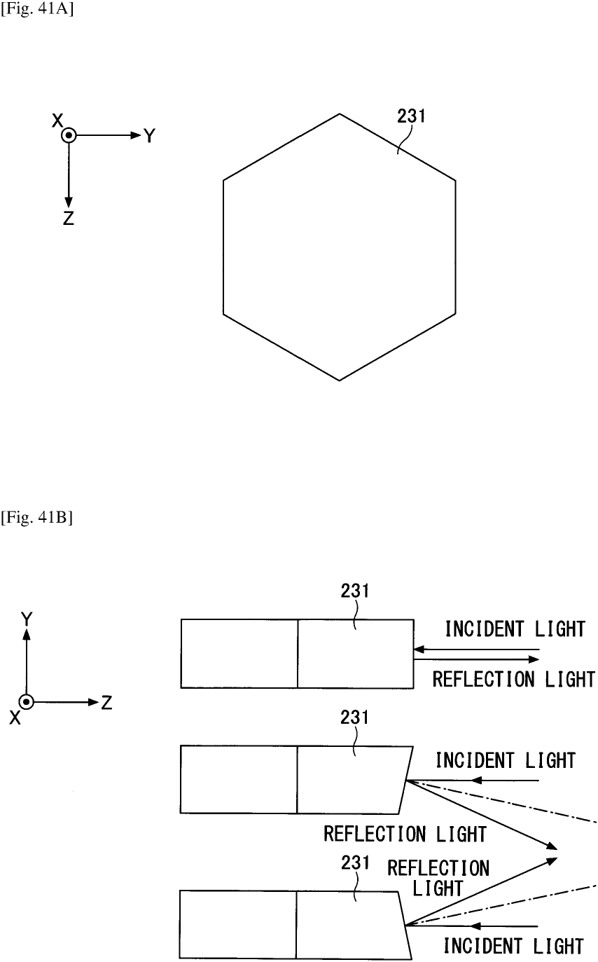

FIGS. 41A and 41B are diagrams illustrating examples of a surface tilt of a polygon mirror, wherein FIG. 41A is a top view of the polygon mirror, and FIG. 41B is a side view of the polygon mirror.

FIG. 41B illustrates a side view of three types of polygon mirrors. The top stage illustrates a state where there is no surface tilt, the middle stage illustrates a state where there is a surface tilt that deflects the reflection light in the Y-axis negative direction, and the bottom stage illustrates a state where there is a surface tilt that deflects the reflection light in the Y-axis positive direction. The surface tilt of the polygon mirror deviates the irradiation position of the scanning light on the base material and degrades the quality of the formed pattern.

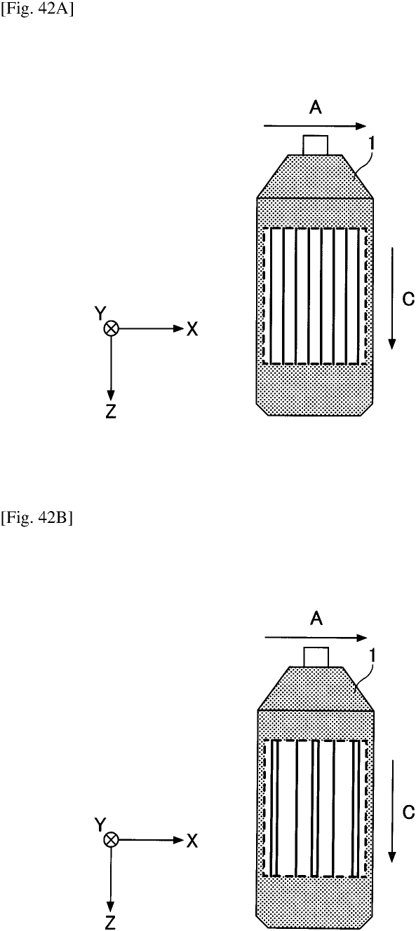

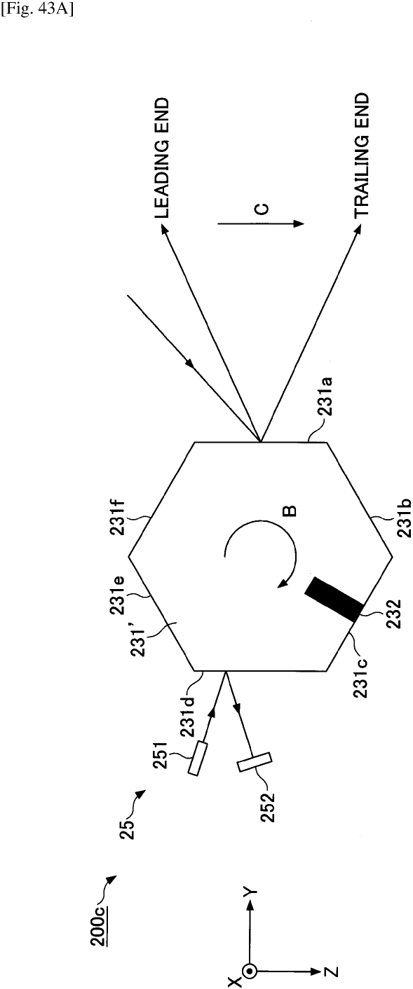

FIGS. 42A and 42B are diagrams for describing an example where the pattern quality is degraded due to a surface tilt of the polygon mirror. FIG. 42A illustrates a case where there is no positional deviation, and FIG. 42B illustrates a case where there is positional deviation.

When the polygon mirror does not have a surface tilt, as illustrated in FIG. 42A, the scanning lines scanned by the polygon mirror are equally spaced in the conveying direction. On the other hand, when the polygon mirror has a surface tilt, as illustrated in FIG. 42B, the intervals in the conveying direction between the scanning lines scanned by the polygon mirror are varied, and the quality of the formed pattern is degraded.

### Example of Configuration of the Pattern Forming Apparatus 200c

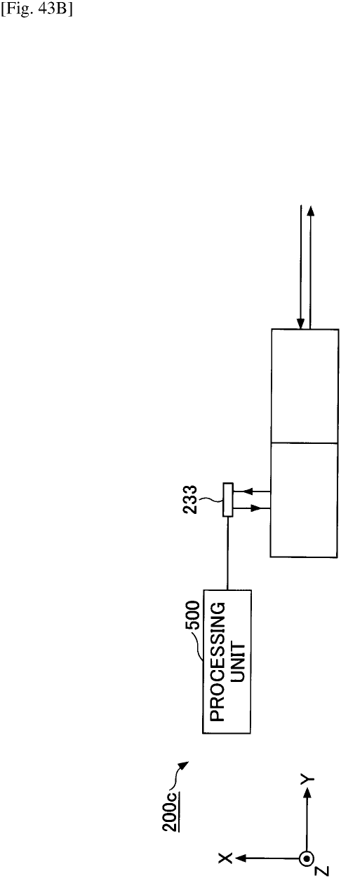

Next, a configuration of the pattern forming apparatus 200c will be described with reference to FIGS. 43A and 43B. FIGS. 43A and 43B are diagrams illustrating an example of a configuration of the pattern forming apparatus 200c, wherein FIG. 43A is a top view and FIG. 43B is a side view.

As illustrated in FIGS. 43A and 43B, the pattern forming apparatus 200c includes a polygon mirror 231′, a rotation origin sensor 233, and a processing unit 500. FIGS. 43A and 43B illustrate only the configuration of the main part of the pattern forming apparatus 200c. With respect to the configurations other than the main part of the pattern forming apparatus 200c, the configurations of the pattern forming apparatuses 200 described in the above embodiment can be applied.

As illustrated in FIG. 43A, the polygon mirror 231′ has a mark 232 on the X-axis positive side thereof, that is used to detect the origin of rotation of the polygon mirror 231′. The mark 232 may be formed by applying paint to the surface or by forming a predetermined shape, such as a recess portion or a protruding portion, on the X-axis positive side of the polygon mirror 231′. The pattern forming apparatus 200c detects the synchronization of the rotation of the polygon mirror 231′ by the synchronization detecting unit 25. Further, the polygon mirror 231′ includes six surfaces, i.e., surfaces 231a to 231f.

The rotation origin sensor 233 is a reflection type sensor provided on the X-axis positive side with respect to the polygon mirror 231′. The rotation origin sensor 233 includes a light emitting element such as a LD and a light receiving element such as a PD. The light emitting element emits light on the X-axis positive side of the polygon mirror 231′ and the light receiving element receives light, which has been emitted by the light emitting element and reflected from the X-axis positive side of the polygon mirror 231′, and outputs a voltage signal corresponding to the light intensity of the received light to the processing unit 500. The pattern forming apparatus 200a corrects the deviation of the irradiation position of the scanning light on the base material due to the tilt of the reflection surface of the polygon mirror 231′ (referred to as “surface tilt”), based on the output signal of the rotation origin sensor 233 including the detection information of the mark 232.

### Example of Functional Configuration of the Processing Unit 500

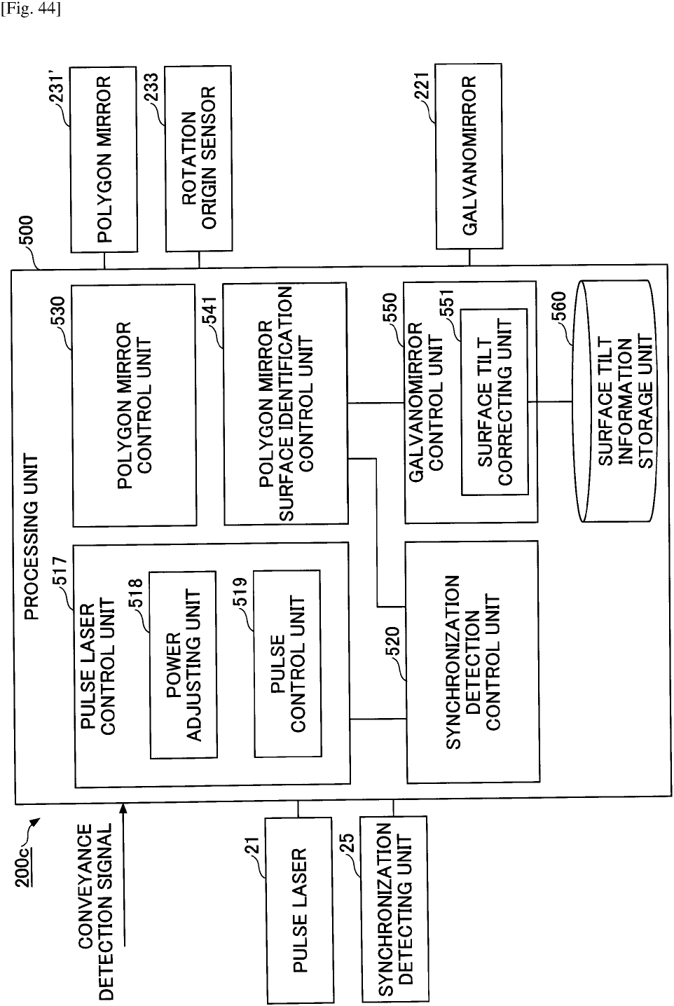

Next, the functional configuration of the processing unit 500 included in the pattern forming apparatus 200c will be described with reference to FIG. 44. FIG. 44 is a block diagram illustrating an example of a functional configuration of the processing unit 500. The functional configuration will be described also by referring to the configuration diagrams of FIGS. 1 to 3 and FIGS. 43A and 43B as appropriate.

As illustrated in FIG. 44, the processing unit 500 includes a pulse laser control unit 517, a synchronization detection control unit 520, a polygon mirror control unit 530, a polygon mirror surface identification control unit 541, a galvanomirror control unit 550, and a surface tilt information storage unit 560.

Among these, the functions of the pulse laser control unit 517, the synchronization detection control unit 520, the polygon mirror control unit 530, the polygon mirror surface identification control unit 541, and the galvanomirror control unit 550 can be implemented by an electric circuit of the processing unit 500, and a part of these functions can be implemented by software (a Central Processing Unit (CPU). These functions may be implemented by multiple circuits or multiple pieces of software. Further, the function of the surface tilt information storage unit 560 can be implemented by a storage device such as a hard disk drive (HDD).

The pulse laser control unit 517 includes a power adjusting unit 518 and a pulse control unit 519 to control the pulse laser 21. The power adjusting unit 518 controls the power of the pulse laser light emitted by the pulse laser 21, and the pulse control unit 519 controls the pulse width of the pulse laser light. The pulse laser control unit 517 can control the emission of the pulse laser light based on the detection signal from the synchronization detection control unit 520.

The synchronization detection control unit 520 controls the emission of laser light emitted by the synchronization detection LD 251 that is provided in the synchronization detecting unit 25, acquires the detection signal of the synchronization detection PD 252, and provides the detection signal to the pulse laser control unit 517 and the polygon mirror surface specific control unit 541, respectively. The polygon mirror control unit 530 controls the rotational driving of the polygon mirror 231′.

The polygon mirror surface identification control unit 541 detects the information of the rotation origin of the polygon mirror 231′, based on the output of the rotation origin sensor 233. The polygon mirror surface identification control unit 541 can identify the surface that is emitting pulse laser light to the base material configuring the container 1 during the rotation of the polygon mirror 231′, among the six surfaces configuring the polygon mirror 231′, based on the detection timing of the rotation origin and the detection signal of the synchronization detection control unit 520. The polygon mirror surface identification control unit 541 provides information regarding the identified surface, to the galvanomirror control unit 550.

The galvanomirror control 550 includes a surface tilt correcting unit 551 for controlling the oscillation driving of the galvanomirror 221. The surface tilt correcting unit 551 refers to the surface tilt information storage unit 560 to acquire the surface tilt information of each surface of the polygon mirror 231′ that is acquired in advance and stored in the surface tilt information storing unit 560. Then, by controlling the oscillation angle of the galvanomirror 221 based on the surface tilt information, the surface tilt correcting unit 551 corrects the deviation of the position at which the scanning light 202 scanned by the polygon mirror 231′ is emitted onto the base material of the container 1, caused by the surface tilt of each surface of the polygon mirror 231′.

The surface tilt of each surface of the polygon mirror 231′ reappears each time the polygon mirror 231′ rotates. Therefore, among the six surfaces configuring the polygon mirror 231′, the surface that is irradiating the base material with the pulse laser light is identified, and the angle of the galvanomirror 221 is adjusted so as to cancel the surface tilt, so that the deviation of the irradiation position of the scanning light 202 caused by the surface tilt can be corrected.

### Example of Surface Tilt Correction Operation

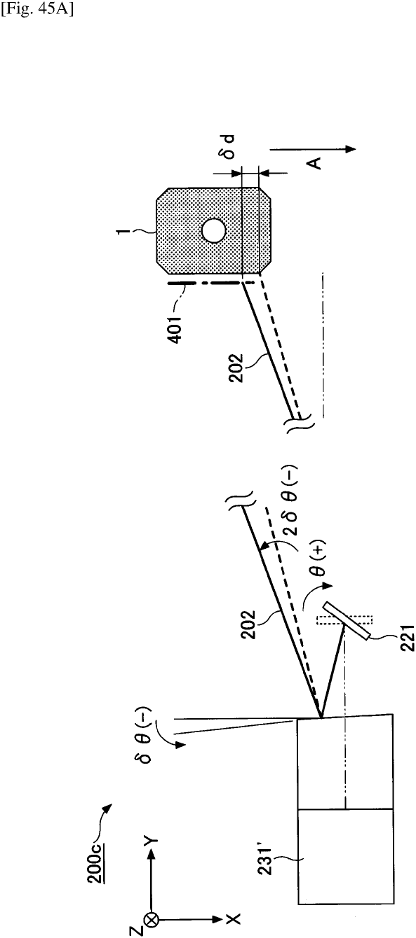

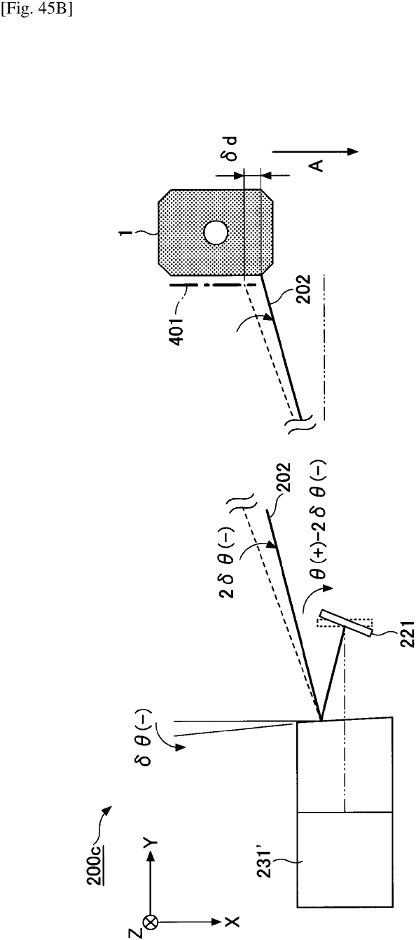

Next, an operation of correcting the surface tilt of the polygon mirror 231′ in the pattern forming apparatus 200c will be described with reference to FIGS. 45A and 45B. FIGS. 45A and 45B are diagrams illustrating an example of an operation of the pattern forming apparatus 200c, wherein FIG. 45A is a correction example by scanning in the X-axis positive direction and FIG. 45B is a correction example by scanning in the X-axis negative direction.

In FIG. 45A, the reflection surface of the polygon mirror 231′ is tilted in the X-axis negative direction by δθ(-) degrees. In this case, the reflection light of the polygon mirror 231′ is deviated by 2×δθ(-) degrees with respect to the reflection light of the reflection surface in a normal state, and the irradiation position of the scanning light 202 is deviated in the X-axis negative direction by an irradiation position deviation δd on the base material of the container 1.

On the other hand, in the present embodiment, the galvanomirror 221 scans (deflects) the pulse laser light by an angle of θ(+)-2×δθ(-) degrees, based on the surface tilt information of the polygon mirror 231′, thereby correcting the irradiation position deviation δd.

In FIG. 45B, the reflection surface of the polygon mirror 231′ is tilted in the X-axis positive direction by δθ(-) degrees. Also in this case, the pattern forming apparatus 200c can correct the irradiation position deviation δd caused by the surface tilt of the polygon mirror 231′.

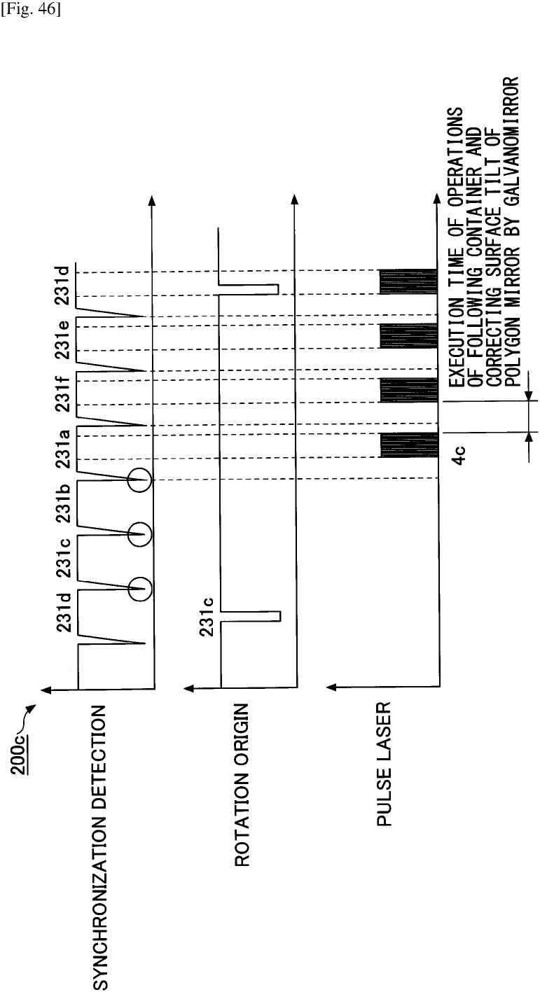

Next, FIG. 46 is a timing chart explaining a first example of an operation of the pattern forming apparatus 200c. The timing illustrated in the upper stage of FIG. 46 indicates the timing of the synchronization detection signal output by the synchronization detecting unit 25. The synchronization detection signals of the surface 231d, the surface 231c, the surface 231b, the surface 231a, the surface 231f, the surface 231e, and the surface 231d are displayed in the stated order starting from the left side as viewed in the figure.

The timing illustrated in the middle stage of FIG. 46 indicates the timing of the rotation origin signal output by the rotation origin sensor 233. The rotation origin sensor 233 detects the mark 232 formed at a position corresponding to the surface 231c of the polygon mirror 231′, at the timing of the synchronization detection signal of the surface 231d of the polygon mirror 231′. In this case, the timing of the synchronization detecting signal output by the synchronization detecting unit 25 and the timing of writing the scanning line are predetermined at the time of pre-shipment adjustment or the like of the pattern forming apparatus 200c, so that an appropriate starting position of the pattern formation by the scanning light 202 can be determined. That is, in the example of FIG. 46, after the rotation origin sensor 233 detects the rotation origin, when the synchronization is detected three times, the pattern forming apparatus 200c starts the scanning by the surface 231c of the polygon mirror 231′.

The shape of the polygon mirror 231′ is a regular hexagonal shape, and, therefore, the interval between the trailing end of the scanning line and the leading end of the next scanning line when the polygon mirror 231′ rotates from the surface 231c to the surface 231d, is a known value. In this interval, the pattern forming apparatus 200c performs the operation of following the container 1 and the operation of correcting the surface tilt of the polygon mirror 231′ by the galvanomirror 221.

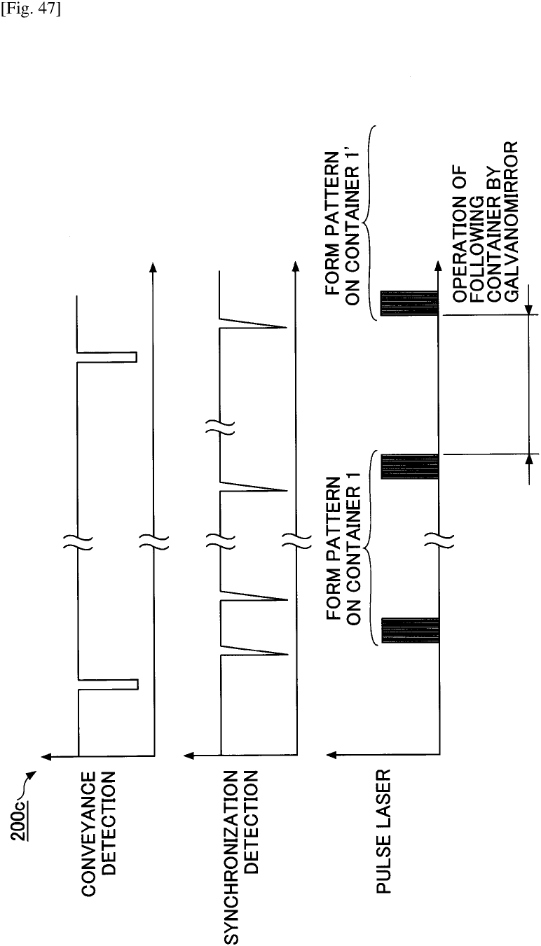

Next, FIG. 47 is a timing chart explaining a second example of the operation of the pattern forming apparatus 200c. FIG. 47 illustrates the timing from after forming a pattern onto the container 1 until starting to form a pattern onto the next container 1′. The conveying speeds of the containers 1 and 1′ are constant, and, therefore, after the conveyance detecting unit 300 detects the container 1, a predetermined number of synchronization detections is counted, and then pattern formation onto the container 1′ is started. The pattern formation region is predetermined, and, therefore, after forming a corresponding number of scanning lines (corresponding to a number of synchronization detections), the pattern forming is completed. Then, during the period from when the next container 1′ is detected until the pattern formation on the next container 1′ is started, the angle of the galvanomirror 221 can be changed so that the scanning light 202 is positioned at the start position of the non-pattern formation section 404′.

### Effect of the Pattern Forming Apparatus 200c

As described above, in the present embodiment, the polygon mirror 231′ (the second light scanning unit) changes the angle of the reflection surface to scan the laser light in the scanning direction, and the galvanomirror 221 (the first light scanning unit) scans the laser light in the conveying direction so as to correct the deviation of the irradiation position of the scanning light on the base material caused by the tilt of the reflection surface in the conveying direction.

Accordingly, the pattern forming apparatus 200c can correct the deviation of the irradiation position of the scanning light caused by the surface tilt of the second light scanning unit, and ensure the accuracy in forming a pattern on the base material. Other effects are the same as those described in the above embodiments.

### Fifth Embodiment

Next, a pattern forming apparatus 200d according to the fifth embodiment will be described. Incidentally, in a pattern forming apparatus without the first light scanning unit such as the galvanomirror, the conveying speed of a container is constant, and, therefore, the pixel density cannot be changed, and in order to increase the pixel density (resolution), the pixel density of the entire pattern needs to be increased. As a result, the time taken for pattern formation becomes long.

In the present embodiment, the pattern forming apparatus forms a pattern based on image data, and the first light scanning unit changes the scanning amount of the laser light in accordance with at least one of the presence or absence of image data in the pattern formation region of the base material or the type of the image data, thereby enabling an increase in the pixel density in the pattern in only the desired region.

In the configuration of the pattern forming apparatus 200d, the configuration of the pattern forming apparatus 200 illustrated in the above embodiment can be applied.

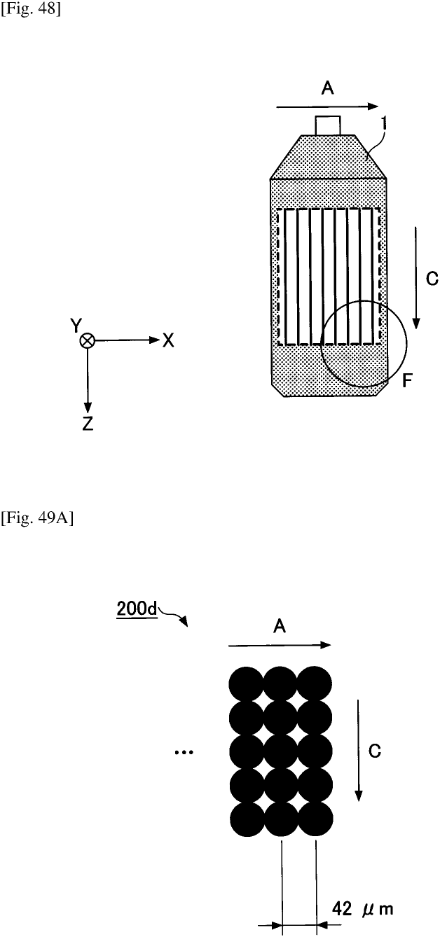

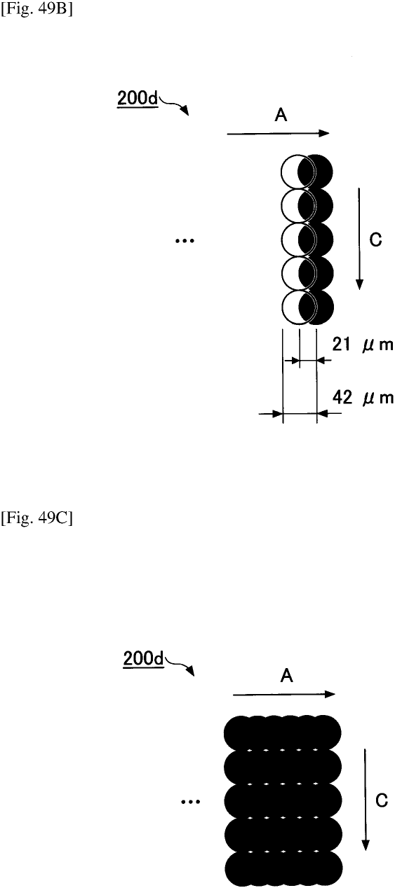

The scanning light in the scanning direction can be scanned by the galvanomirror in the conveying direction so as to follow the container, so that the interval between the scanning lines in the conveying direction can be equalized to form a pattern, as illustrated in FIG. 48. An enlarged view around a region F enclosed by a circle in FIG. 48 is illustrated in FIGS. 49A to 49C.

FIGS. 49A to 49C are diagrams illustrating an example of the pixel density of a pattern. FIG. 49A illustrates one example of 600 dpi (dot per inch), FIG. 49B illustrates one example of 1200 dpi, and FIG. 49C illustrates another example of 1200 dpi.

As illustrated in FIG. 49A, at 600 dpi, the pattern forming apparatus 200d forms a pattern by scanning lines having intervals of 42 micrometers. As illustrated in FIG. 49B, at 1200 dpi, the pattern forming apparatus 200d forms a pattern by scanning lines having intervals of 21 micrometers.

In the present embodiment, the pixel density in a desired region can be changed, by changing the scanning amount (the amount of movement of the scanning line) in a direction along the conveying direction of a scanning line scanned in the scanning direction by the galvanomirror. The desired region is the region in accordance with at least one of the presence or absence of image data in the pattern formation region of the base material or the type of image data.

For example, by changing the pixel density of the corresponding region according to the type of image included in a pattern, such as a character region (text, etc.) and an image region (photograph, graphic shape, design, bar code, etc.), appropriate visibility of the corresponding region can be ensured according to the type of image.

The pixel density can be set to any density; however, the difference in pixel density between the region in which the pixel density is changed and the region in which the pixel density is not changed, is preferably an integer multiple. For example, 1200 dpi is twice the pixel density of 600 dpi. In the 600 dpi region, a pattern is formed by scanning line intervals according to the conveying speed, and only in the 1200 dpi region, the scanning amount by the galvanomirror is changed, so that a pattern can be formed corresponding to both pixel densities, by a minimum number of lines.

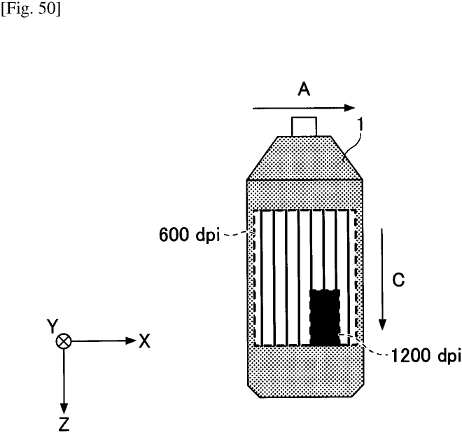

FIG. 50 is a diagram illustrating an example of a pattern according to the present embodiment. The portion filled with black is a region having a pixel density of 1200 dpi, and the rest is a region having a pixel density of 600 dpi. As described above, the pattern forming apparatus 200d can change the pixel density only in the desired region of a pattern.

### Sixth Embodiment

The sixth embodiment described below is based on the pattern forming apparatus 200 illustrated in FIGS. 1 to 3, etc., and, therefore, overlapping descriptions are omitted.

### Fluence Conditions of Pulse Laser Light According to Sixth Embodiment

Next, a fluence condition of the pulse laser light according to the sixth embodiment will be described.

The fluence F of the pulse laser light can be expressed as by the following formulas (4) and (5).

$$\text{P=E} ⋅ v \qquad \text{(4)}$$

$$\text{F=} \text{E} / \text{S} \qquad \text{(5)}$$

In the above, P (W) represents the average output (light intensity) of the pulse laser, E (J) represents the pulse energy per pulse of the pulse laser light, and v (Hz) represents the repetition frequency of the emission of the pulse laser light emitted by the pulse laser. F J/cm² represents the fluence and S (cm2) represents the area of the laser beam spot. The fluence F corresponds to a value obtained by dividing the pulse energy by the area of the laser beam spot. The fluence at the base material configuring the container 1 is a value obtained by dividing the pulse energy of the pulse laser light emitted by the pulse laser 21 by the area of the laser beam spot on the base material configuring the container 1.

When a pulse laser light having a pulse width of the nanosecond scale is used, pattern formation (laser processing) is performed by thermal denaturation according to the light absorption spectrum of the base material. On the other hand, when a pulse laser light having a pulse width of the picosecond-scale is used, pattern formation (laser processing) is performed by thermal denaturation according to both the light absorption spectrum and multiphoton absorption. Multiphoton absorption refers to a nonlinear phenomenon in which the pulse laser light is emitted to be a state in which the pulse laser light is excited by light having a wavelength corresponding to ½ or ⅓ of the pulse laser light’s oscillation wavelength, and the state of electrons and atoms transition to a high energy level when multiple photons are absorbed. By using a pulse laser light having a pulse width of the picosecond-scale, the base material is sublimated from a solid state without passing through a molten state, and processing marks are formed on the base material.

Here, as a result of an experiment in which the fluence is changed according to the thickness (wall thickness) of the base material, with a plurality of combinations of the oscillation wavelength and pulse width of the pulse laser light, it was found that a pattern with good visibility can be formed while ensuring the mechanical strength of the base material by satisfying the following first to the eighth conditions.

### First Condition

When the oscillation wavelength of the pulse laser is 300 nanometers or more and 400 nanometers or less, and the pulse width of the pulse laser light is 10 picoseconds or more and 200 picoseconds or less, the fluence per pulse of the pulse laser light at the base material J/cm² is to satisfy the following formulas (10-1) and (10-2).

$$0.01 ≦ \text{t} < 1 \qquad \text{(10-1)}$$

$$0.61 \text{t} + 0.15 ≦ \text{F} ≦ 64.1 \text{t} + 32 \qquad \text{(10-2)}$$

(In the formulas (10-1) and (10-2), t represents the thickness of the base material in millimeters and F represents the fluence.)

### Second Condition

When the oscillation wavelength of the pulse laser of the pulse laser light is 300 nanometers or more and 400 nanometers or less, and the pulse width is 0.1 picoseconds or more and less than 10 picoseconds, the fluence per pulse J/cm² of the pulse laser light at the base material is to satisfy the following formulas (11-1), (11-2), and (11-3).

$$0.01 ≦ \text{t} < 1 \qquad \text{(11-1)}$$

$$0.1 ≦ \text{s} < 10 \qquad \text{(11-2)}$$

$$0.31 \text{s} + 0.023 ≦ \text{F} ≦ 64.1 \text{t} + 32 \qquad \text{(11-3)}$$

(In the formulas (11-1), (11-2), and (11-3), t represents the thickness of the base material in millimeters, s represents the pulse width of the pulse laser light in picoseconds, and F represents the fluence.)

### Third Condition

When the oscillation wavelength of the pulse laser is 300 nanometers or more and 400 nanometers or less, and the pulse width of the pulse laser light is 1 nanosecond or more and 100 nanoseconds or less, the fluence per pulse J/cm² of the pulse laser light at the base material is to satisfy the following formulas (12-1) and (12-2).

$$0.01 ≦ \text{t} < 1 \qquad \text{(12-1)}$$

$$\text{5t} + 1.7 ≦ \text{F} ≦ 67.7 \text{t} + 26.5 \qquad \text{(12-2)}$$

(In the formulas (12-1) and (12-2), t represents the thickness of the base material in millimeters and F represents the fluence.)

### Fourth Condition

When the oscillation wavelength of the pulse laser is 500 nanometers or more and 600 nanometers or less, and the pulse width of the pulse laser light is 10 picoseconds or more and 200 picoseconds or less, the fluence per pulse J/cm² of the pulse laser light at the base material is to satisfy the following formulas (13-1) and (13-2).

$$0.01 \underline{\leq } \text{t < 1} \qquad \text{(13-1)}$$

$$10.4 \text{t + 3} \text{.2} \underline{\leq } \text{F} \underline{\leq } 196.2 \text{t} \qquad \text{(13-2)}$$

(In formulas (13-1) and (13-2), t represents the thickness of the base material in millimeters and F represents the fluence.)

### Fifth Condition

When the oscillation wavelength of the pulse laser is 500 nanometers or more and 600 nanometers or less, and the pulse width of the pulse laser light is 0.1 picoseconds or more and less than 1 picosecond, the fluence per pulse J/cm² of the pulse laser light at the base material is to satisfy the following formulas (14-1) and (14-2).

$$0.01 \underline{\leq } \text{t < 1} \qquad \text{(14-1)}$$

$$0.17 \underline{\leq } \text{F} \underline{\leq } 196.2 \text{t} \qquad \text{(14-2)}$$

(In formulas (14-1) and (14-2), t represents the thickness of the base material in millimeters and F represents the fluence.)

### Sixth Condition

When the oscillation wavelength of the pulse laser is 500 nanometers or more and 600 nanometers or less, and the pulse width of the pulse laser light is 1 picoseconds or more and less than 10 picoseconds, the fluence per pulse J/cm² of the pulse laser light at the base material is to satisfy the following formulas (15-1), (15-2), and (15-3).

$$0.01 \underline{\leq } \text{t < 1} \qquad \text{(15-1)}$$

$$1 \underline{\leq } \text{s < 10} \qquad \text{(15-2)}$$

$$0.76 \text{s-0} \text{.59} \underline{\leq } \text{F} \underline{\leq } 196.2 \text{t} \qquad \text{(15-3)}$$

(In the formulas (15-1), (15-2), and (15-3), t represents the thickness of the base material in millimeters, s represents the pulse width of the pulse laser light in picoseconds, and F represents the fluence.)

### Seventh Condition

When the oscillation wavelength of the pulse laser is 1,000 nanometers or more and 1,100 nanometers or less, and the thickness of the base material is 0.01 millimeters or more and less than 1 millimeter, and the pulse width of the pulse laser light is 0.1 picoseconds or more and less than 1 picosecond, the fluence per pulse J/cm² of the pulse laser light at the base material is to satisfy the following formula (16-1).

$$1 \underline{\leq } \text{F} \underline{\leq } 8 \qquad \text{(16-1)}$$

(In the formula (16-1), F represents the fluence.)

### Eighth Condition

When the oscillation wavelength of the pulse laser is 1,000 nanometers or more and 1,100 nanometers or less, and the thickness of the base material is 0.01 millimeters or more and less than 1 millimeter, and the pulse width of the pulse laser light is 1 picosecond or more and 3 picoseconds or less, the fluence per pulse J/cm² of the pulse laser light at the base material is to satisfy the following formulas (17-1) and (17-2).

$$1 \underline{\leq } \text{s} \underline{\leq } 3 \qquad \text{(17-1)}$$

$$0.89 \text{s} \text{+} \text{0} \text{.11} \underline{\leq } \text{F} \underline{\leq } 8 \qquad \text{(17-2)}$$

(In formulas (17-1) and (17-2), s represents the pulse width of the pulse laser light in picoseconds and F represents the fluence.)

### Examples of Experimental Results

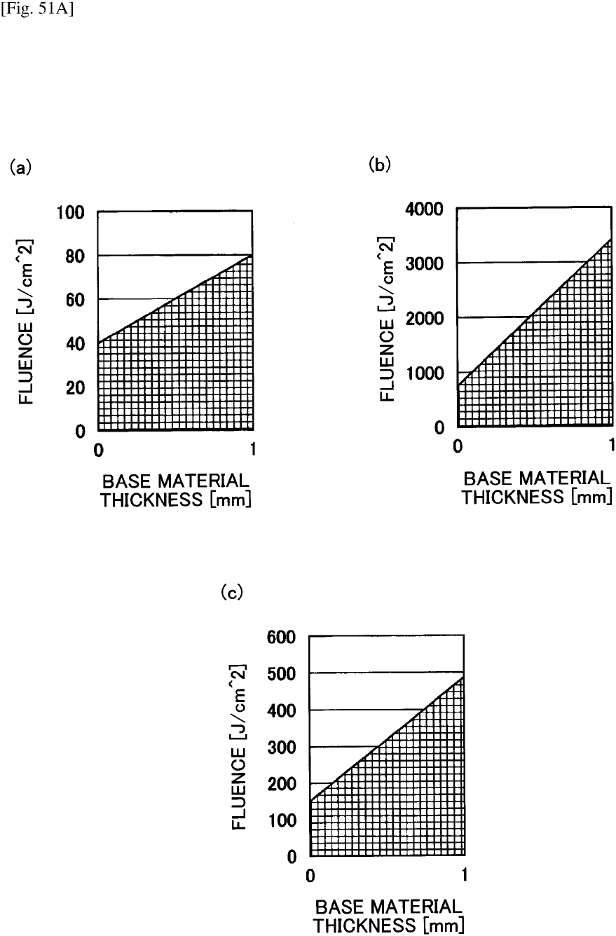

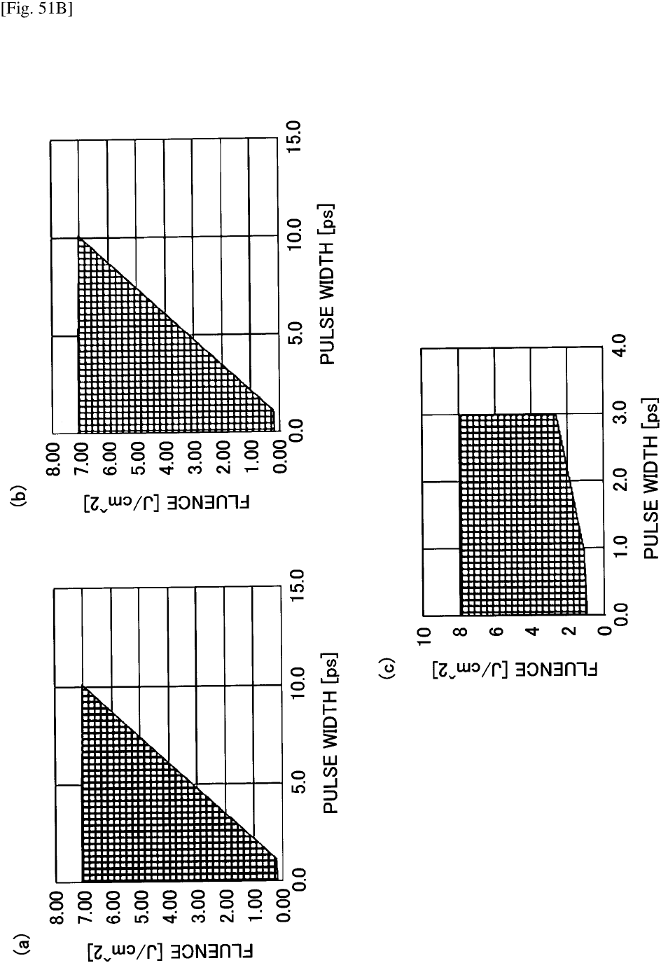

FIG. 51A illustrates an example of the experimental result of the relationship between the thickness of the base material and the fluence of the pulse laser light. In FIG. 51A, (a) indicates the results with respect to the first condition, (b) indicates the results with respect to the fourth condition, and (c) indicates the results with respect to the third condition. In each of (a) to (c) in FIG. 51A, the horizontal axis represents the thickness mm of the base material and the vertical axis represents the fluence J/cm². FIG. 51A illustrates the results obtained by using a picosecond laser (model name: Talisker Ultra 355-4, manufactured by Coherent Inc.).

In FIG. 51A, each of the regions illustrated by lattice hatching indicates a range that satisfies the first condition, the fourth condition, or the third condition. The range where the fluence is below the lower limit indicates that a pattern having good visibility is not formed on the base material. Further, the range where the fluence exceeds the upper limit indicates that the surface of the base material has become discolored due to oxidation or through holes have been formed in the base material due to being irradiated by pulse laser light.

The upper and lower limits of fluence were obtained by forming a pattern on the base material while changing the average output (light intensity) of a laser light source such as the pulse laser 21 (see FIG. 1) with an attenuator, and evaluating the results of forming each pattern.

FIG. 51A (a) illustrates the experimental results when the pulse laser 21 has an oscillation wavelength of 355 nanometers, and a pulse width of 15 picoseconds, and the base material has a thickness of 0.11 mm, 0.39 mm, and 0.55 mm. In the range of 0.01 ≦t < 1, the lower limit of fluence ranged from approximately 0.15 J/cm² to approximately 0.76 J/cm² depending on the thickness of the base material. The upper limit of fluence varied substantially linearly, ranging from approximately 40 J/cm² to approximately 80 J/cm² depending on the thickness of the base material.

The first condition was derived on the basis of experimental results using a plurality of pulse laser light beams having an oscillation wavelength of 300 nanometers or more and 400 nanometers or less, and a pulse width of 10 picoseconds or more and 200 picoseconds or less. FIG. 51A (a) is a representative example of such experimental results.

FIG. 51A (b) illustrates the experimental results when the pulse laser 21 has an oscillation wavelength of 532 nanometers, and a pulse width of 15 picoseconds, and the base material has a thickness of 0.11 mm, 0.39 mm, and 0.55 mm. In the range of 0.01 ≦t < 1, the lower limit of fluence ranged from approximately 3.3 J/cm² to approximately 13.6 J/cm² depending on the thickness of the base material. The upper limit of fluence varied substantially linearly, ranging from approximately 800 J/cm² to approximately 3,300 J/cm² depending on the thickness of the base material.

The fourth condition was also derived on the basis of experimental results using a plurality of pulse laser light beams having an oscillation wavelength of 500 nanometers or more and 600 nanometers or less, and a pulse width of 10 picoseconds or more and 200 picoseconds or less, similar to the first condition. FIG. 51A (b) is a representative example of such experimental results.

FIG. 51A (c) illustrates the experimental results when the pulse laser 21 has an oscillation wavelength of 355 nanometers, and a pulse width of 12 nanoseconds, and the base material has a thickness of 0.11 mm, 0.39 mm, and 0.55 mm. In the range of 0.01 ≦t < 1, the lower limit of fluence ranged from approximately 1.75 J/cm² to approximately 6.7 J/cm² depending on the thickness of the base material. The upper limit of fluence varied substantially linearly, ranging from approximately 70 J/cm² to approximately 480 J/cm² depending on the thickness of the base material.

The third condition was also derived on the basis of experimental results using a plurality of pulse laser light beams having an oscillation wavelength of 300 nanometers or more and 400 nanometers or less and a pulse width of 1 nanosecond or more and 100 nanoseconds or less, similar to the first condition. FIG. 51A (c) is a representative example of such experimental results.

Next, FIG. 51B illustrates examples of experimental results regarding the relationship between the pulse width and the fluence of the pulse laser light. In FIG. 51B, (a) indicates the results with respect to the second condition, (b) indicates the results with respect to the fifth and sixth conditions, and (c) indicates the results with respect to the seventh and eighth conditions. In each of (a) to (c) in FIG. 51B, the horizontal axis represents the pulse width picosecond (ps) and the vertical axis represents the fluence J/cm². FIG. 51B illustrates the results obtained by using a femtosecond laser (model name: Yuja, manufactured by Amplitude Systems).

In FIG. 51B, each of the regions illustrated by lattice hatching indicates a range that satisfies the second condition, the fifth condition, the sixth condition, the seventh condition, or the eighth condition. The range where the fluence is below the lower limit indicates that a pattern having good visibility is not formed on the base material. Further, the range where the fluence exceeds the upper limit indicates that the surface of the base material has become discolored due to oxidation or through holes have been formed in the base material due to being irradiated by pulse laser light.

The upper and lower limits of fluence were obtained by forming a pattern on the base material while changing the average output (light intensity) of a laser light source such as the pulse laser 21 (see FIG. 1) with an attenuator, and evaluating the results of forming each pattern.

FIG. 51B (a) illustrates the experimental results when the pulse laser 21 has an oscillation wavelength of 343 nanometers, the base material has a thickness of 0.39 mm, and a pulse width is 0.5 picoseconds, 0.9 picoseconds, 1 picosecond, 3 picoseconds, 5 picoseconds, 7 picoseconds, and 9 picoseconds. In the pulse width range of 0.1 ≦s < 10, the lower limit of fluence varied substantially linearly, ranging from approximately 0.05 J/cm² to approximately 3 J/cm² depending on the pulse width. The upper limit of fluence was similar to that of the first condition. The aforementioned s represents the pulse width of the pulse laser light in picoseconds.

The second condition was derived on the basis of experimental results using a plurality of pulse laser light beams having an oscillation wavelength of 300 nanometers or more and 400 nanometers or less, and a pulse width of 0.1 picoseconds or more and less than 10 picoseconds, similar to the first condition. FIG. 51B (a) illustrates a representative example of such experimental results.

FIG. 51B (b) illustrates the experimental results when the pulse laser 21 has an oscillation wavelength of 515 nanometers, the base material has a thickness of 0.39 mm, and the pulse width is 0.5 picoseconds, 0.9 picoseconds, 1 picosecond, 3 picoseconds, 5 picoseconds, 7 picoseconds, and 9 picoseconds. In the pulse width range of 0.1 ≦s < 1, the lower limit of fluence was 0.17 J/cm², regardless of the pulse width. The upper limit of fluence was similar to that of the fourth condition. In the pulse width range of 1 ≦s ≦10, the lower limit of fluence varied substantially linearly, ranging from approximately 0.17 J/cm² to approximately 7 J/cm² depending on the pulse width.

The fifth condition was derived on the basis of experimental results using a plurality of pulse laser light beams having an oscillation wavelength of 500 nanometers or more and 600 nanometers or less, and a pulse width of 0.1 picoseconds or more and less than 1 picosecond, as in the fourth condition. The sixth condition was derived on the basis of experimental results using a plurality of pulse laser light beams having an oscillation wavelength of 500 nanometers or more and 600 nanometers or less, and a pulse width of 1 picosecond or more and less than 10 picoseconds, as in the fourth condition. FIG. 51B (b) illustrates a representative example of such experimental results.

FIG. 51B (c) illustrates the experimental results when the pulse laser 21 has an oscillation wavelength of 1,030 nanometers, the base material has a thickness of 0.39 mm, and the pulse width is 0.5 picoseconds, 0.9 picoseconds, 1 picoseconds, 3 picoseconds, 5 picoseconds, 7 picoseconds, and 9 picoseconds. In the pulse width range of 0.1 ≦s < 1, the lower limit of fluence was 1 J/cm² regardless of the pulse width. Further, the upper limit of fluence was 8 J/cm² regardless of the pulse width. In the pulse width range of 1 ≦s ≦3, the lower limit of fluence varied substantially linearly, ranging from approximately 1 J/cm² to approximately 2.7 J/cm² depending on the pulse width.

The seventh condition was derived on the basis of the results of experiments using a plurality of pulse laser light beams having an oscillation wavelength of 1,000 nanometers or more and 1,100 nanometers or less, and a pulse width of 0.1 picoseconds or more and less than 1 picosecond. The eighth condition was also derived on the basis of the results of experiments using a plurality of pulse laser light beams having an oscillation wavelength of 1,000 nanometers or more and 1,100 nanometers or less, and a pulse width of 1 picosecond or more and 3 picoseconds or less, similar to the seventh condition. FIG. 51B (c) illustrates a representative example of such experimental results.

The reason why the range of the fluence that satisfies the condition differs according to the respective combinations of the oscillation wavelength and the pulse width of the pulse laser light, is because the denaturing mechanism differs depending on the scale of the pulse width. Further, the greater the thickness of the base material, the higher the upper limit of fluence that satisfies the condition, because as the thickness of the base material increases, the temperature of the base material irradiated with the pulse laser light does not appreciably rise and the base material does not appreciably melt, thereby requiring higher pulse energy.

As an example of fluence satisfying the condition in the embodiment, when the average output is 100 (W) and the repetition frequency is 200 (kHz), the pulse energy is 500 (µJ). If the beam spot diameter of the pulse laser light at the base material is 50 (µm), the fluence per pulse is 25.5 J/cm².

When the fluence satisfying the condition is 25.5 J/cm², it is possible to form a pattern satisfying the condition by emitting the pulse laser light of one pulse. When the fluence satisfying the condition is 51 J/cm², it is possible to form a pattern satisfying the condition by emitting the pulse laser light of two pulses.

Accordingly, even when the pulse energy per pulse is insufficient with respect to the fluence satisfying the condition, the condition of the fluence can be satisfied by increasing the number of pulses to be emitted. However, increasing the number of pulses slows the speed of pattern formation by a rate corresponding to the number of pulses.

### Effects of the Pattern Forming Apparatus 200

Next, an effect of the pattern forming apparatus 200 according to the sixth embodiment will be described.

Conventionally, techniques have been known in which a pattern is formed by pulse laser light on a transparent base material made of a transparent resin or the like that is transparent to visible light. Further, the transparent base material absorbs little wavelength in the visible light range, and, therefore, a configuration in which a pattern is formed using an infrared light having a wavelength of 10.6 micrometers, a CO₂ laser capable of emitting non-visible ultraviolet light having a wavelength of 355 nanometers, or the like, is disclosed.

However, when infrared light is used, the beam spot diameter cannot be sufficiently narrowed, so the resolution may be reduced and the visibility of the pattern may be reduced. Further, the use of ultraviolet light may reduce the visibility of the pattern depending on the thickness of the base material, or the mechanical strength of the base material may be reduced due to a through hole being formed in the base material due to excessive energy penetration, etc.

In the present embodiment, when the oscillation wavelength of the pulse laser is 300 nanometers or more and 400 nanometers or less, the pattern forming apparatus is configured to satisfy at least one of the following (A) to (C).

(A) When the pulse width of the pulse laser light is 10 picoseconds or more and 200 picoseconds or less, the pattern forming apparatus is configured such that the fluence per pulse J/cm² of the pulse laser light at the base material satisfies the following formulas (10-1) and (10-2).

$$0.01 \underline{\leq } \text{t < 1} \qquad \text{(10-1)}$$

$$0.61 \text{t} \text{+} \text{0} \text{.15} \underline{\leq } \text{F} \underline{\leq } 64.1 \text{t} \text{+} \text{32} \qquad \text{(10-2)}$$

(In the formulas (10-1) and (10-2), t represents the thickness of the base material in millimeters and F represents the fluence.)

(B) When the pulse width of the pulse laser light is 0.1 picoseconds or more and less than 10 picoseconds, the pattern forming apparatus is configured such that the fluence per pulse J/cm² of the pulse laser light at the base material satisfies the following formulas (11-1), (11-2), and (11-3).

$$0.01 \underline{\leq } \text{t < 1} \qquad \text{(11-1)}$$

$$0.1 \underline{\leq } \text{s < 10} \qquad \text{(11-2)}$$

$$0.31 \text{s} \text{+} \text{0} \text{.023} \underline{\leq } \text{F} \underline{\leq } 64.1 \text{t} \text{+} \text{32} \qquad \text{(11-3)}$$

(In the formulas (11-1), (11-2), and (11-3), t represents the thickness of the base material in millimeters, s represents the pulse width of the pulse laser light in picoseconds, and F represents the fluence.)

(C) When the pulse width of the pulse laser light is 1 nanosecond or more and 100 nanoseconds or less, the pattern forming apparatus is configured such that the fluence per pulse J/cm² of the pulse laser light at the base material satisfies the following formulas (12-1) and (12-2).

$$0.01 \underline{\leq } \text{t < 1} \qquad \text{(12-1)}$$

$$5 \text{t} \text{+} \text{1} \text{.7} \underline{\leq } \text{F} \underline{\leq } 67.7 \text{t} \text{+} \text{26} \text{.5} \qquad \text{(12-2)}$$

(In the formulas (12-1) and (12-2), t represents the thickness of the base material in millimeters and F represents the fluence.)

In the present embodiment, when the oscillation wavelength of the pulse laser is 500 nanometers or more and 600 nanometers or less, the pattern forming apparatus is configured to satisfy at least one of the following (D) to (F).

(D) When the pulse width of the pulse laser light is 10 picoseconds or more and 200 picoseconds or less, the pattern forming apparatus is configured such that the fluence per pulse J/cm² of the pulse laser light at the base material satisfies the following formulas (13-1) and (13-2).

$$0.01 \underline{\leq } \text{t < 1} \qquad \text{(13-1)}$$

$$\text{10} \text{.4t} \text{+3} \text{.2} \underline{\leq } \text{F} \underline{\leq } 196.2 \text{t} \qquad \text{(13-2)}$$

(In formulas (13-1) and (13-2), t represents the thickness of the base material in millimeters and F represents the fluence.)

(E) When the pulse width of the pulse laser light is 0.1 picoseconds or more and less than 1 picosecond, the pattern forming apparatus is configured such that the fluence per pulse J/cm² of the pulse laser light at the base material satisfies the following formulas (14-1) and (14-2).

$$0.01 \underline{\leq } \text{t < 1} \qquad \text{(14-1)}$$

$$0.17 \underline{\leq } \text{F} \underline{\leq } 196.2 \text{t} \qquad \text{(14-2)}$$

(In formulas (14-1) and (14-2), t represents the thickness of the base material in millimeters and F represents the fluence.)

(F) When the pulse width of the pulse laser light is 1 picosecond or more and less than 10 picoseconds, the pattern forming apparatus is configured such that the fluence per pulse J/cm² of the pulse laser light at the base material satisfies the following formulas (15-1), (15-2), and (15-3).

$$0.01 \underline{\leq } \text{t < 1} \qquad \text{(15-1)}$$

$$1 \underline{\leq } \text{s < 10} \qquad \text{(15-2)}$$

$$0.76 \text{s-0} \text{.59} \underline{\leq } \text{F} \underline{\leq } 196.2 \text{t} \qquad \text{(15-3)}$$

(In the formulas (15-1), (15-2), and (15-3), t represents the thickness of the base material in millimeters, s represents the pulse width of the pulse laser light in picoseconds, and F represents the fluence.)

In the present embodiment, when the oscillation wavelength of the pulse laser is 1,000 nanometers or more and 1,100 nanometers or less, and the thickness of the base material is 0.01 millimeters or more and less than 1 millimeter, the pattern forming apparatus is configured to satisfy at least one of (G) and (H) below.

(G) When the pulse width of the pulse laser light is 0.1 picoseconds or more and less than 1 picosecond, the pattern forming apparatus is configured such that the fluence per pulse J/cm² of the pulse laser light at the base material satisfies the following formula (16-1).

$$1 \underline{\leq } \text{F} \underline{\leq } 8 \qquad \text{(16-1)}$$

(In the formula (16-1), F represents the fluence.)

(H) When the pulse width of the pulse laser light is 1 picosecond or more and 3 picoseconds or less, the pattern forming apparatus is configured such that the fluence per pulse J/cm² of the pulse laser light at the base material satisfies the following formulas (17-1) and (17-2).

$$1 \underline{\leq } \text{s} \underline{\leq } 3 \qquad \text{(17-1)}$$

$$0.89 \text{s} \text{+} \text{0} \text{.11} \underline{\leq } \text{F} \underline{\leq } 8 \qquad \text{(17-2)}$$

(In formulas (17-1) and (17-2), s represents the pulse width of the pulse laser light in picoseconds and F represents the fluence.)

With this configuration, a pattern with good visibility can be formed in accordance with the thickness of the base material, and a pattern can be formed on the base material within the range of fluence that does not decrease the mechanical strength of the base material, and a pattern with good visibility can be formed while ensuring the mechanical strength of the base material.

In the present embodiment, a container having a rectangular shape and a flat portion is described as an example. However, even a container having other shapes, such as a cylindrical shape, is applicable to the present embodiment.

### Seventh Embodiment

Next, a pattern forming apparatus 200e according to the seventh embodiment will be described. The same elements as those of the embodiment described with reference to FIGS. 1 to 3, etc., are denoted by the same reference numerals, and the overlapping descriptions are omitted accordingly.

In the present embodiment, the pulse laser light emitted by each of the plurality of pulse lasers of the light source unit, is scanned in a predetermined direction, and the scanning light of each pulse laser light is emitted at different positions of the base material in a direction intersecting the predetermined direction.

Alternatively, the pulse laser light emitted by each of the plurality of pulse lasers is scanned in a predetermined direction, and the scanning light beams of the respective pulse laser light beams are emitted so as to overlap each other at the same position of the base material in a direction intersecting the predetermined direction.

Accordingly, the condition of fluence is also satisfied when a pulse laser with low pulse energy or low emission repetition frequency is used, and a pattern with good visibility can be formed while ensuring the mechanical strength of the base material.

### Example of Configuration of the Pattern Forming Apparatus 200e

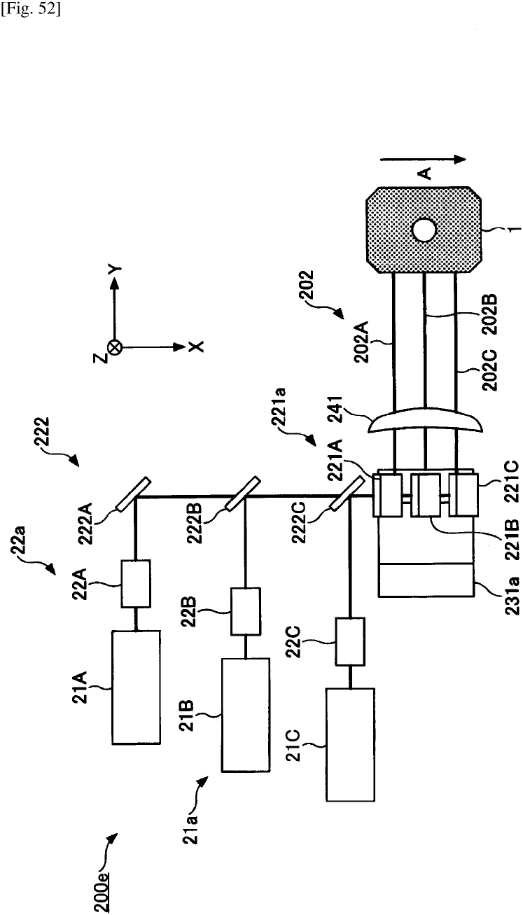

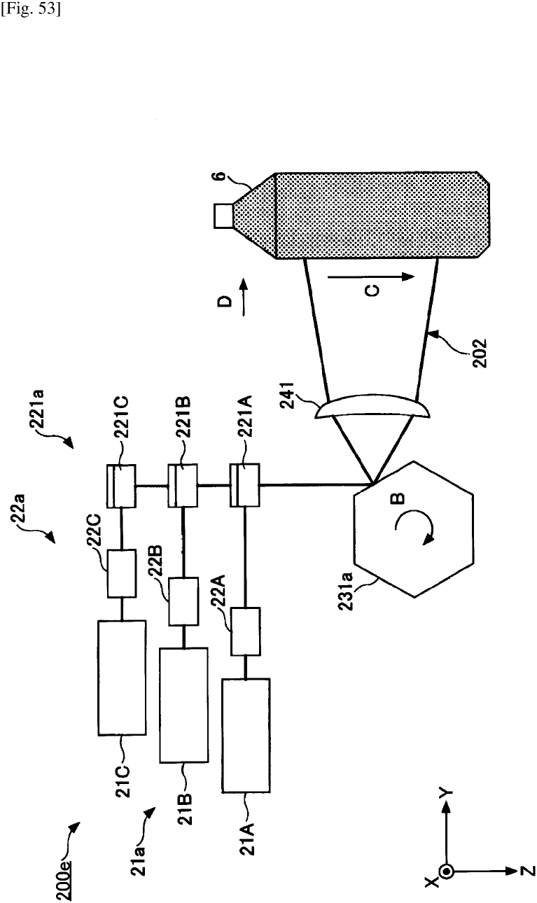

First, the configuration of the pattern forming apparatus 200e will be described with reference to FIGS. 52 and 53. FIG. 52 is a top view and FIG. 53 is a side view illustrating an example of the configuration of the pattern forming apparatus 200e.

As illustrated in FIGS. 52 and 53, the pattern forming apparatus 200e includes a pulse laser group 21a, a beam expander group 22a, an X-axis deflection mirror group 222, a Z-axis deflection mirror group 221a, and a polygon mirror 231a.

The pulse laser group 21a includes a pulse laser 21A, a pulse laser 21B, and a pulse laser 21C. The beam expander group 22a includes a beam expander 22A, a beam expander 22B, and a beam expander 22C. The X-axis deflection mirror group 222 includes an X-axis deflection mirror 222A, an X-axis deflection mirror 222B, and an X-axis deflection mirror 222C. The Z-axis deflection mirror group 221a includes a Z-axis deflection mirror 221A, a Z-axis deflection mirror 221B, and a Z-axis deflection mirror 221C.

The pulse laser light emitted by the pulse laser 21A is enlarged in beam diameter at the beam expander 22A, deflected in the X-axis positive direction at the X-axis deflection mirror 222A, deflected in the Z-axis positive direction at the Z-axis deflection mirror 221A, and is then incident on the reflection surface of the polygon mirror 231a.

Similarly, the pulse laser light emitted by the pulse laser 21B is enlarged in beam diameter at the beam expander 22B, deflected in the X-axis positive direction at the X-axis direction deflector mirror 222B, deflected in the Z-axis positive direction at the Z-axis direction deflector mirror 221B, and is then incident on the reflection surface of the polygon mirror 231a.

The pulse laser light emitted by the pulse laser 21C is enlarged in beam diameter by the beam expander 22C, deflected in the X-axis positive direction by the X-axis deflector mirror 222C, deflected in the Z-axis positive direction by the Z-axis deflector mirror 221C, and is then incident on the reflection surface of the polygon mirror 231a.

The polygon mirror 231a is configured to have a thickness capable of reflecting, in parallel in the Y-axis positive direction, the three pulse laser light beams incident from the Z-axis deflection mirrors 221A, 221B, and 221C, and scans these three pulse laser light beams in parallel in the arrow C direction. The scanning light beams 202A, 202B, and 202C of the three pulse laser light beams are emitted in parallel via the fθ lens 241 onto the base material configuring the container 1, to form a pattern on the base material.

In the pattern forming apparatus 200e, the arrangement of each element is defined so that the scanning light 202A, 202B, and 202C is emitted onto the base material with predetermined intervals therebetween in the conveying direction (the arrow A direction) of the container 1. It is preferable that each element is disposed so that the optical path length from the pulse laser 21A to the irradiation position of the scanning light 202A on the base material, the optical path length from the pulse laser 21B to the irradiation position of the scanning light 202B on the base material, and the optical path length from the pulse laser 21C to the irradiation position of the scanning light 202C on the base material, are substantially equal.

### Examples of Pattern Formation by the Pattern Forming Apparatus 200e

Next, examples of pattern formation by the pattern forming apparatus 200e will be described. In first and second examples, the fθ lens 241 (the emitting unit) emits scanning light 202A, 202B, and 202C scanned by the polygon mirror 231a (the light scanning unit), corresponding to the pulse laser light beams emitted by the plurality of the pulse lasers 21A, 21B, and 21C, to different positions of the base material in the conveying (the direction intersecting the predetermined direction).

On the other hand, in a third example, the fθ lens 241 emits the scanning light beams 202A, 202B, and 202C scanned by the polygon mirror 231a, corresponding to the pulse laser light beams emitted by the plurality of the pulse lasers 21A, 21B, and 21C, so as to be superimposed at the same position on the base material in the conveying direction.

### First Example

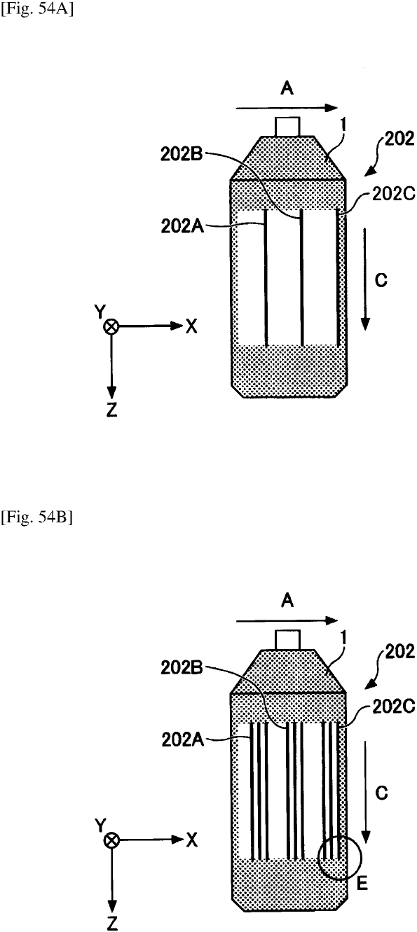

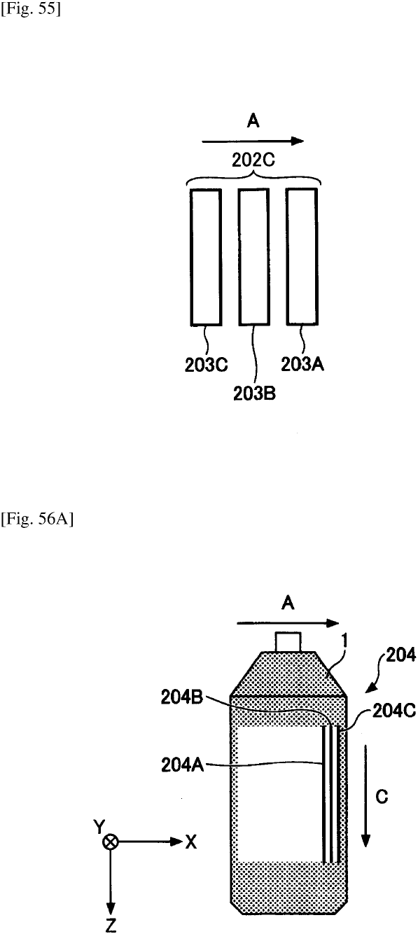

FIGS. 54A and 54B are diagrams illustrating a first example of pattern formation by the pattern forming apparatus 200e. FIG. 54A illustrates scanning lines by one scan, and FIG. 54B illustrates scanning lines by three scans. FIGS. 54A and 54B illustrate the container 1 viewed from the direction of the arrow D of FIG. 53. FIG. 55 is an enlarged view illustrating a portion around a region E in FIG. 54B.

As illustrated in FIG. 54A, in one scan by the rotation of one surface of the polygon mirror 231a, one scanning line is emitted by each of the scanning lights 202A, 202B, and 202C to the base material in parallel. As illustrated in FIG. 54B, in three scans by the rotation of the three surfaces of the polygon mirror 231a, three scanning lines are emitted by each of the scanning lights 202A, 202B, and 202C to the base material so as to be shifted in the conveying direction by a distance corresponding to the conveying speed of the container 1.

As illustrated in FIG. 55, a scanning line 203A is a scanning line formed by the scanning light according to a first surface of the polygon mirror 231a, a scanning line 203B is a scanning line formed by the scanning light according to a second surface of the polygon mirror 231a, and a scanning line 203C indicates a scanning line formed by the scanning light according to a third surface of the polygon mirror 231a.

As described above, by emitting three scanning light beams to the base material in parallel to form a pattern, compared to the case of forming a pattern by one scanning light beam, the pattern formation region on the base material irradiated by one scanning light beam is reduced to ⅓, and the number of scans for pattern formation on one container 1 is reduced to ⅓. As the number of scans is reduced to ⅓, the time taken for forming one predetermined dot in the pattern can be three times longer.

For example, when the conveying speed of the container 1 is set to ensure a predetermined level of productivity, in order to ensure the fluence that satisfies the conditions described in the sixth embodiment, an expensive pulse laser with high pulse energy per pulse or high repetition frequency may be required. Also, the continuous operating time of the pulse laser may be limited or the pulse laser may need to be cooled, which may be undesirable in terms of cost, productivity, and associated equipment.

As in the present embodiment, for example, a three-fold increase in the formation time of one dot allows the pulse energy or the repetition frequency required for the pulse laser to be reduced to one-third, thereby enabling the pattern forming apparatus to be configured by using a relatively inexpensive pulse laser. This allows the pattern forming apparatus to be improved in terms of cost, productivity, and associated equipment.

### Second Example

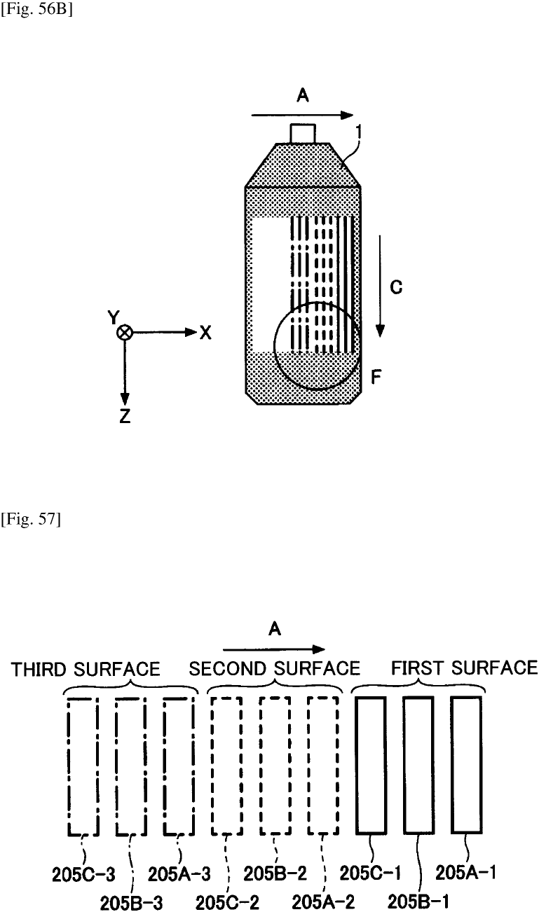

Next, FIGS. 56A and 56B are diagrams illustrating a second example of pattern formation by the pattern forming apparatus 200e, wherein FIG. 56A illustrates scanning lines formed in one scan by the rotation of one surface of the polygon mirror 231a, and FIG. 56B illustrates scanning lines formed in three scans by the rotation of three surfaces of the polygon mirror 231a. FIG. 57 is an enlarged view illustrating a portion around a region F of FIG. 56B.

In the second example, the pattern forming apparatus 200e is configured such that three scanning lines 204A, 204B, and 204C are arranged on the base material at intervals corresponding to the pixel density (resolution) of the pattern in the conveying direction.

FIG. 57 illustrates scanning lines 205A-1, 205B-1, and 205C-1 formed by the rotation of the first surface of the polygon mirror 231a, scanning lines 205A-2, 205B-2, and 205C-2 formed by the rotation of the second surface of the polygon mirror 231a, and scanning lines 205A-3, 205B-3, and 205C-3 formed by the rotation of the third surface of the polygon mirror 231a.

The scanning lines 205A-1, 205A-2, and 205A-3 are formed by the scanning light 202A (see FIG. 52), and the scanning lines 205B-1, 205B-2, and 205B-3 are formed by the scanning light 202B (see FIG. 52). The scanning lines 205C-1, 205C-2, the 205C-3 are formed by the scanning light 202C (see FIG. 52). The interval between the scanning lines in the conveying direction (arrow A direction) corresponds to the pixel density of the pattern.

In the first example described above, the interval between the three scanning lines on the base material corresponds to the length of the pattern formation region divided by three. For example, when the width of the pattern formation region in the conveying direction of the container 1 is 100 millimeters, the fθ lens 241 used in the pattern forming apparatus requires an effective diameter that is 6.6 millimeters (33.3×2) larger than the case where the pattern is formed by one scanning light. Accordingly, the size of the pattern forming apparatus may increase, and the cost of the apparatus may increase.

On the other hand, in the second example, as illustrated in FIGS. 56A to 57, the three scanning lines 204A, 204B, and 204C are arranged at intervals corresponding to the pixel density. As the interval between each scanning line decreases, the fθ lens 241 is not required to have a large effective diameter. For example, in the case where the pixel density is 600 dpi (dot per inch), the diameter of the fθ lens 241 is to be increased only by 0.084 millimeters (0.042×2) compared to the case where the pattern is formed by one scanning light beam. Accordingly, it is possible to prevent an increase in the size and cost of the pattern forming apparatus 200e.

### Third Example

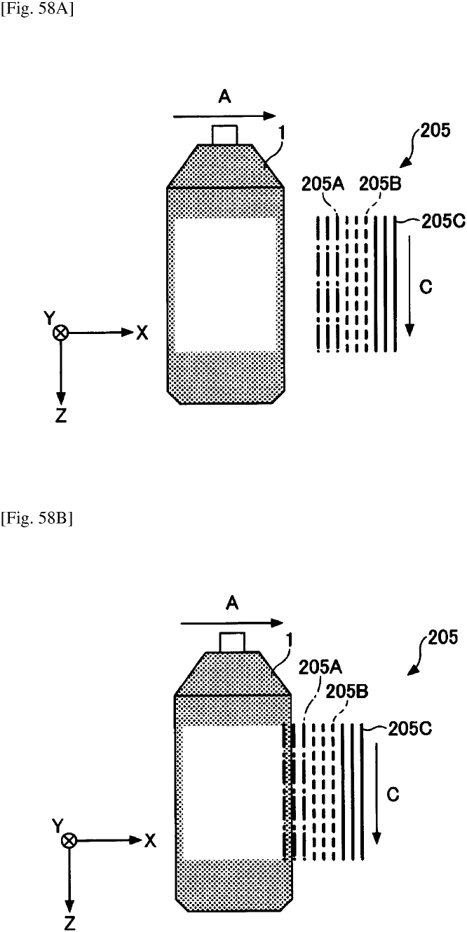

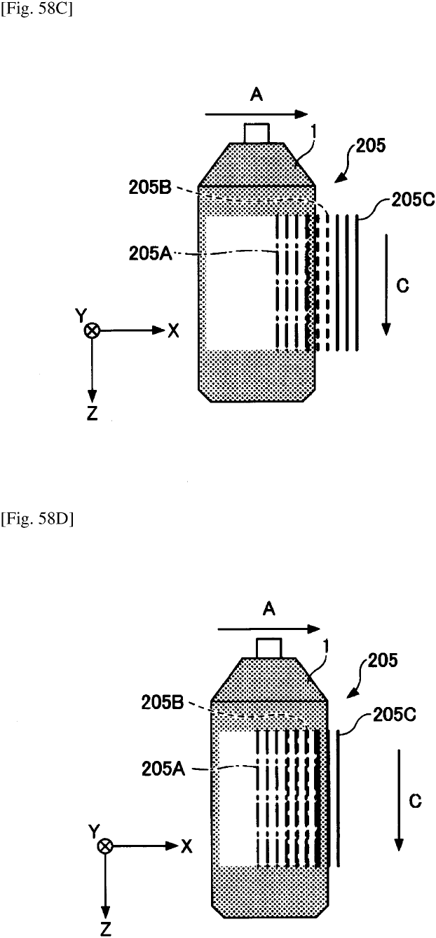

Next, FIGS. 58A to 58D are diagrams illustrating a third example of pattern formation by the pattern forming apparatus 200e. FIG. 58A illustrates the scanning lines at time T0, FIG. 58B illustrates the scanning lines at time T1, FIG. 58C illustrates the scanning lines at time T2, and FIG. 58D illustrates the scanning lines at time T3.

The container 1 is conveyed along the conveying direction corresponding to the arrow A direction, and the position of the container 1 relative to scanning lines 205A, 205B, and 205C according to the scanning light beams 202A, 202B, and 202C (see FIG. 52) differs according to the time in the conveying direction.

Each of the scanning lines 205A, 205B, and 205C includes three scanning lines corresponding to the scanning lines respectively scanned by three surfaces of the polygon mirror 231a. In the order from the downstream side to the upstream side in the conveying direction, a first line scanned by the first surface of the polygon mirror 231a, a second line scanned by the second surface of the polygon mirror 231a, and a third line scanned by the third surface of the polygon mirror 231a, are illustrated.

At the time t0 illustrated in FIG. 58A, none of the scanning lines 205A, 205B, and 205C are emitted onto the container 1. At the time t1 illustrated in FIG. 58B, only the third line of the scanning line 205A, among the scanning lines 205A, 205B, and 205C, is emitted onto a position near the end portion in the X-axis positive direction of the container 1.

At time T2 illustrated in FIG. 58C, the first to third lines of scanning line 205A and the third line of scanning line 205B are emitted onto the base material. The third line of scanning line 205B is emitted at the same position as the position where the third line of the scanning line 205A is emitted at time T1, so as to be superimposed thereon.

At time T3 illustrated in FIG. 58D, the first to third lines of the scanning line 205A, the first to third lines of the scanning line 205B, and the third line of the scanning line 205C are emitted onto the base material. Each of the first to third lines of the scanning line 205B is emitted at the same positions as the position where the first to third lines of scanning line 205A are emitted at time T2, so as to be superimposed thereon. The third line of scanning line 205C is emitted at the same position as the position where the third line of scanning line 205B is emitted at time T2, so as to be superimposed thereon.

In the above-described second example, although the enlargement of the diameter of the fθ lens 241 can be minimized, the set magnification of the fθ lens 241 may affect the beam intervals of the incident pulse laser light beams. For example, when a pattern with a pixel density of 600 dpi (42 micrometers) is formed by a plurality of pulse laser light beams in a state of using a light flux whose incident beam diameter of 2 millimeters is focused to 50 micrometers, the intervals between the scanning light beams in the conveying direction on the base material is 2.1 millimeters (0.04 × 2.5/0.05). If the interval between a plurality of pulse laser light beams is narrow in the conveying direction, it may be difficult to arrange elements such as the Z-axis deflection mirror 221a.

Further, depending on the material or thickness of the base material configuring the container 1, it may be desirable to increase or decrease the influence of heat during pattern formation. As the influence of heat increases, the line width of the pattern tends to increase. In some cases, it is desirable to form a small pattern by reducing the influence of heat and narrowing the line width. When a new pattern is formed at a position adjacent to a formed patterned immediately after the pattern is formed, the heat is likely to affect the image formation.

On the other hand, in the third example, the intervals between the scanning light beams of the plurality of pulse laser light beams in the conveying direction can be set to any distance, and, therefore, flexible arrangement of elements is enabled and the influence of heat can be reduced.

Further, the scanning lines 205A, 205B, and 205C are emitted so as to be superimposed at the same position, and, therefore, the pulse energy or the emission repetition frequency required for the pulse laser can be reduced to approximately one-third, so that a pattern forming apparatus can be configured using a relatively inexpensive pulse laser. This can improve the pattern forming apparatus in terms of cost, productivity, and associated equipment.

### Effect of the Pattern Forming Apparatus 200e

As described above, in the present embodiment, the pulse laser light emitted by each of the plurality of pulse lasers provided in the light source unit is scanned in the scanning direction (the predetermined direction), and the scanning light of each pulse laser light is emitted at different positions of the base material in the conveying direction (the direction intersecting the predetermined direction). Alternatively, the pulse laser light emitted by each of the plurality of pulse lasers is scanned in the scanning direction, and the scanning light beams of the respective pulse laser light beams are emitted so as to be superimposed at the same position of the base material in the conveying direction.

Accordingly, a pattern with good visibility can be formed by ensuring fluence even when a pulse laser with low pulse energy or low emission repetition frequency is used. The pattern forming apparatus can be improved in terms of cost, productivity, and associated equipment.

Here, when the number of pulse lasers is N, the fluence of the pulse laser light emitted by one pulse laser is preferably equal to F/N, because the fluence of one pulse can be secured by the pulse laser light of three pulse lasers.

The effects other than the foregoing are the same as those described in the sixth embodiment.

Further, the ordinal numbers, values of quantities, or the like used in the description of the embodiments are all exemplified for the purpose of specifically describing the technology of the present invention, and the present invention is not limited to the exemplary numbers. The connection relationship between the elements is exemplified for the purpose of specifically describing the technology of the present invention, and the connection relationship for implementing the functions of the present invention is not limited thereto.

Further, in the functional block diagram, the division of the blocks is an example; a plurality of the blocks may be implemented as one block, each block may be divided into two or more blocks, and/or some functions may be transferred to other blocks. The functions of multiple blocks with similar functions may be processed in parallel or by time division by a single piece of hardware or software.

### REFERENCE SIGNS LIST

1 container
10 cylindrical axis
11 characters
111 enlarged view
112 processing image data
1121 pixel
1122 dot data
12 straight line
121 outer surface portion
122 recessed portion
123 inner surface portion
13, 14, 15 image
180 pixel
2 laser emitting unit
20 processing laser beam
21 pulse laser (example of light source unit)
21a pulse laser (first light source unit)
21b pulse laser (second light source unit)
202 scanning light
203 scanning line
204 scanning line
205 scanning line
22 beam expander
220 character
221 galvanomirror
221a galvanomirror (first conveying direction light scanning unit)
221b galvanomirror (second conveying direction light scanning unit)
222 X-axis deflection mirror
23 scanning unit
231 polygon mirror (example of light scanning unit)
231a polygon mirror (first intersecting direction light scanning unit)
231b polygon mirror (second intersecting direction light scanning unit)
232 mark
233 rotation origin sensor
24 scanning lens
241 fθ lens
241a fθ lens (first light emitting unit)
241b fθ lens (second light emitting unit)
25 synchronization detecting unit
251 synchronization detection LD
252 synchronization detection PD
3 rotation mechanism
30a, 30b emitting unit
4 moving mechanism
5 dust collecting unit
6 control unit
501 CPU
502 ROM
503 RAM
504 HD
505 HDD
506 display
508 external device connection I/F
509 network I/F
510 data bus
511 keyboard
512 pointing device
514 DVD-RW drive
516 medium I/F
61 first pattern data input unit
611 pattern data
612 character data
62 second pattern parameter specifying unit
621 processing parameter
63 storage unit
631 association table
64 processing data generating unit
641 processing data
642 character data
65 laser emission control unit
651 light intensity control unit
652 pulse control unit
66 laser scan control unit
67 container rotation control unit
68 container movement control unit
69 dust collection control unit
7 container body
8 sealing member
9 content
100 manufacturing apparatus (example of pattern forming apparatus)
200 pattern forming apparatus
300 conveyance detecting unit
301 conveyance detection light emitting element
302 conveyance detection light receiving element
400 irradiation target surface
401 pattern
500 processing unit
517 pulse laser control unit
520 synchronization detection control unit
530 polygon mirror control unit
541 polygon mirror surface identification control unit
550 galvanomirror control unit
560 surface tilt information storage unit
P interval
Pd1, Pd2, Pd3, Pd4 interval
W width
Hp processed depth
Hb unprocessed depth
t thickness of base material
D crystallization depth
d distance
L length
M number of containers included in container group
T distance between emitting unit and base material
θ half angle of maximum light scanning angle
b′ waiting section
q interval (example of predetermined interval)
N number of emitting units

The present application is based on and claims priority of Japanese Priority Application No. 2020-139568 filed on Aug. 20, 2020, Japanese Priority Application No. 2020-139569 filed on Aug. 20, 2020, Japanese Priority Application No. 2020-199086 filed on Nov. 30, 2020, Japanese Priority Application No. 2021-085407 filed on May 20, 2021, and Japanese Priority Application No. 2021-085399 filed on May 20, 2021, the entire contents of which are hereby incorporated herein by reference.

1. A pattern forming apparatus for forming a pattern by emitting a scanning light onto a plurality of base materials conveyed in a predetermined conveying direction, the pattern forming apparatus comprising:
a plurality of emitters including a first emitter and a second emitting unit, wherein
the first emitter includes:
a first light source to emit a first laser light;
a first conveying direction light scanner to scan the first laser light in the predetermined conveying direction;
a first intersecting direction light scanner to scan a scanning light, scanned by the first conveying direction light scanner, in an intersecting direction that intersects the predetermined conveying direction; and
a first light emitter to emit a first scanning light, scanned by the first intersecting direction light scanner, onto a base material among the plurality of base materials, wherein
the second emitter includes:
a second light source to emit a second laser light;
a second conveying direction light scanner to scan the second laser light in the predetermined conveying direction;
a second intersecting direction light scanner to scan a scanning light, scanned by the second conveying direction light scanner, in the intersecting direction; and
a second light emitter to emit a second scanning light, scanned by the second intersecting direction light scanner, onto another base material among the plurality of base materials, wherein
the first light emitter emits the first scanning light onto the base material that is different from the another base material onto which the second light emitter emits the second scanning light, at a position different from a position where the second light emitter emits the second scanning light in the predetermined conveying direction.

2. The pattern forming apparatus according to claim 1, wherein a formula d=(L+2 • T • tanθ+b′)/N is satisfied, where d represents a distance in the predetermined conveying direction between a central axis of the first light emitter and a central axis of the second light emitter, L represents a length in the predetermined conveying direction of a pattern formation target region in each of the plurality of base materials, T represents a distance between each of the plurality of emitters and a corresponding base material among the plurality of base materials, θ represents a half angle of a maximum light scanning angle of each of the first conveying direction light scanner and the second conveying direction light scanner, b′ represents a predetermined waiting section where each of the first intersecting direction light scanner and the second intersecting direction light scanner waits before performing scanning, and N represents a number of the plurality of emitters.

3. The pattern forming apparatus according to claim 1, wherein
the first light emitter emits the first scanning light onto the plurality of base materials conveyed with a predetermined interval in the predetermined conveying direction between adjacent base materials among the plurality of base materials, and
the second light emitter emits the second scanning light onto the plurality of base materials conveyed with a predetermined interval in the predetermined conveying direction between adjacent base materials among the plurality of base materials.

4. A pattern forming apparatus for emitting a laser light onto a base material conveyed in a predetermined direction, the pattern forming apparatus comprising:
a light source to emit the laser light;
a first light scanner to scan the laser light in the predetermined direction;
a second light scanner to scan the laser light in an intersecting direction that intersects the predetermined direction; and
a light emitter to emit a scanning light, scanned by the first light scanner or the second light scanner, onto the base material, wherein
the second light scanner scans the laser light in the intersecting direction at a plurality of positions along the predetermined position.

5. A pattern forming apparatus for emitting a laser light onto a base material conveyed in a predetermined direction, the pattern forming apparatus comprising:
a light source to emit the laser light;
a first light scanner to scan the laser light in the predetermined direction;
a second light scanner to scan the laser light in an intersecting direction that intersects the predetermined direction, at a plurality of positions along the predetermined direction; and
a light emitter to emit a scanning light, scanned by the first light scanner or the second light scanner, onto the base material, wherein
the pattern forming apparatus forms a two-dimensional pattern on the base material,
the base material includes a plurality of base materials conveyed at a predetermined interval, and
a formula 0.4<Lx/(Lx+S)<1 is satisfied, where Lx represents a size of the two-dimensional pattern in the predetermined direction and S represents the predetermined direction.

6. The pattern forming apparatus according to claim 5, wherein a formula ΔV ≧V-Lx / (t_{L} ×N) is satisfied, where ΔV represents a scanning speed of scanning the laser light in the predetermined direction by the first light scanner, V represents a conveying speed at which the base material is conveyed, t_{L}represents a scanning time taken to scan one scanning line of an intersecting scanning line corresponding to a scanning line in the intersecting direction according to the scanning light, and N represents a number of the scanning lines of the intersecting scanning line required for forming the two-dimensional pattern.

7. The pattern forming apparatus according to claim 4, wherein a two-dimensional pattern is formed on the base material while changing, in the predetermined direction by the first light scanner, an irradiation position to which the scanning light scanned by the second light scanner is emitted, the irradiation position being changed according to a position of the base material being conveyed.

8. The pattern forming apparatus according to claim 4, wherein the first light scanner returns an irradiation position to which the scanning light scanned by the second light scanner is emitted, to an initial position of scanning in the predetermined direction, within a shorter time than a time taken for scanning in the predetermined direction, after scanning in the predetermined direction.

9. The pattern forming apparatus according to claim 1, wherein
the first conveying direction light scanner, the second conveying direction light scanner, and the first light scanner include a galvanomirror; and
the first intersecting direction light scanner, the second intersecting direction light scanner, and the second light scanner include a polygon mirror.

10. The pattern forming apparatus according to claim 4, wherein
the second light scanner scans the laser light in the intersecting direction while changing an angle of a reflection surface of the second light scanner, and
the first light scanner scans the laser light in the predetermined direction so as to correct a shift in an irradiation position where the scanning light is emitted on the base material, the shift being caused by a tilt of the reflection surface in the predetermined direction.

11. The pattern forming apparatus according to claim 4, wherein
the pattern forming apparatus forms a pattern based on image data; and
the first light scanner changes a scanning amount of the laser light according to at least one of presence or absence of the image data in a pattern formation region of the base material and a type of the image data.

12-19. (canceled)
